(19) United States
(12) Patent Application Publication
(10) Pub. No.: US 2010/0223066 A1
(43) Pub. Date: Sep. 2, 2010

(54) SOCIAL NETWORKING AND DATING PLATFORM AND METHOD

(76) Inventor: Jacqueline Mary Berger, Redhead (AU)

Correspondence Address: STROOCK & STROOCK & LAVAN LLP, 180 MAIDEN LANE, NEW YORK, NY, 10038, US

(21) Appl. No.: 12/717,583

(22) Filed: Mar. 4, 2010

Related U.S. Application Data
(63) Continuation of application No. 11/799,202, filed on Apr. 30, 2007, now abandoned.
Application No. 11/799,202 is a continuation-in-part of application No. 11/258,284, filed on Oct. 24, 2005, now abandoned.
(60) Provisional application No. 60/795,858, filed on Apr. 28, 2006.

(51) Int. Cl. G06Q 99/00; G06F 3/01; G06F 15/16

(52) U.S. Cl. 705/1.1; 715/744; 709/204

(57) ABSTRACT

A social networking or dating platform and method that systematically documents and stores evaluations by participants of their networking or dating experiences. Each evaluation is then sent, by, for example, email and or SMS, to the other participant in the date. Advantageously, the system processes each evaluation to determine a date rating and prompts the participants to take further action based on that rating. The social networking or dating system further comprises a widget interface.

### BACKGROUND AND SUMMARY

A review of existing Internet dating sites reveals a need for a site that provides an easy to use, automated date feedback mechanism by which each date participant can evaluate the other participant. Such evaluations would be useful not only to the participants themselves, but to other people who might be interested in dating one of the participants.

The present invention addresses this need by providing such an automated date feedback mechanism. Briefly, a date participant evaluates the other participant by completing an automated, on-line questionnaire. The Internet dating system in accordance with the present invention processes the questionnaire and determines a date rating and sends the rating to the other participant to the date by, for example, email or short message service (SMS). The evaluations and ratings may also be stored in a database for later review by the participants and/or other interested people. Advantageously, the system may also prompt the participants to take further action based on that rating. For example, if a participant rates a date positively, the system may prompt the participant to send a gift, such as flowers or candy, to the other participant, send a message to the other participant, or provide suggestions to that participant for another date. A participant receiving a positive rating may be likewise prompted by the system.

In another aspect of the present invention, the system enables a participant to authorize other members of the Internet website system to view his or her date evaluation. In that way, other members may consider that evaluation in deciding whether to arrange a date with the reviewed participant.

In yet another aspect of the present invention, the system may be linked to an established Internet dating website to provide that website with the features described herein. Alternatively, the system may be linked to blogs (weblogs) or social networking sites such as MySpace, Xanga, TagWorld, Friendster, and LinkedIn.

In still a further aspect of the present invention, the system may be accessed, and evaluations provided and received, via a mobile device, such as a mobile phone. In that way, participants can conveniently provide and receive evaluations of the date while the date is still fresh in their minds.

In yet another aspect of the present invention, a widget is provided as a user-interface.

### BRIEF DESCRIPTION OF THE DRAWINGS

Additional objects and features of the invention will be more readily apparent from the following detailed description and appended claims when taken in conjunction with the drawings, in which:

FIG. 1 is an illustration of a system in accordance with the present invention;

FIG. 2 is an illustration of an alternative embodiment of a system in accordance with the present invention;

FIG. 3 is a block diagram illustrating a process in accordance with the present invention;

FIGS. 4-18 illustrate web pages that may be displayed on a user's computer during the course of the process illustrated in FIG. 3;

FIG. 19 is a block diagram illustrating a process in accordance with the present invention in which a mobile device, such as a cell phone, is used to access the Internet dating system;

FIGS. 20-30 illustrate pages that may be displayed on a user's mobile device during the course of the process illustrated in FIG. 19;

FIGS. 31-36 illustrate pages that may be displayed on a user's mobile device during the course of sending a pre-written message provided by a system in accordance with the present invention;

FIG. 37 is a flowchart illustrating the process of unlocking a widget;

FIG. 38 shows a widget in accordance with an embodiment of the present invention;

FIG. 39 illustrates a site map for the front-end of an illustrative embodiment of a widget-based user interface in accordance with an illustrative embodiment of the present invention;

FIGS. 40-47 provide illustrative flowcharts of the front-end features provided by an illustrative embodiment of the present invention;

FIG. 48 illustrates a site map for the back-end administrative features provided in an embodiment of the present invention;

FIG. 49 is a web page through which the back-end administrative features may be provided;

FIGS. 50-56 provide flowcharts of the back-end administrative features provided by an embodiment of the present invention; and

FIGS. 57-91 depict screen shots of a widget-based user interface in accordance with an embodiment of the present invention.

In the drawings, like reference numerals refer to like items.

### DETAILED DESCRIPTION

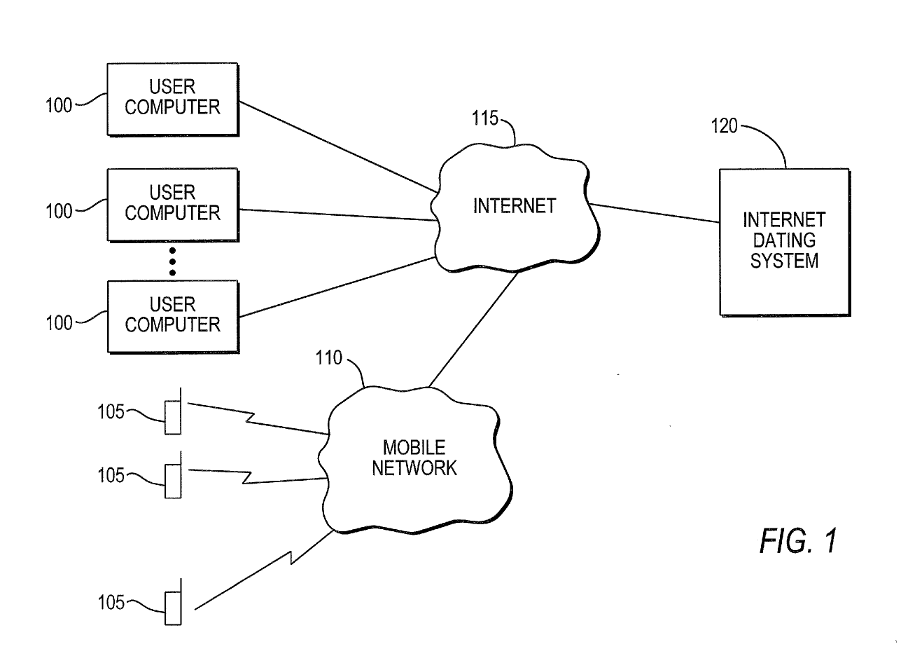

FIG. 1 illustrates a system in accordance with an embodiment of the present invention, in which one or more user computers 100, such as personal computers, laptop computers, etc., or mobile devices 105, such as mobile phones, personal digital assistants, etc., are capable of communicating with Internet dating system 120, via a network 115, such as the Internet. In the case of mobile devices 105, communication with Internet dating system 120 may also utilize a mobile network 110 that is capable of communicating information over network 115. Internet dating system 120 includes servers and other computers and processors, as well as storage devices, and all other hardware and software necessary for hosting an Internet website, as is known in the art. The Internet dating system 120 further includes a database system for storing information about users of the system, including account information and the evaluations and ratings described below.

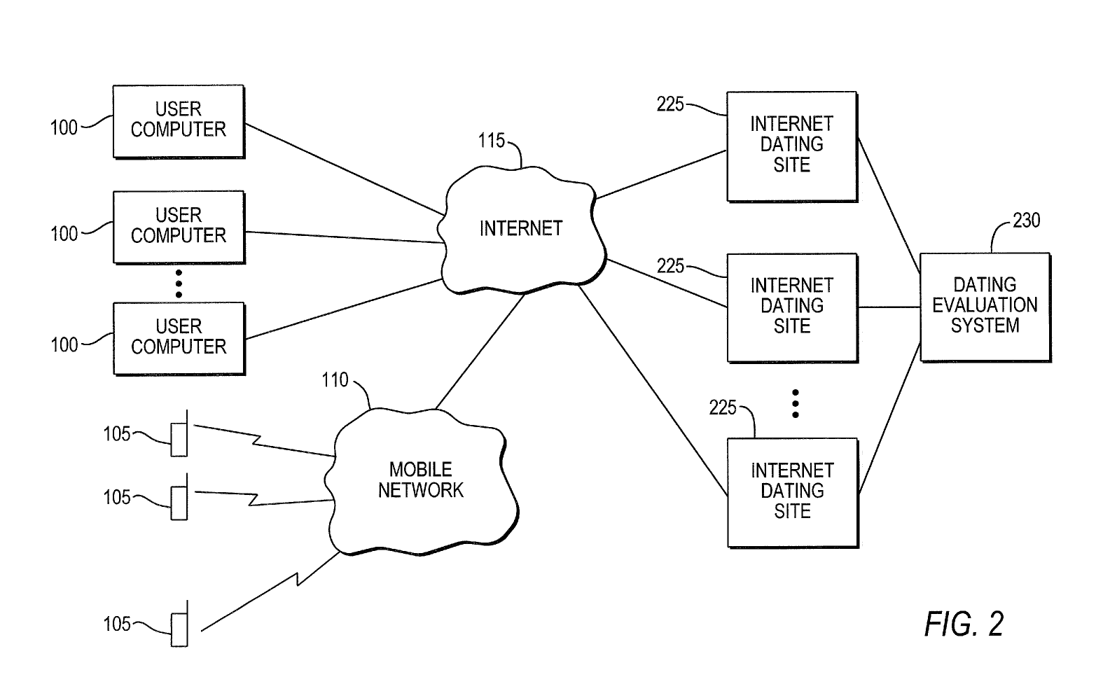

FIG. 2 illustrates an alternative system in accordance with an embodiment of the present invention. In this embodiment, one or more user computers 100, such as personal computers, laptop computers, etc., or mobile devices 105, such as mobile phones, personal digital assistants, etc., are capable of communicating with one or more Internet dating sites 225, via a network 115, such as the Internet, and, in the case of mobile devices 105, mobile network 110. The one or more Internet dating sites 225 are, in turn, linked to dating evaluation system 230. Again, Internet dating sites 225 and dating evaluation system 230 include servers and other computers and processors, as well as storage devices, and all other hardware and software necessary for hosting an Internet website and/or communicating with a hosted website, as is known in the art.

In another alternative system in accordance with an embodiment of the present invention, rather than Internet dating sites 225, dating evaluation system 230 is linked to blogs (weblogs) or social networking sites, e.g. MySpace, Xanga, TagWorld, Friendster, and LinkedIn, to provide those blogs and sites with the features described herein.

Dating evaluation system 230 further includes a database system for storing information about users of the system, including account information and the evaluations and ratings described below. In this embodiment, dating evaluation system 230 can act as a central repository for evaluation information that may be shared by some or all of the Internet dating sites 225. In this way, a user that is a member of more than one Internet dating site 225 can have his or her dating information aggregated.

In operation, the features and information provided by dating evaluation system 230 may be incorporated into the web pages served by the one or more Internet dating sites 225, for example, in a separate frame in the web pages served by those sites. Alternatively, the features and information provided by dating evaluation system 230 may be provided in a separate browser window. In either case, a link and/or button may be provided by Internet dating sites 225 that enable the user to access the features provided by dating evaluation system 230.

In both the FIG. 1 and FIG. 2 embodiments, the database stores a history of all date reviews received by each user. The system in turn performs analysis of that information. For example, the database may track the number of dates a user went on, the number of positive and negative responses that were received, and the number of times a user received the same response to the same question. Advantageously, the system may then use that information to provide suggestions to that user for improving his or her dating habits. For example, if a number of reviewers have indicated that the user does not look like the picture that he or she posted on the dating site, the system may send a message to the user, suggesting that he or she change the picture. Similarly, for example, if a number of reviewers have indicated that the user's personality does not match his or her profile, the system may advise the user to change the profile. The system may also use the analyzed information to refer the user to dating materials that specifically address the user's dating deficiencies. The analyzed information may optionally be presented to the user in tabular or graphical form. In addition, the review information may be used to verify that a user in fact who she or he claims to be.

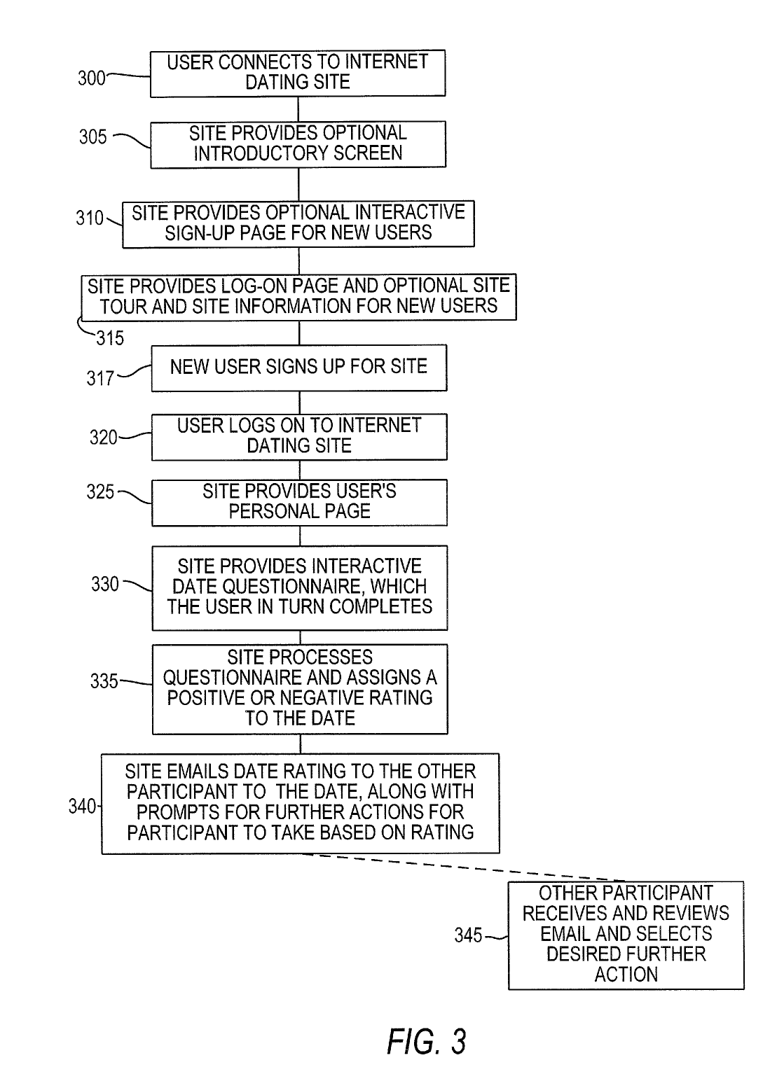

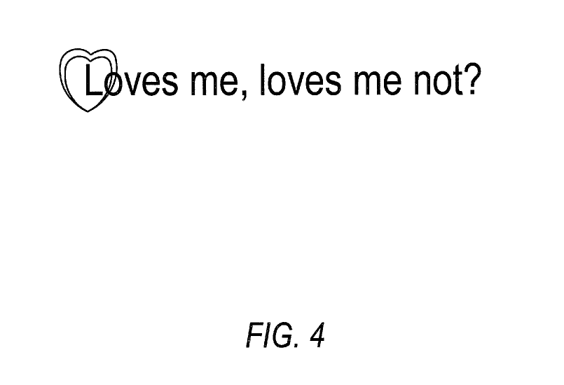

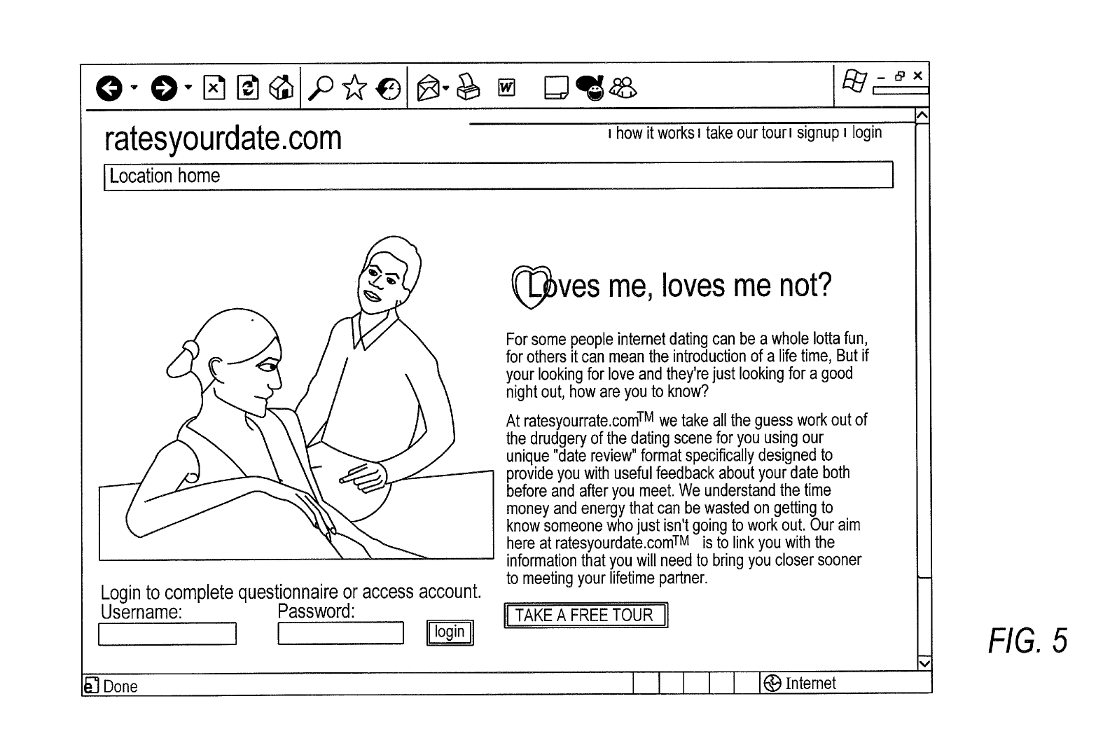

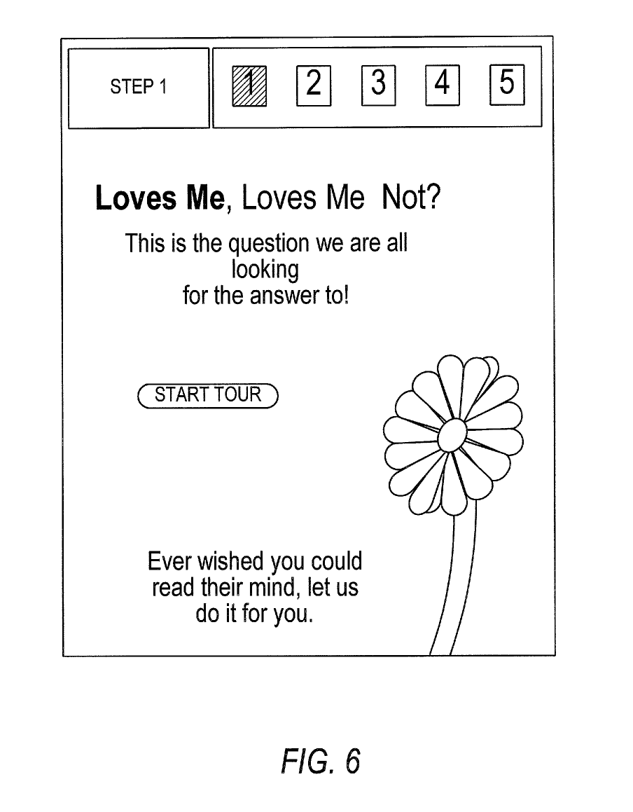

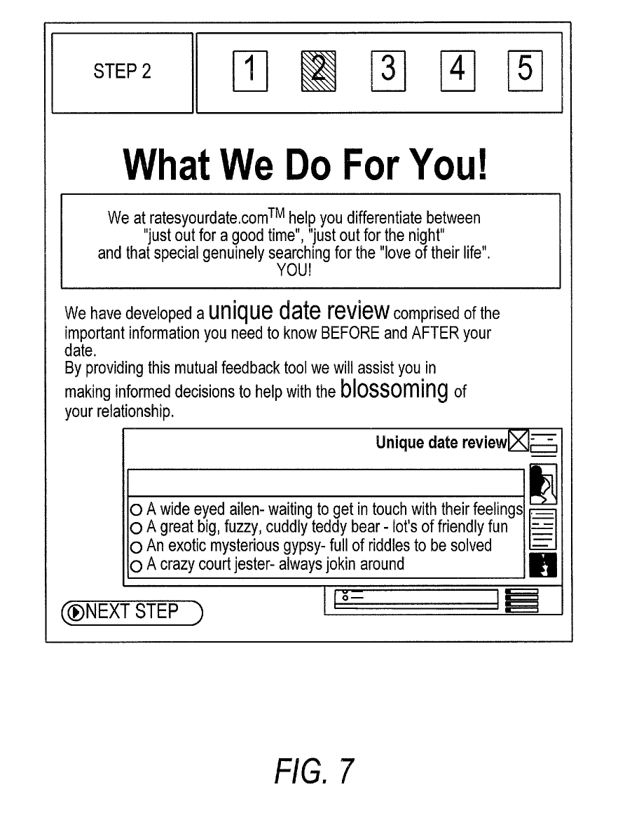

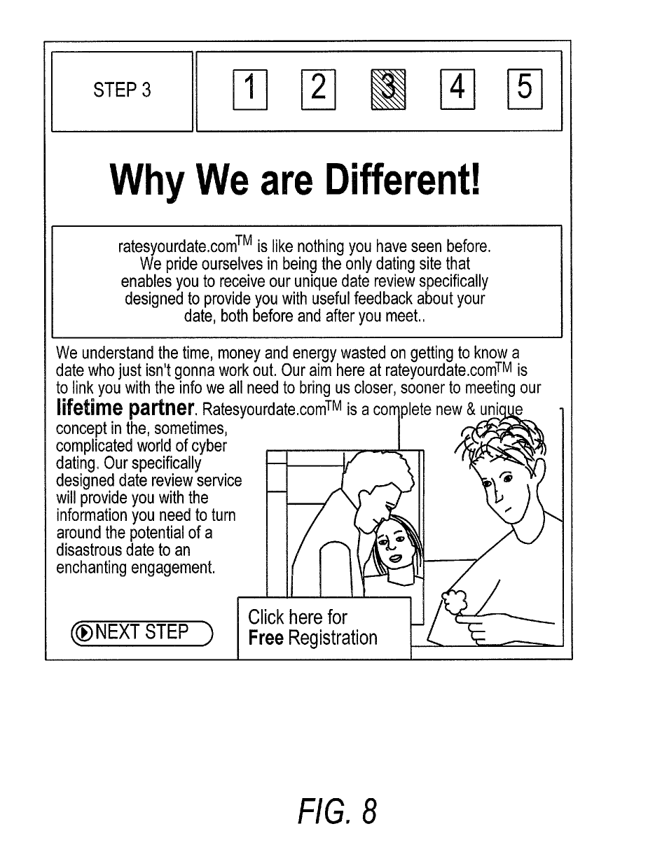

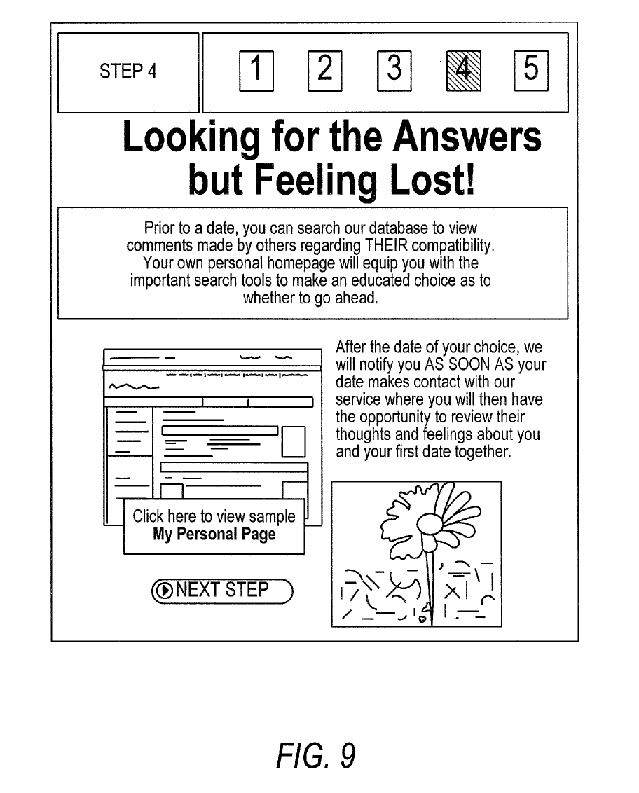

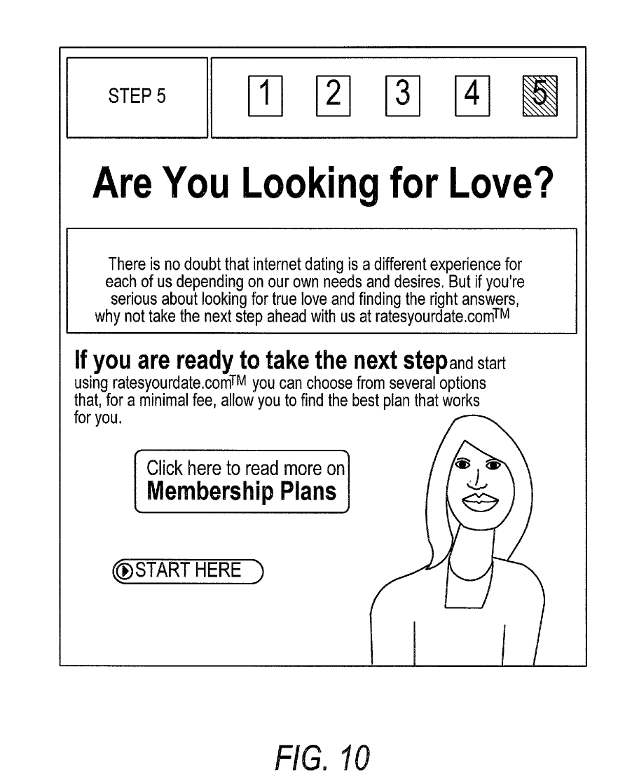

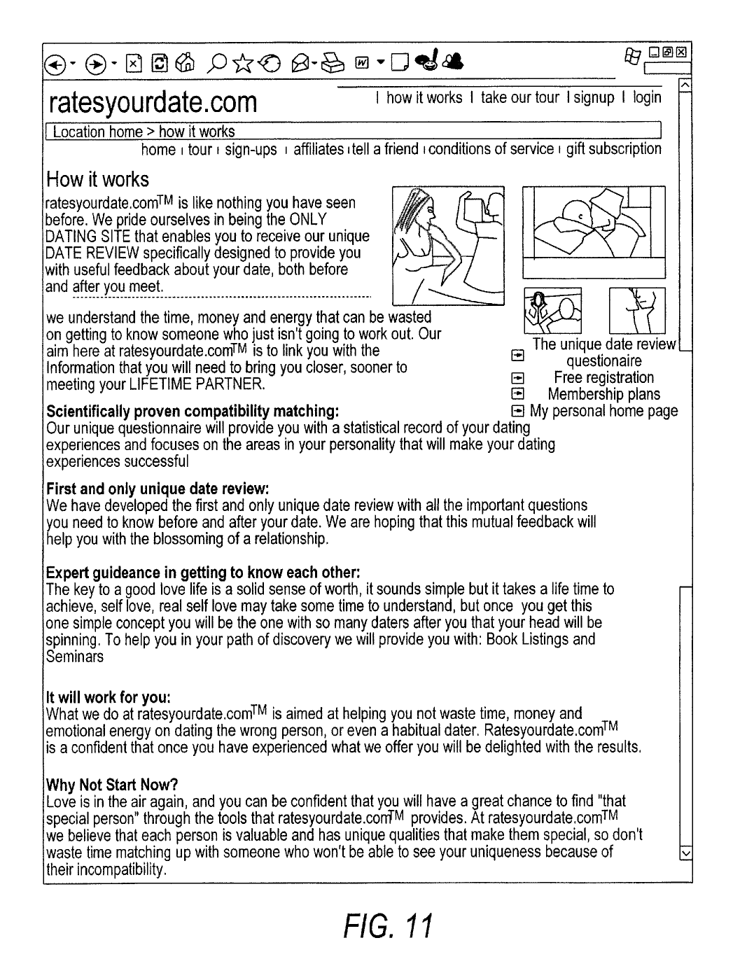

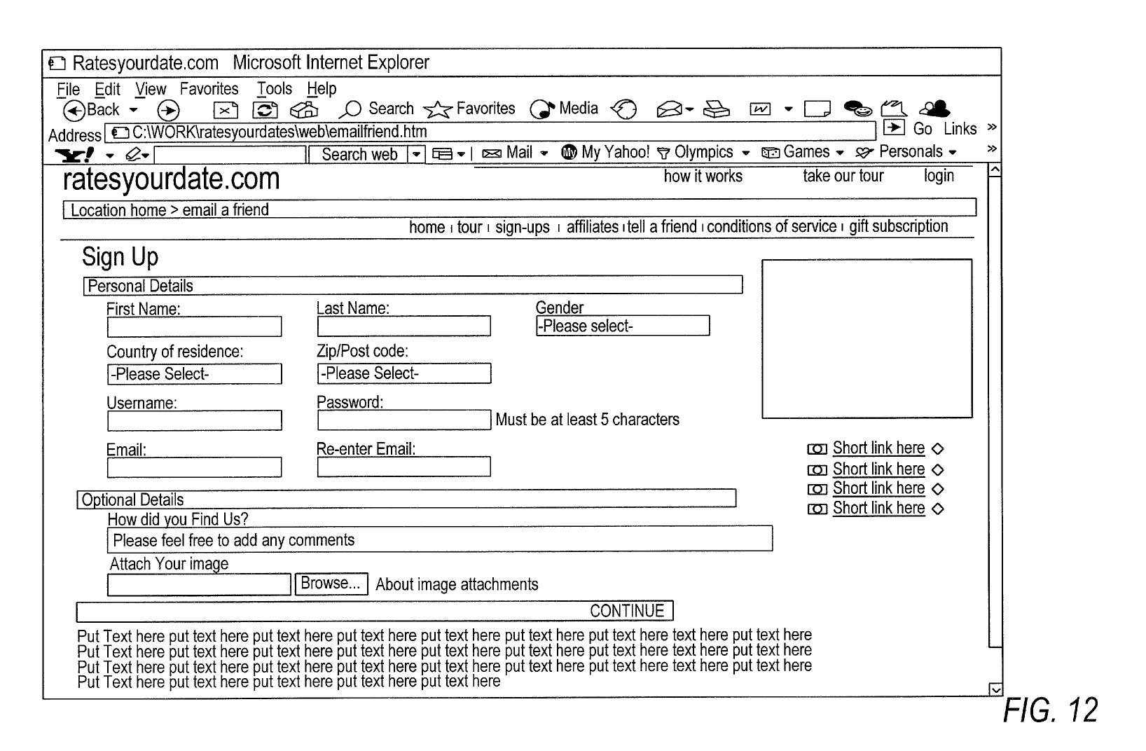

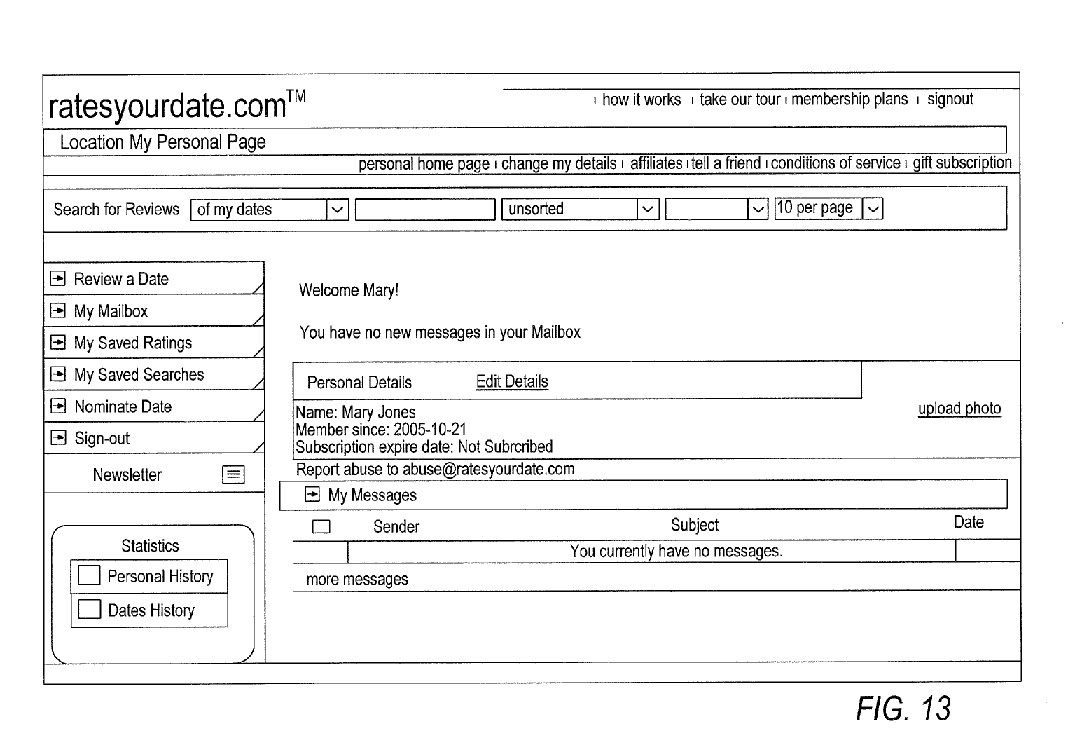

FIG. 3 illustrates a process, in accordance with an embodiment of the present invention, for providing and utilizing an automated evaluation and rating system in an Internet dating site. The process can be performed by a stand-alone Internet dating system, as shown in FIG. 1, or a combined system comprising one or more Internet dating sites and a dating evaluation system, as shown in FIG. 2. In step 300, a user connects to the system by, for example, entering the URL for the system's website, or the URL for one of the one or more Internet dating sites shown in FIG. 2, into an Internet browser or selecting a hyperlink, button, or bookmark for the site. In step 305, the site then may optionally provide an introductory screen, such as the one shown in FIG. 4, which is in turn displayed on the screen of the user's computer. In step 310, the site then provides a log-on page, such as the one shown in FIG. 5. In step 315, the log-on page may optionally include a link to a site tour and/or other information about the site that would be useful to a new user. An exemplary site tour for the site is shown in FIGS. 6-10. An example of additional information that may be provided to new users is shown in FIG. 11. In step 317, a new user may sign-up to become a member of the site, in which case the site will provide a sign-up form for the user to complete. An example of a sign-up form is shown in FIG. 12.

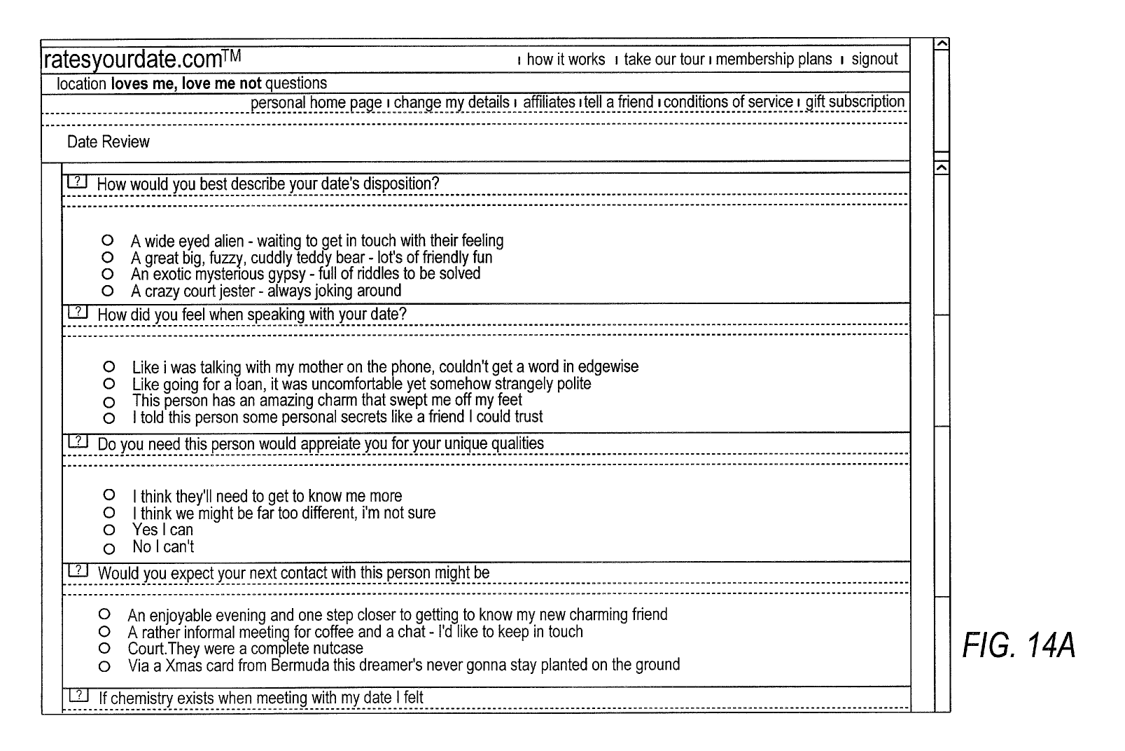

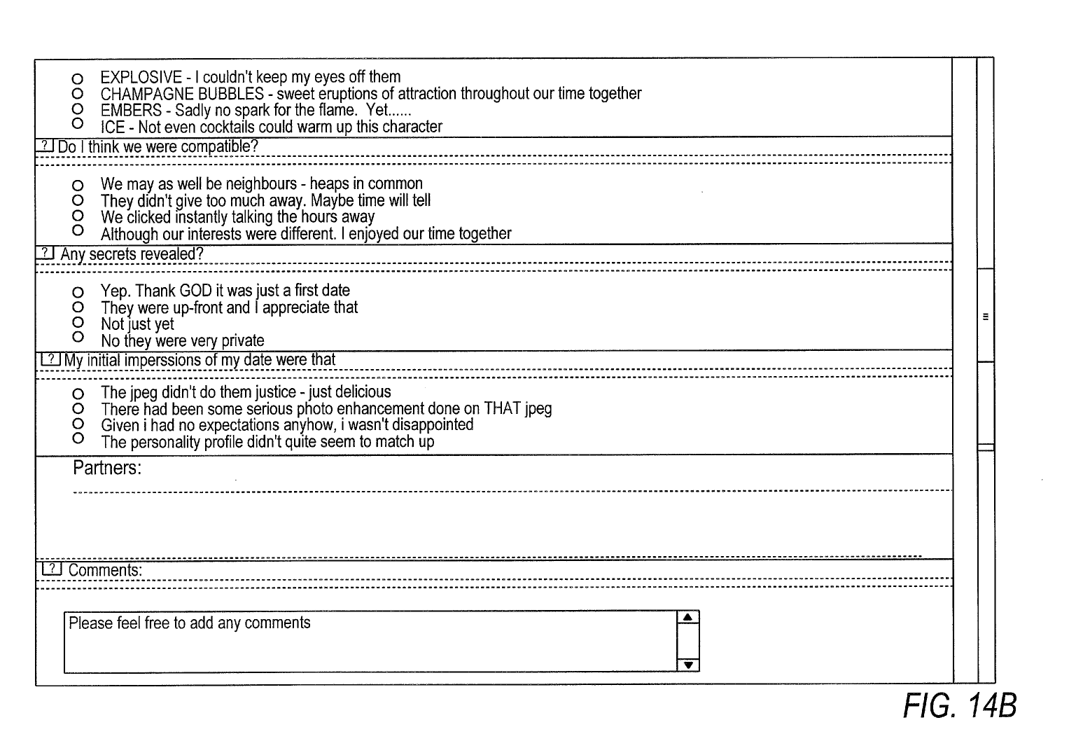

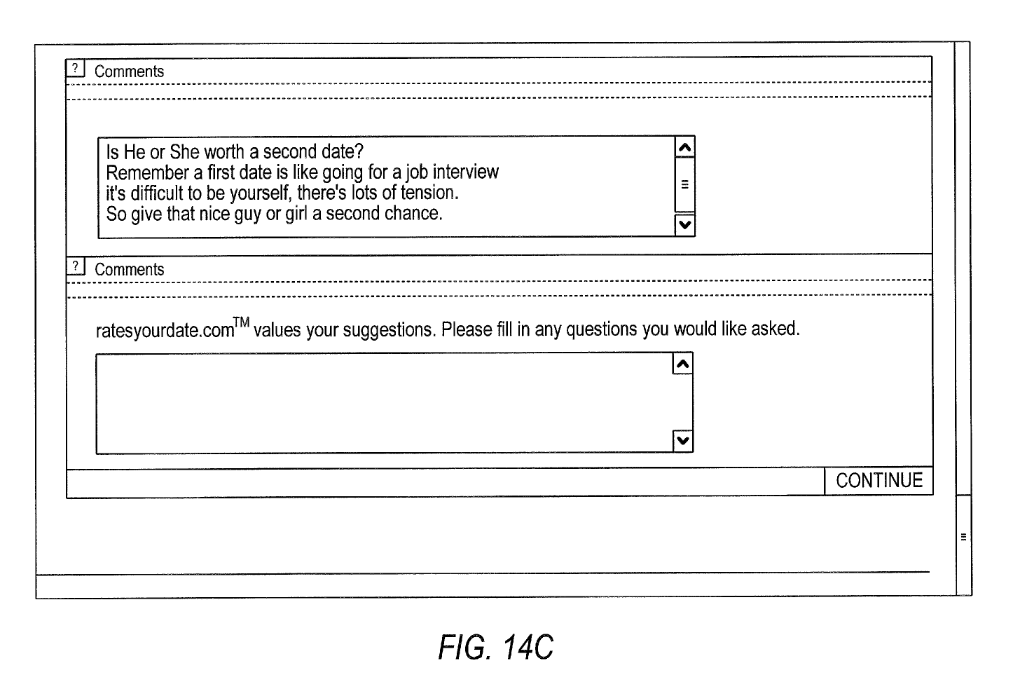

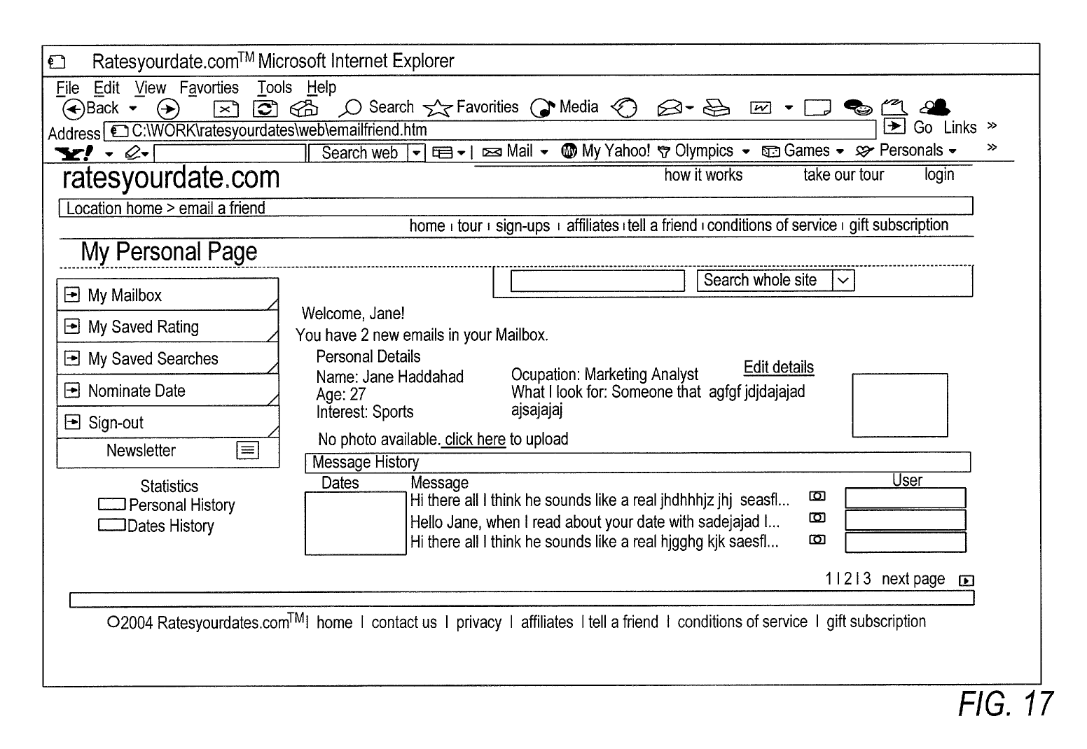

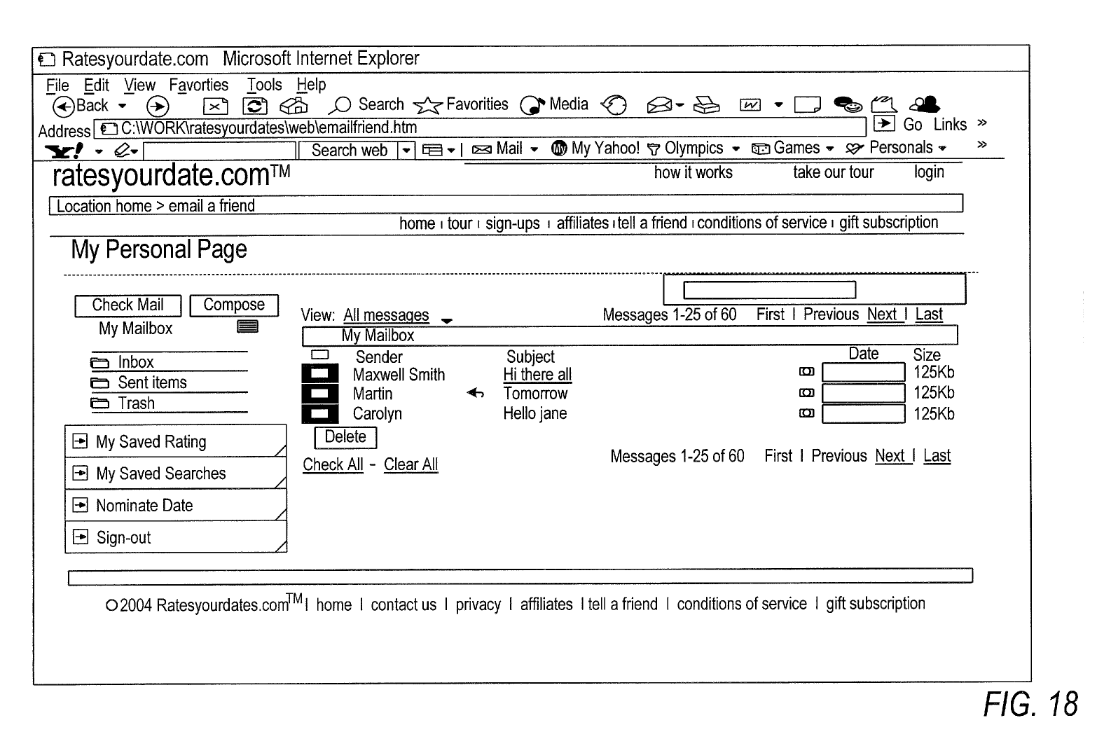

In step 320, the user logs on to the Internet dating site, and, in step 325, the user's personal page is displayed. Illustrative personal pages are shown in FIGS. 13 and 17. FIG. 18 illustrates the display of the user's mailbox, which can be reached through the user's personal page by selecting the My Mailbox button. In step 330, if the user indicates that he or she would like to review a date, the site will provide an interactive date questionnaire for the user to complete. The user can make that indication by, for example, clicking on the Review a Date button shown in FIG. 13. An exemplary date questionnaire is shown in FIGS. 14A-14C.

After the user completes the questionnaire, the site, in step 335, processes the questionnaire and assigns a positive or negative rating to the date. The questionnaire is preferably designed to obtain personality profile and identity verification information.

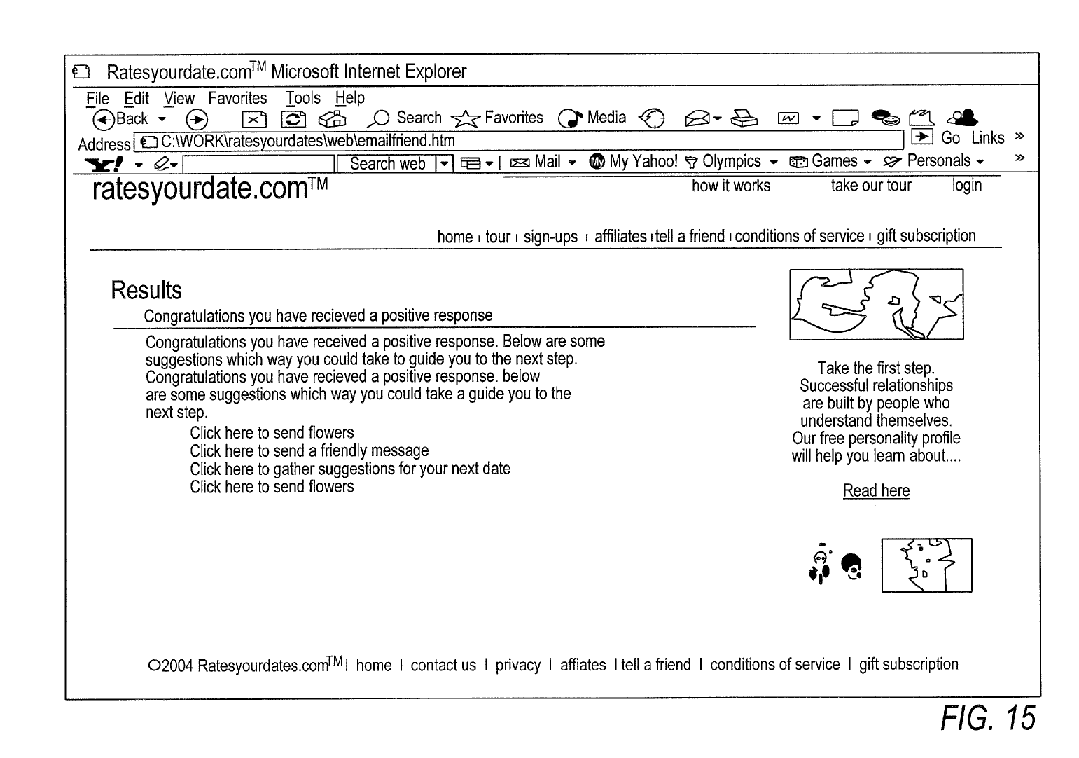

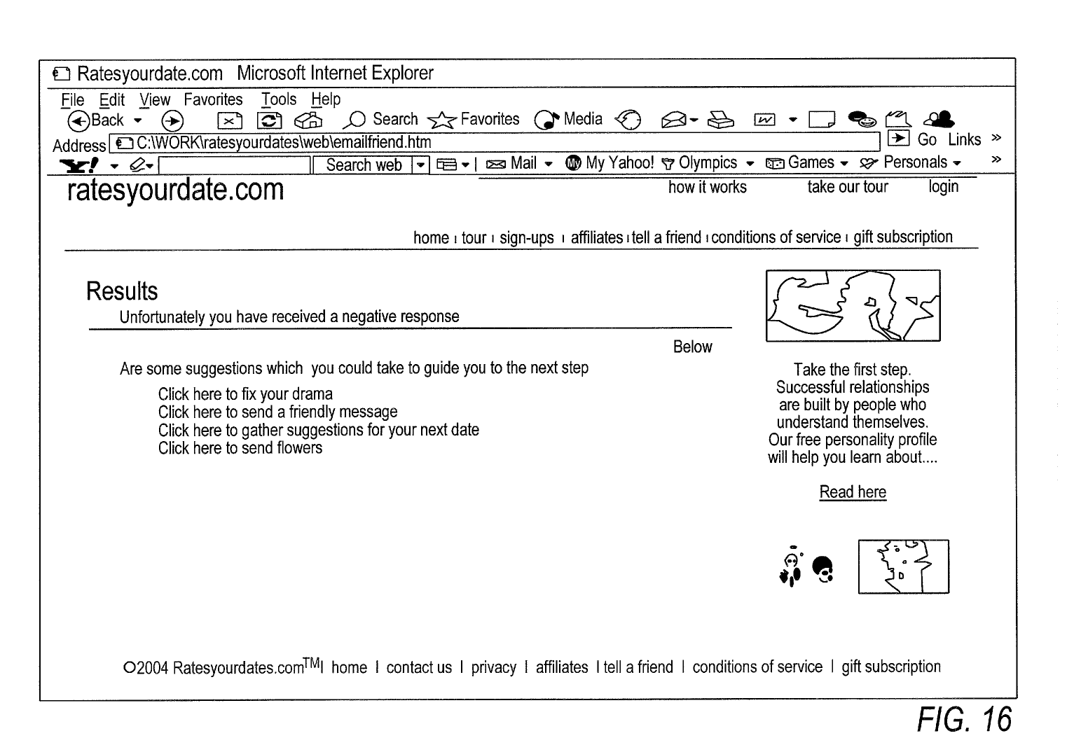

In step 340, the site emails the date rating to the other participant. The email may contain prompts or links that enable further actions for the other participant to take based on the rating. For example, as shown in FIG. 15, if the rating is positive, the email may contain prompts or links for sending the reviewer (i.e., the user who filled out the questionnaire) a gift, such as flowers, sending the reviewer a friendly message, or for gathering suggestions for a next date. As shown in FIG. 16, if the rating is negative, the email may contain a prompt or link for the other participant to “fix your drama,” which will direct the other participant to information that may improve his or her dating skills.

In step 345, the other participant receives and reviews the email containing the date rating. The other participant may then select one of the suggestions for further actions by, for example, clicking on or otherwise selecting one of the prompts or links in the email. By making a selection, the participant may, for example, be directed to a webpage at which flowers may be purchased, provided with a screen for sending a friendly message to the reviewer, provided with suggestions for a next date, or, if the review was negative, provided with helpful dating hints or directed to a dating website to continue the search for a compatible date.

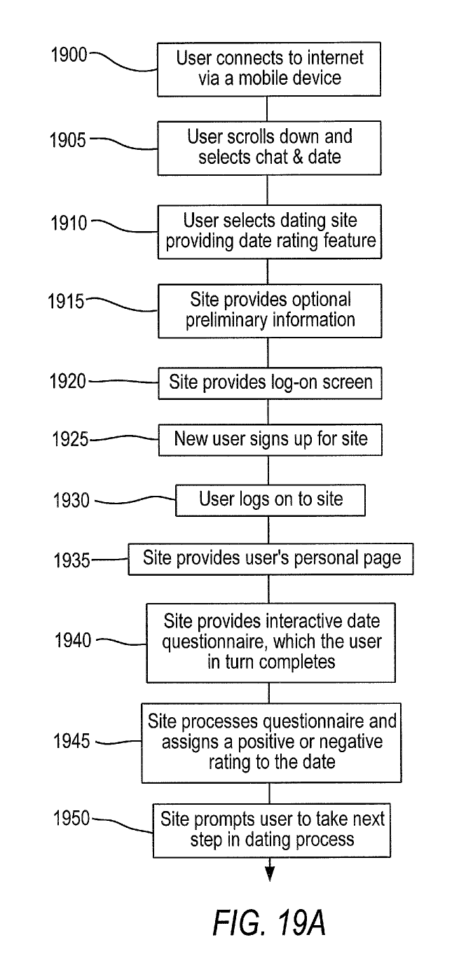

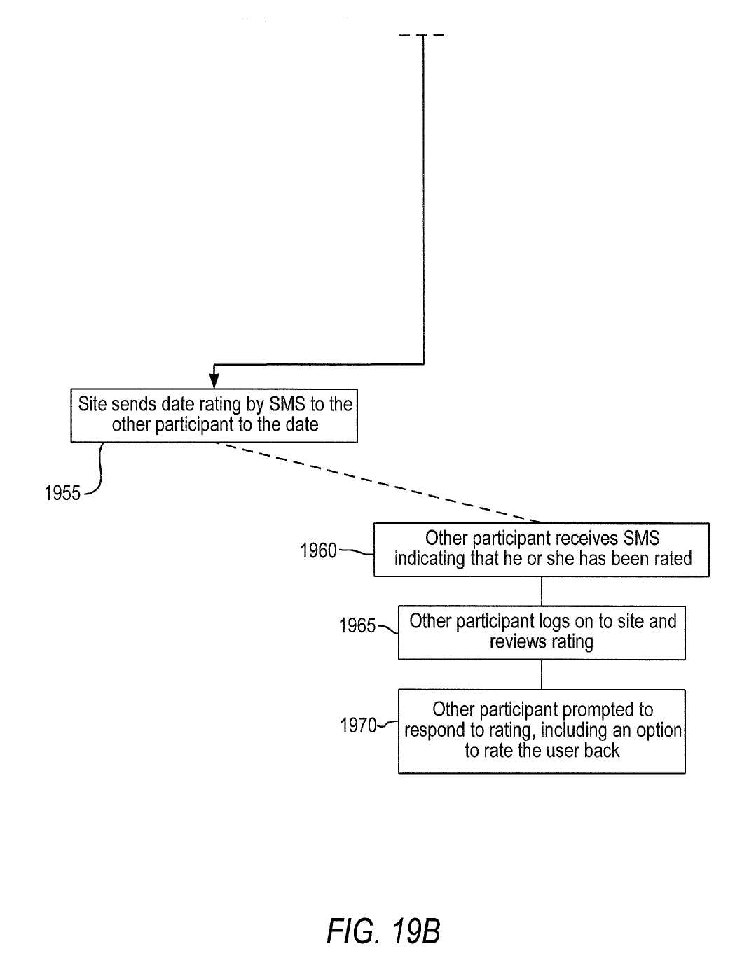

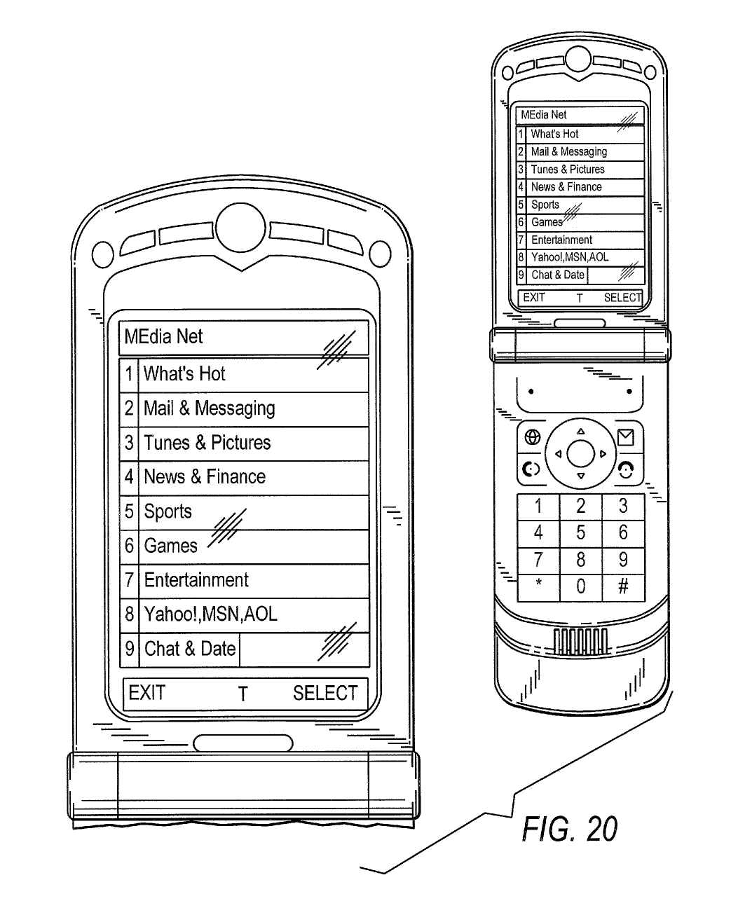

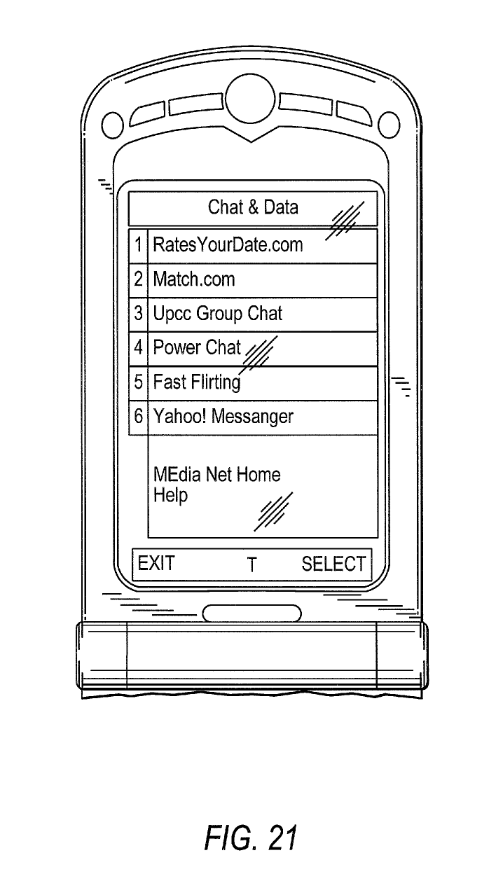

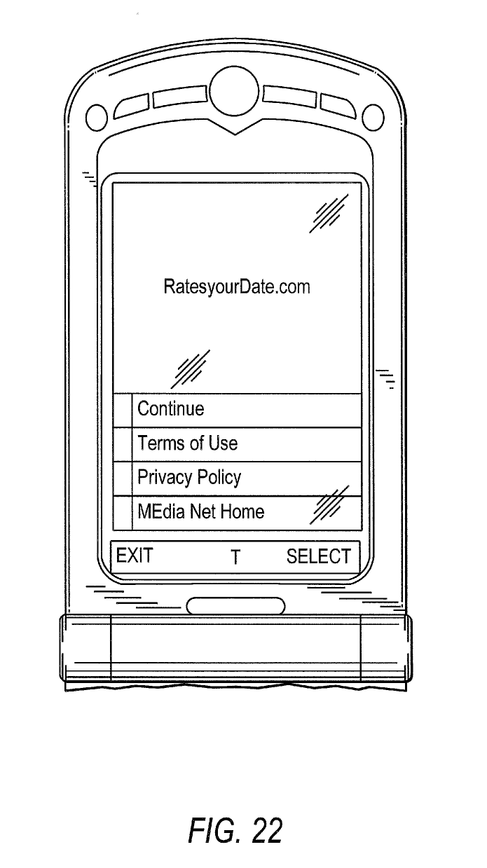

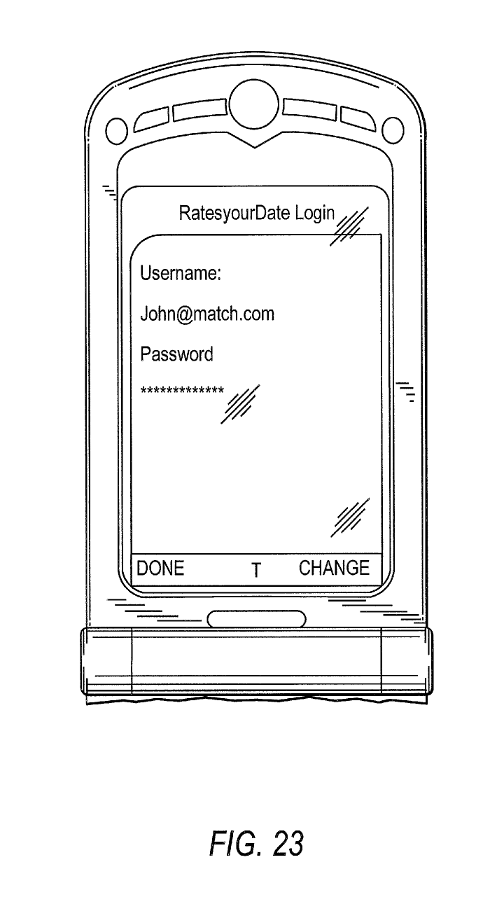

FIG. 19 illustrates a process in accordance with an embodiment of the present invention, in which a mobile device, such as a cell phone, is used to access the Internet dating system. In step 1900, a user connects to the Internet via a mobile device. In step 1905, the user scrolls down and selects Chat & Date, as illustrated in FIG. 20, which in turn causes links to one or more dating sites to be displayed. In step 1910, the user selects a dating site that provides a date rating service in accordance with the present invention, as illustrated in FIG. 21. In step 1915, the site provides optional preliminary information, as illustrated in FIG. 22. In step 1920, the user is provided a log-on page. If the user is not yet a member, he or she will, in step 1925, be prompted to sign up and then continue. In step 1930, the user logs on to the Internet dating site, as illustrated in FIG. 23.

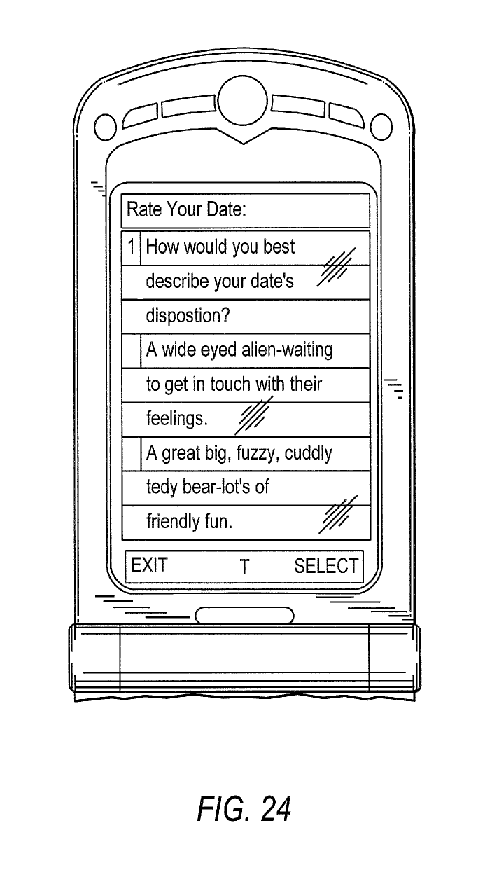

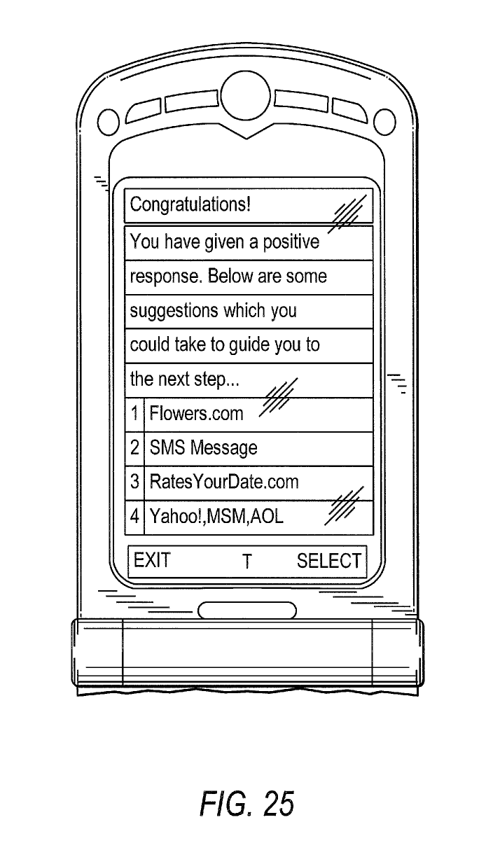

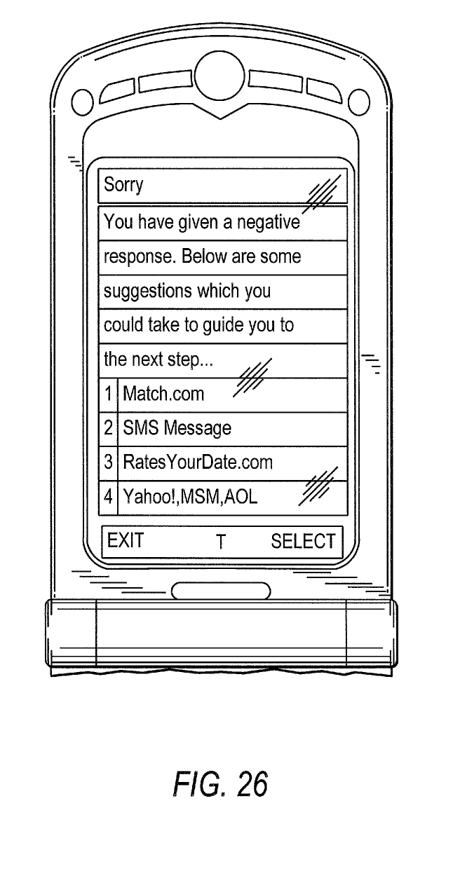

In step 1935, the user's personal page is displayed and the user may select to complete a date rating. If a user selects to complete a date rating, then, in step 1940, the site provides an interactive date questionnaire, a page of which is illustrated in FIG. 24, which the user in turn completes. In step 1945, the site processes the questionnaire and assigns a positive or negative rating to it. The site then, in step 1950, prompts the user to take the next step in the dating process. If the rating is positive, the site may prompt the user to, for example, send a gift, such as flowers, or an SMS Message to the other participant in the date, as illustrated in FIG. 25. If the rating is negative, the site may prompt the user to, for example, go to an Internet dating site to continue his or her search for a compatible date, as illustrated in FIG. 26.

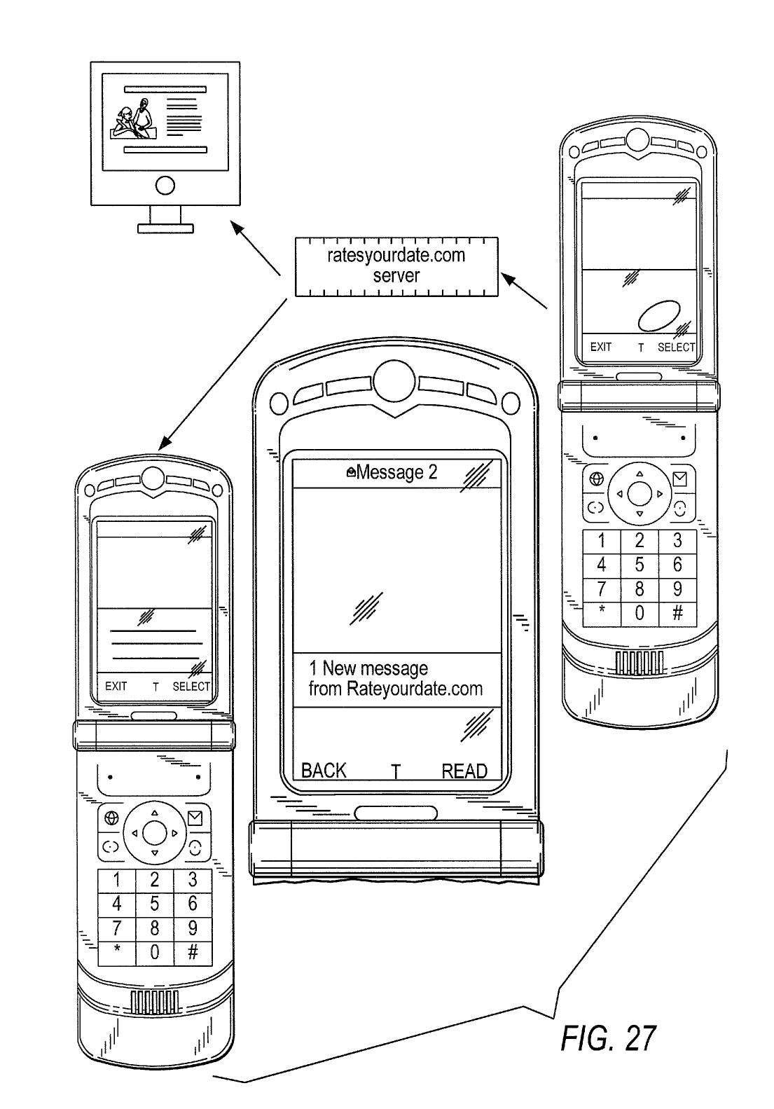

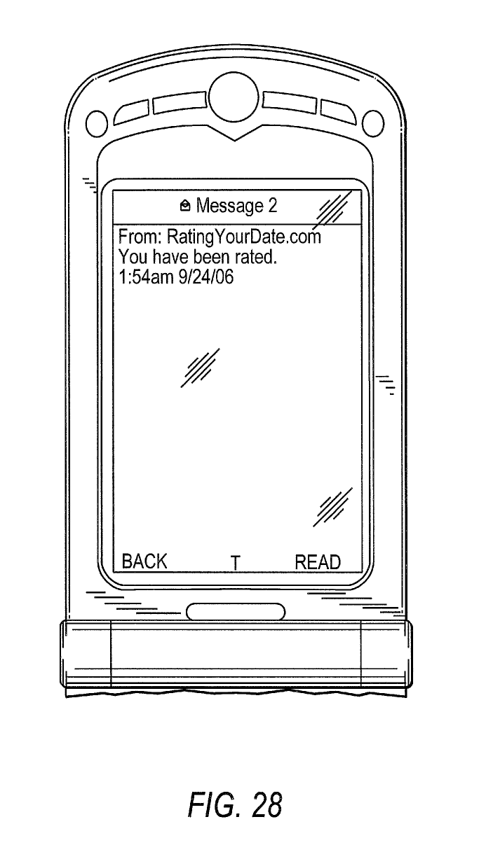

In step 1955, the site sends the date rating by, for example, Short Message Service (SMS) and/or email, to the other participant to the date, as illustrated in FIG. 27. In step 1960, the other participant is alerted on his or her mobile device that a rating has been received, as illustrated in FIG. 28. In step 1965, the other participant logs on to the site, as described previously.

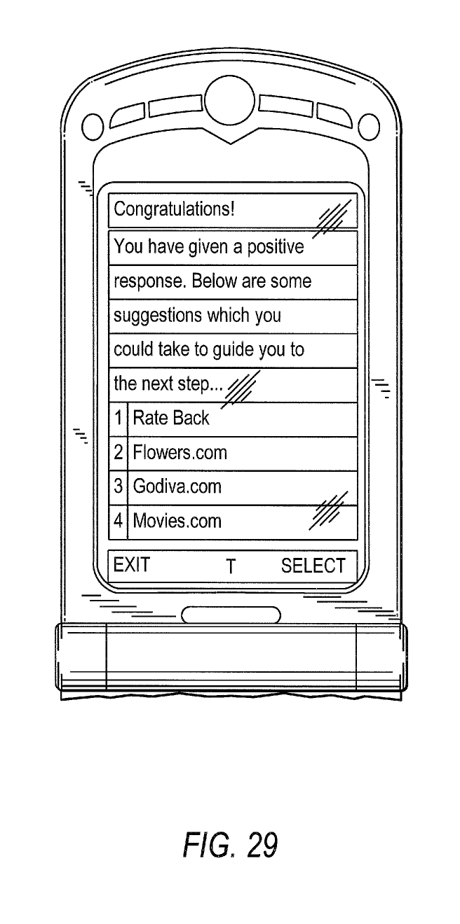

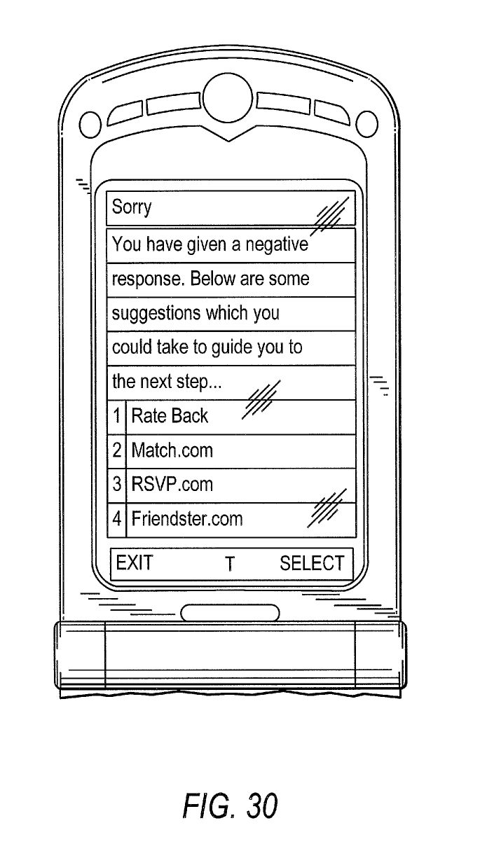

In step 1970, the other participant is prompted to respond to the rating, including an option to rate the user back. If the received rating is positive, the site may prompt the user to send a gift, such as flowers or chocolates, send a message back to the user, provide suggestions for a next date, such as a link to information about current movies, etc., as illustrated in FIG. 29. If the received rating is negative, the site may prompt the user to, for example, go to an Internet dating site to continue his or her search for a compatible date, as illustrated in FIG. 30.

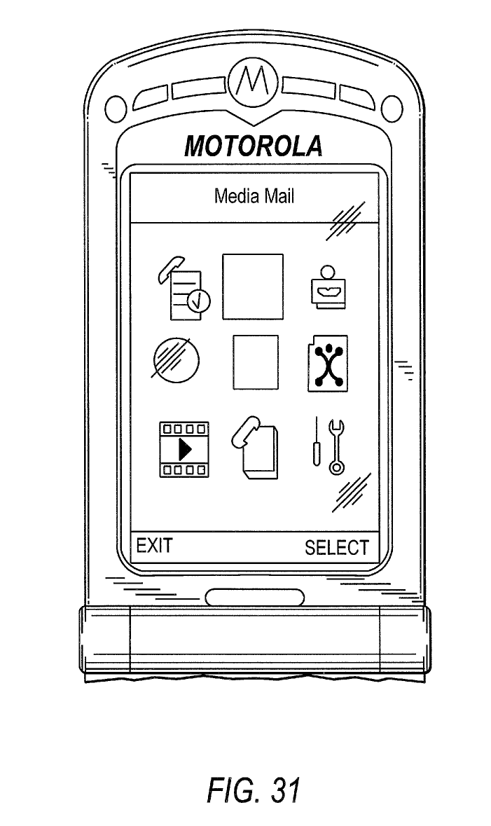

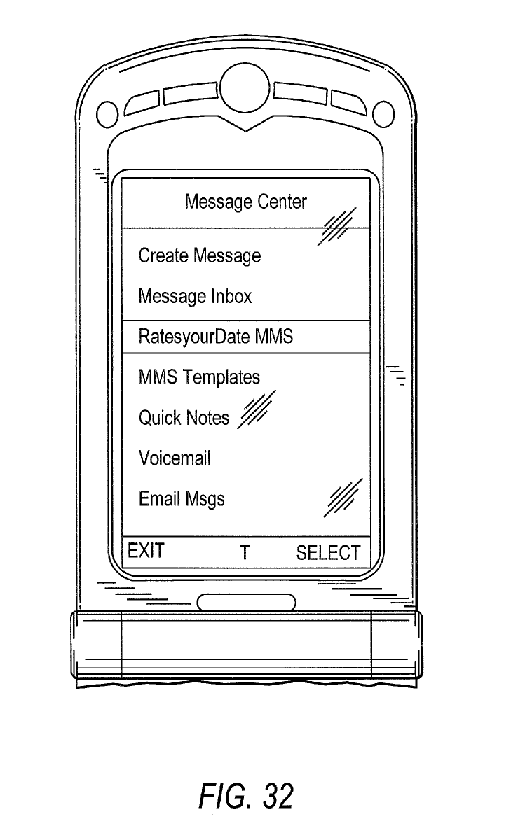

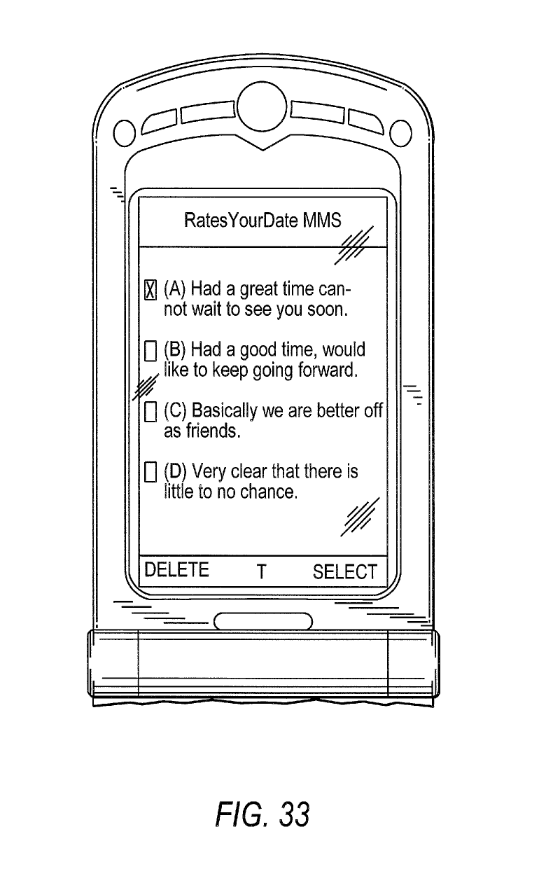

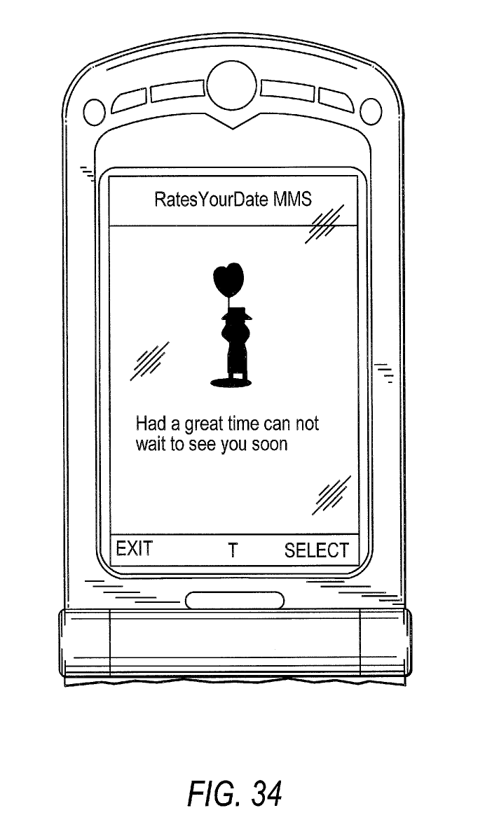

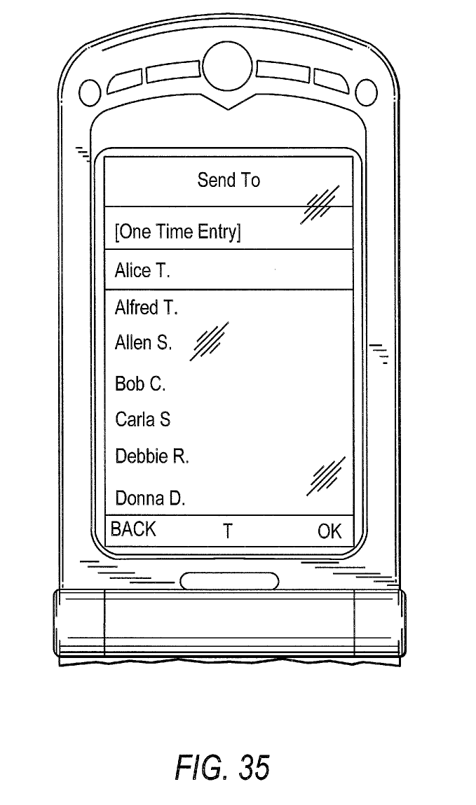

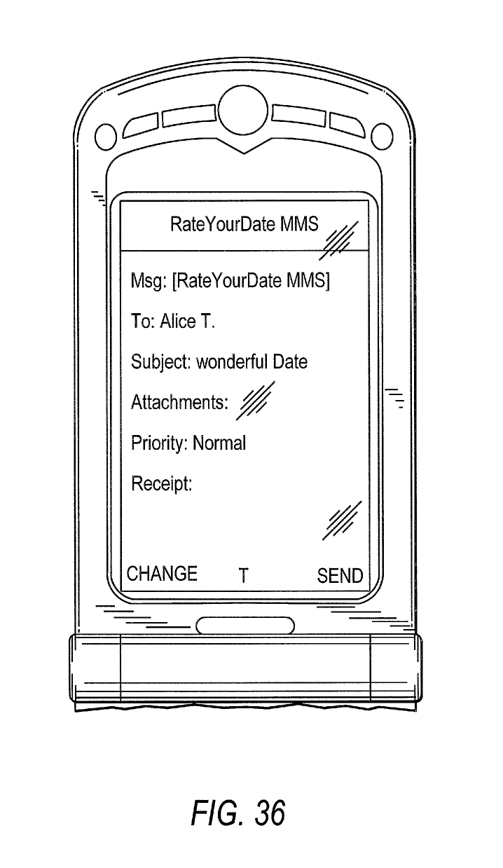

A system in accordance may also provide appropriate pre-written messages to be sent from one date participant to another. As illustrated in FIG. 31, a mail icon can be selected, which in turn displays mail and message related options, as illustrated in FIG. 32. If the date rating MMS menu option is selected (i.e., RatesyourDate MMS in FIG. 32), a number of pre-written messages is displayed, as illustrated in FIG. 33, for selection by the user. The user may also select an animation that will accompany the message, as illustrated in FIG. 34. The user can then either enter the phone number of the other participant or select it from the user's address book, as illustrated in FIG. 35. Lastly the user can add a priority to the message, as illustrated in FIG. 36.

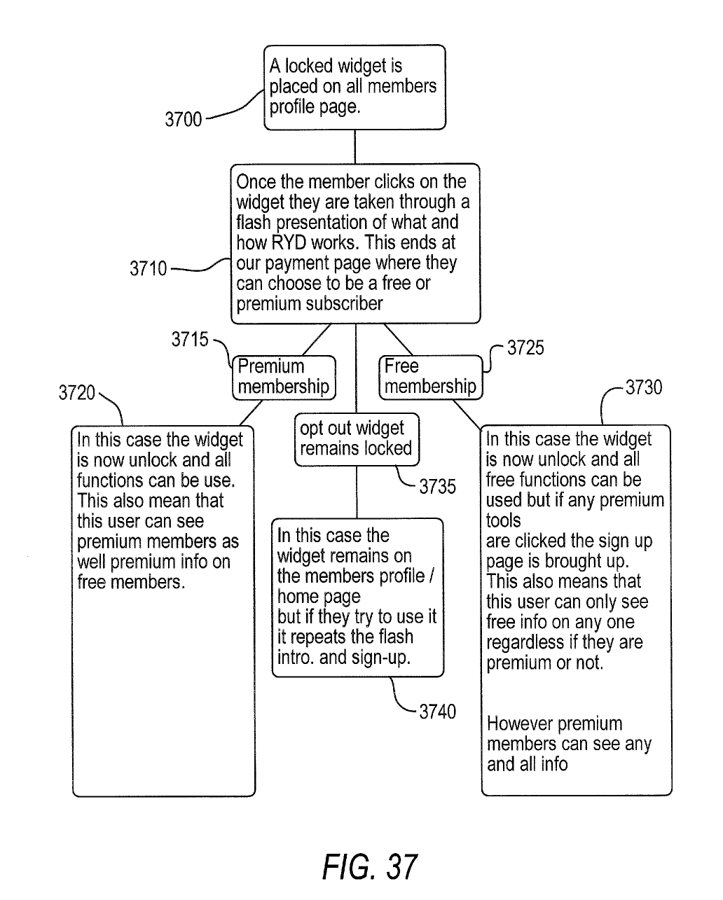

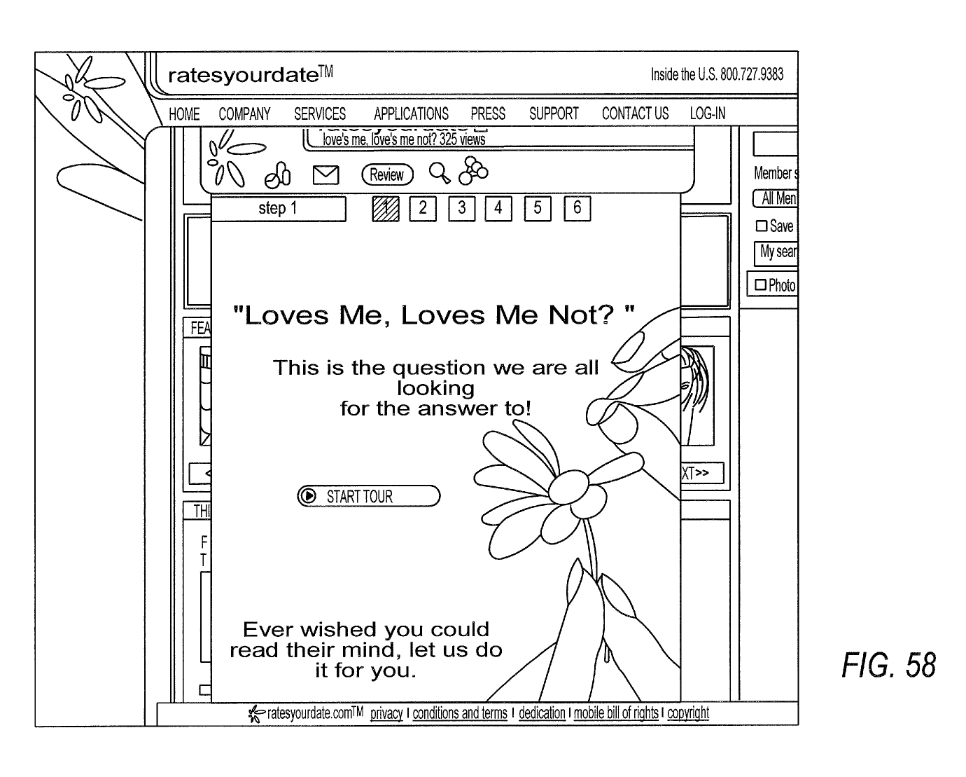

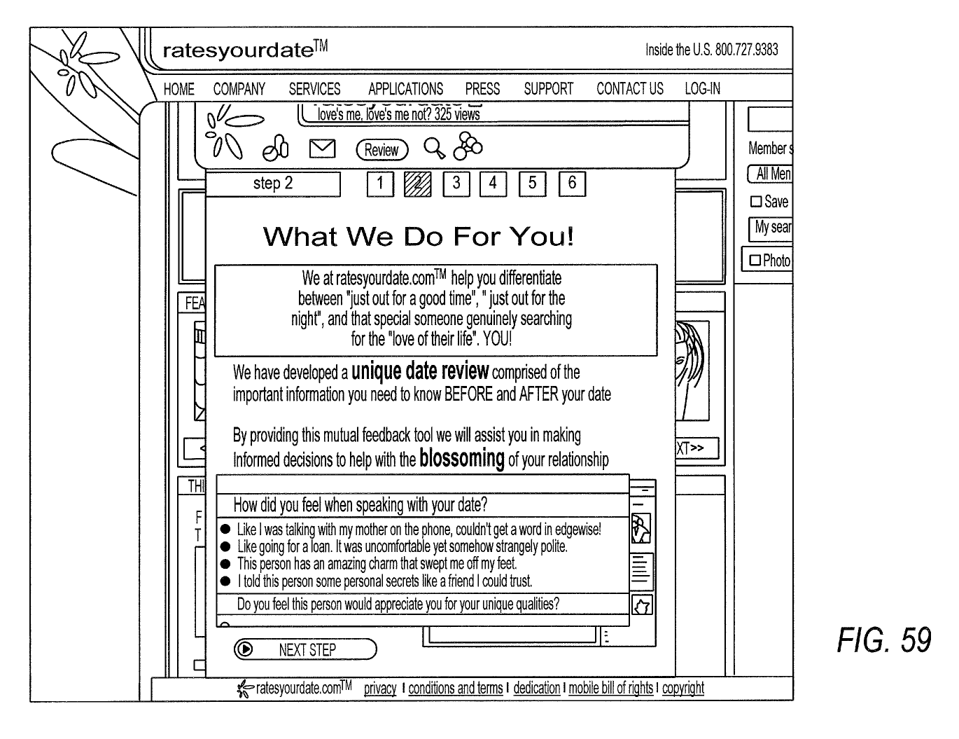

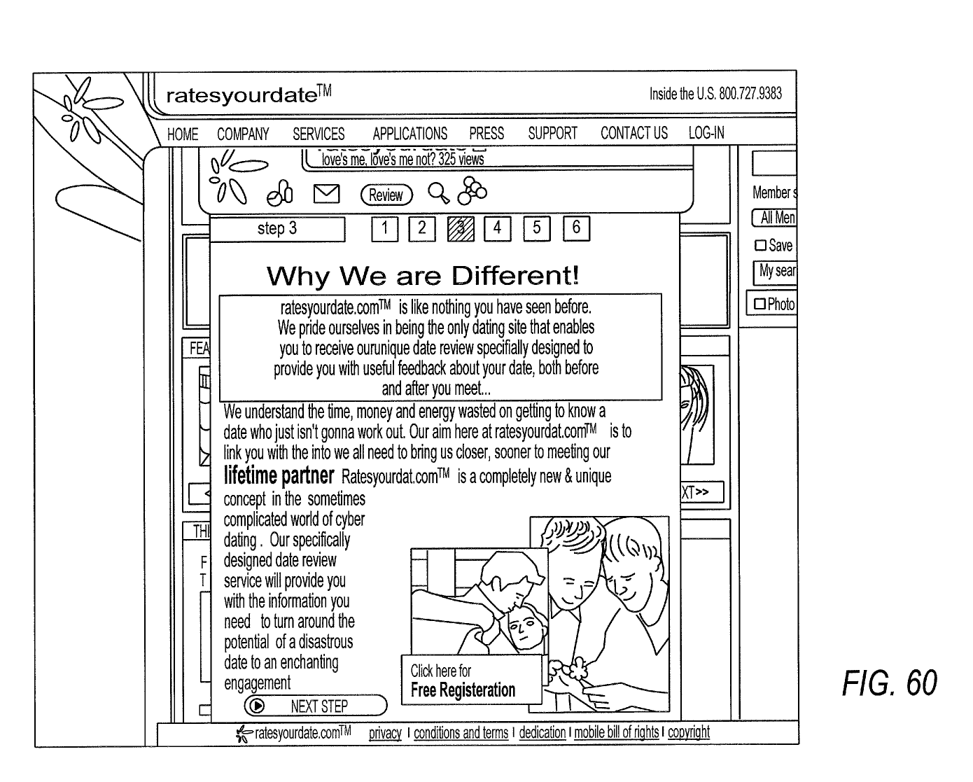

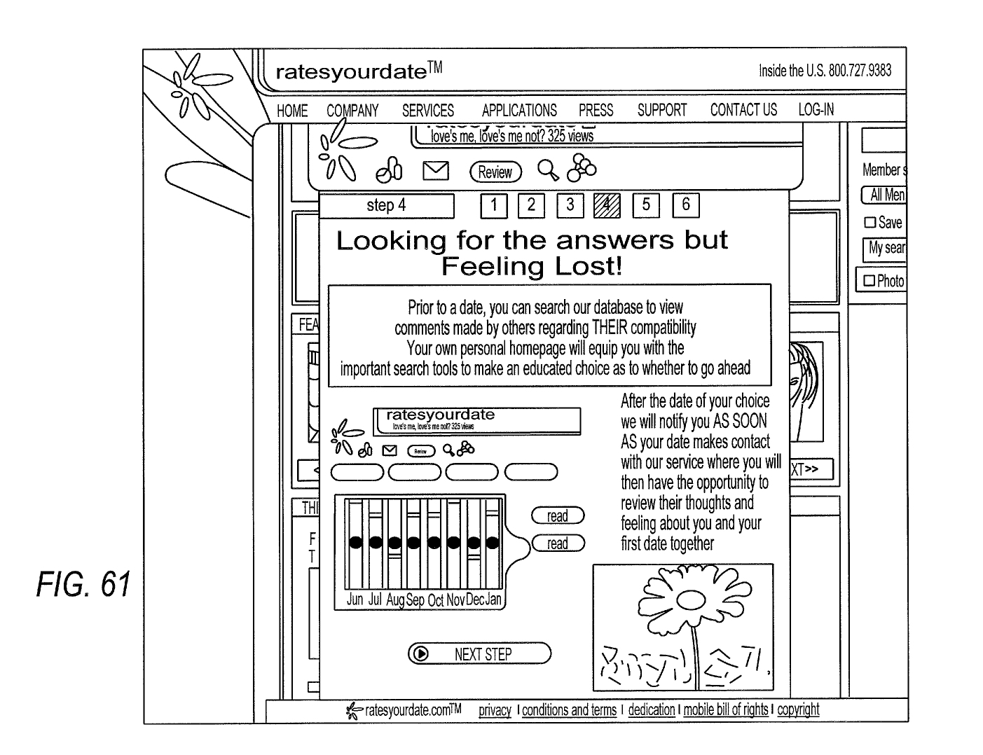

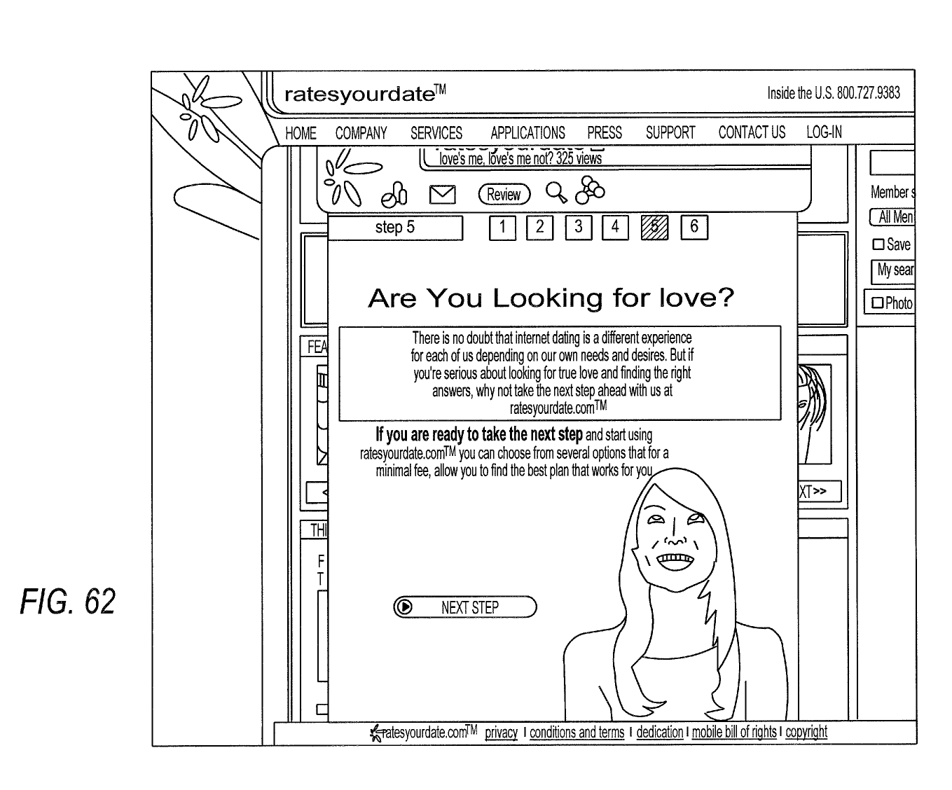

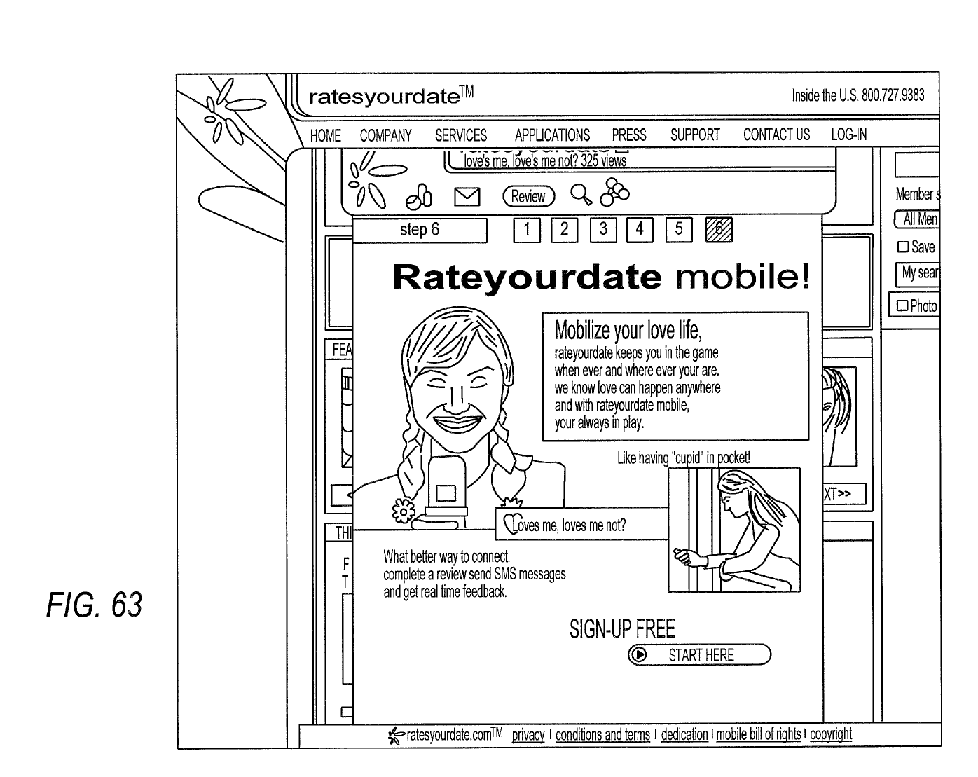

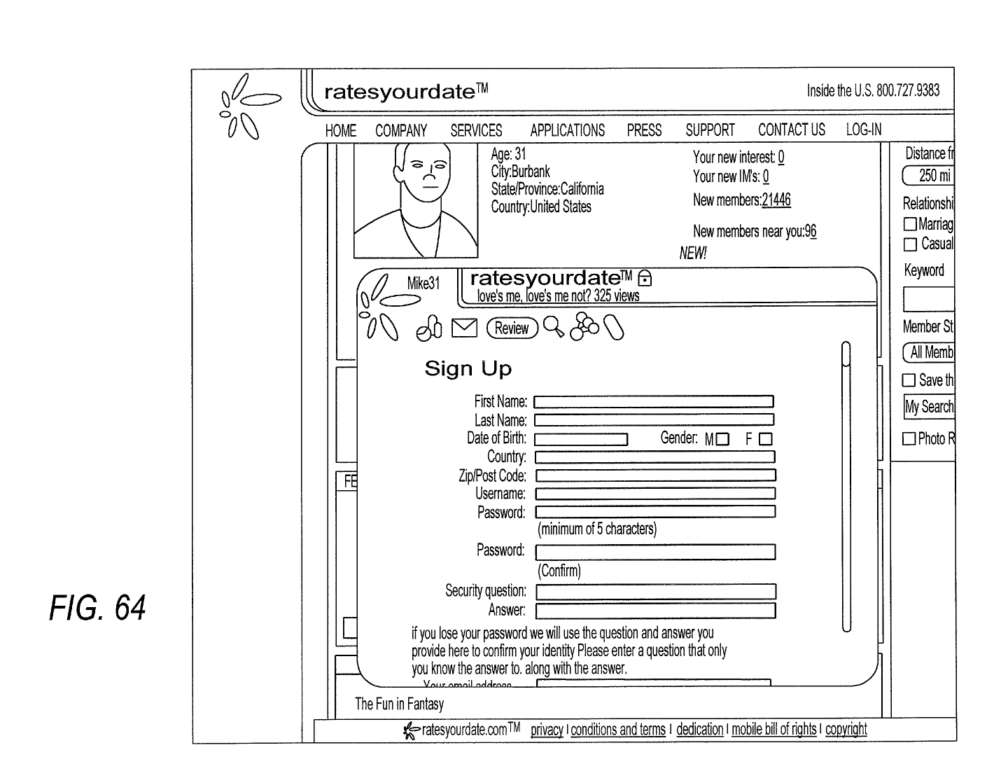

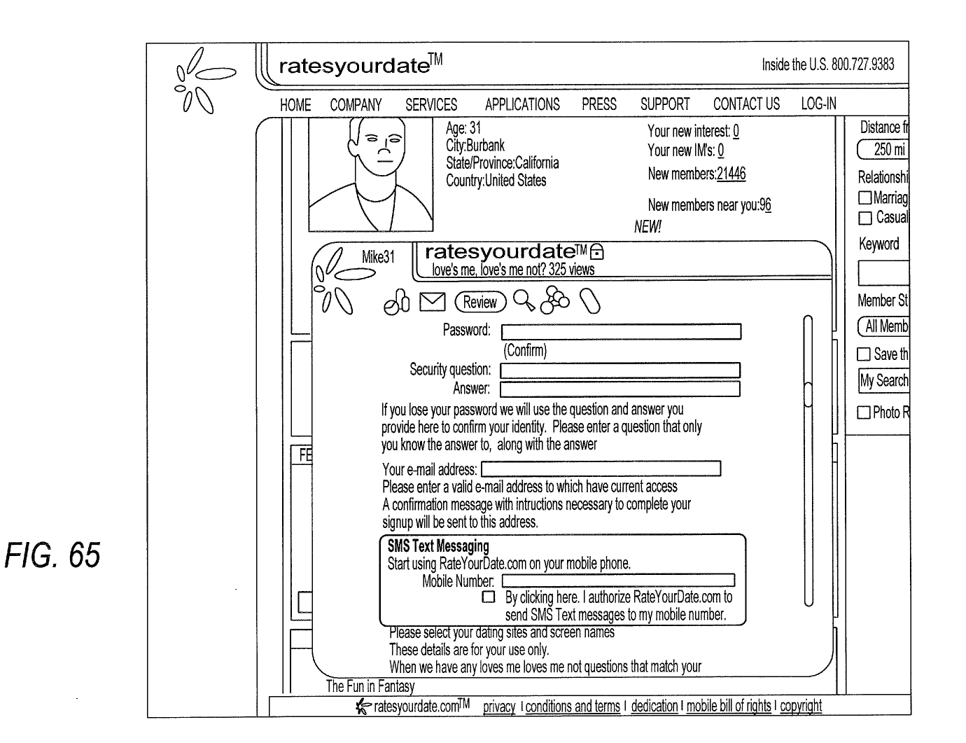

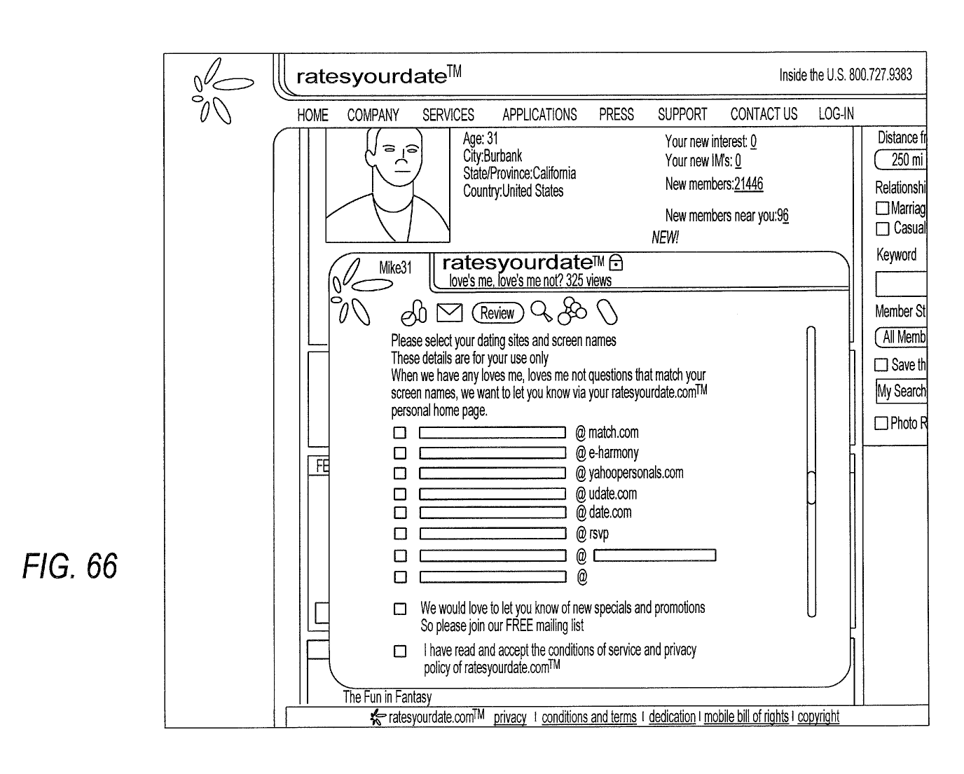

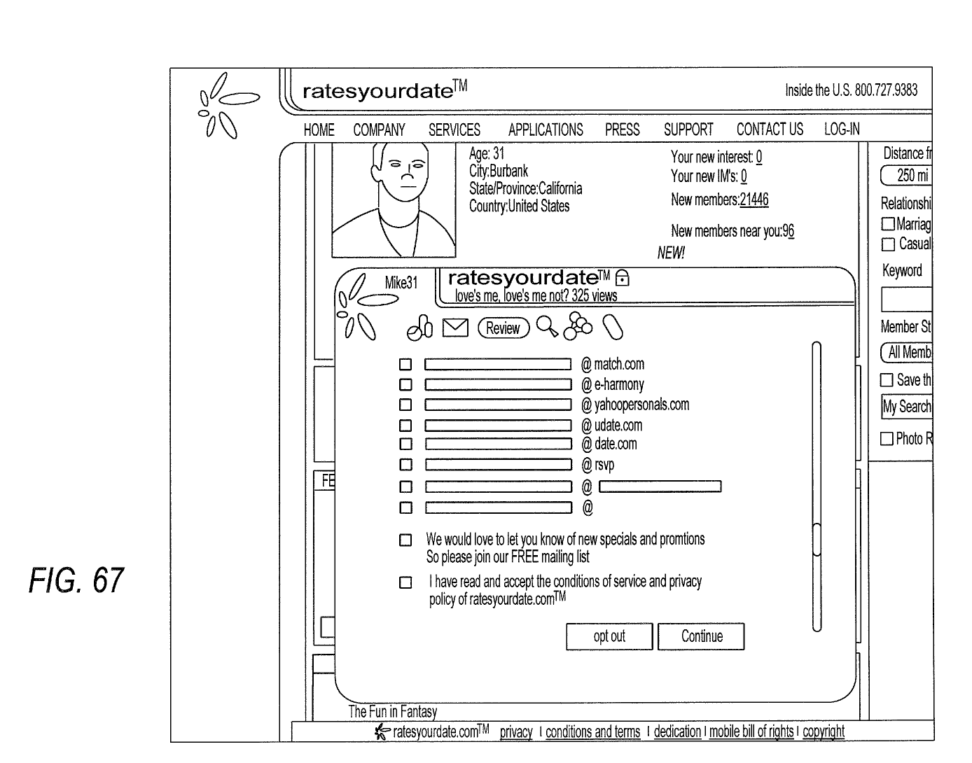

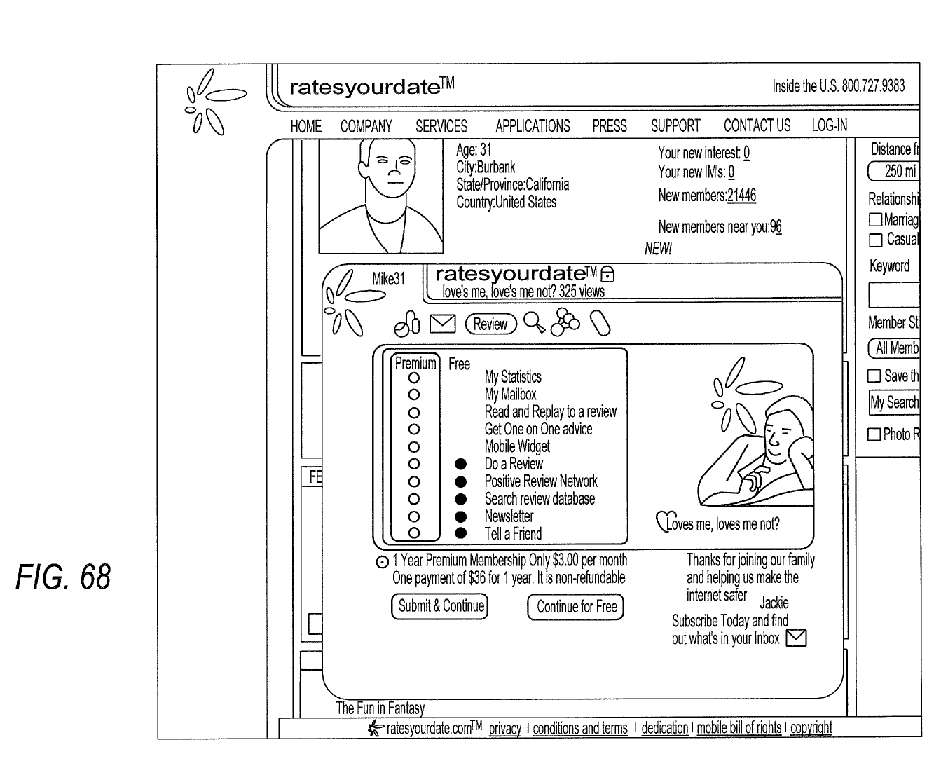

In one embodiment, a widget is provided as an interface means to a member of an Internet dating service. FIG. 37 illustrates the process of unlocking a widget. In step 3700, a locked widget is placed on a member's home page. A member's home page is a web page in which a member's profile can be accessed by the user and/or others, and may be hosted, for example, by an Internet dating site 225, as depicted in FIG. 2. In step 3710, once the member clicks on the widget he or she is taken, for example, through a flash presentation of how an Internet dating system in accordance with the present invention works, as shown in FIGS. 58-63. The member is then asked to sign-up for the service, as shown in FIGS. 64-69. A member can then choose to be a free or premium member of the service, as shown in FIG. 68, or to opt out of the selection process, as shown in FIG. 67.

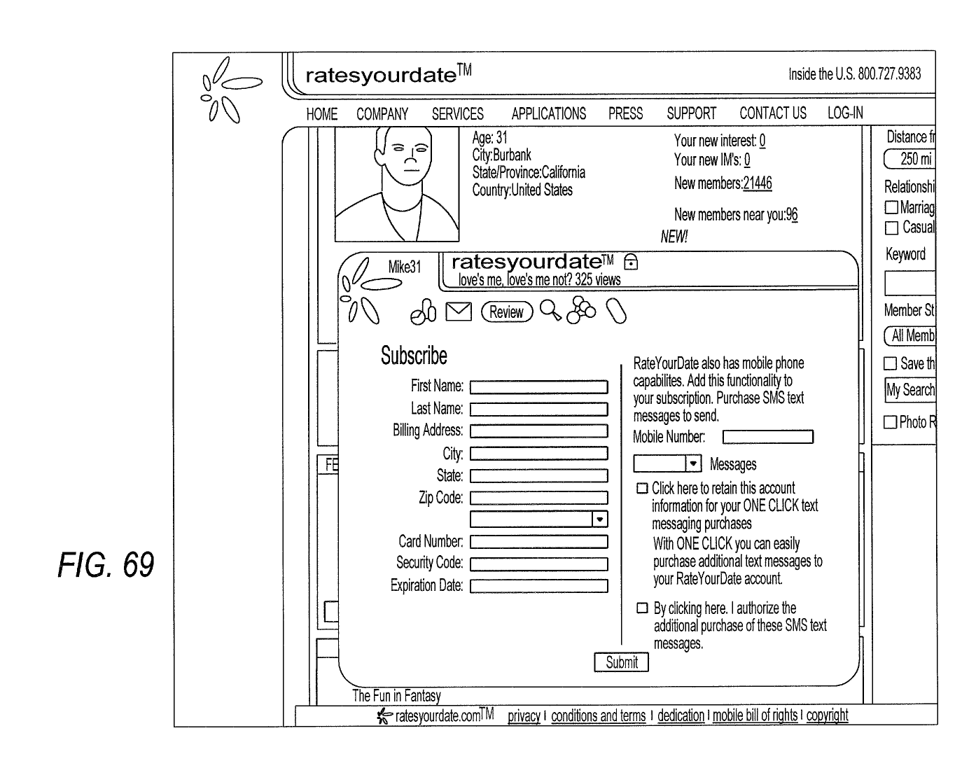

If the member chooses premium membership in step 3715, the member will complete a sign-up page and provide payment information, as shown in FIG. 69. As a premium member, the member will, in an exemplary embodiment, have full access to all services provide to members of the Internet dating system in accordance with the present invention, and will be provided with premium information regarding both other premium members and free members.

In step 3720, the widget is unlocked and the member is granted access to premium member services.

If the member chooses free membership in step 3725, the member will complete a sign-up page, but not provide payment information. As a free member, the member will, in an exemplary embodiment, have use of all free aspects of an unlocked widget for any other member, both premium and free. The widget for a free member may appear the same as a widget for a premium member, other than, e.g., a modified logo, but when the member tries to use a premium service, the premium service sign-up page appears.

In step 3730, the widget is unlocked and the member is granted access to free member services. A free member can only see free information on other users, regardless of whether the other user is premium or not.

In one embodiment, both free and premium members can complete a review, notify a date, invite friends, receive newsletters, and receive dating advice based on reviews done of him or her. A premium member can also review and reply to ratings done of him or her, view his or her dating statistics and the dating statistics of other members, including both premium and free members, and save searches and ratings.

If the member chooses to opt out in step 3735, the widget remains locked. In that case, in step 3640, the widget remains on the member's profile/home page, but if the member tries to use it, the flash presentation and sign-up information is repeated.

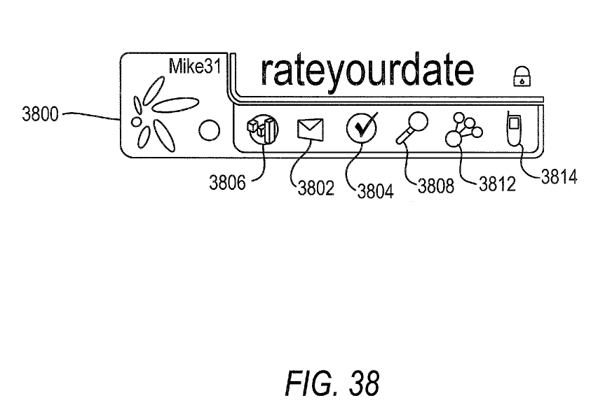

As shown in FIG. 38, a widget 3800 may have a number of selectable icons, buttons, links, or other selection mechanism within in it, such as My mailbox icon 3802, Do a review/rate icon 3804, My statistics icon 3806, Search icon 3808, Invite my friends icon 3812 and mobile phone icon 3814. Other icons may also be included in the widget, such as, for example, a Newsletter icon.

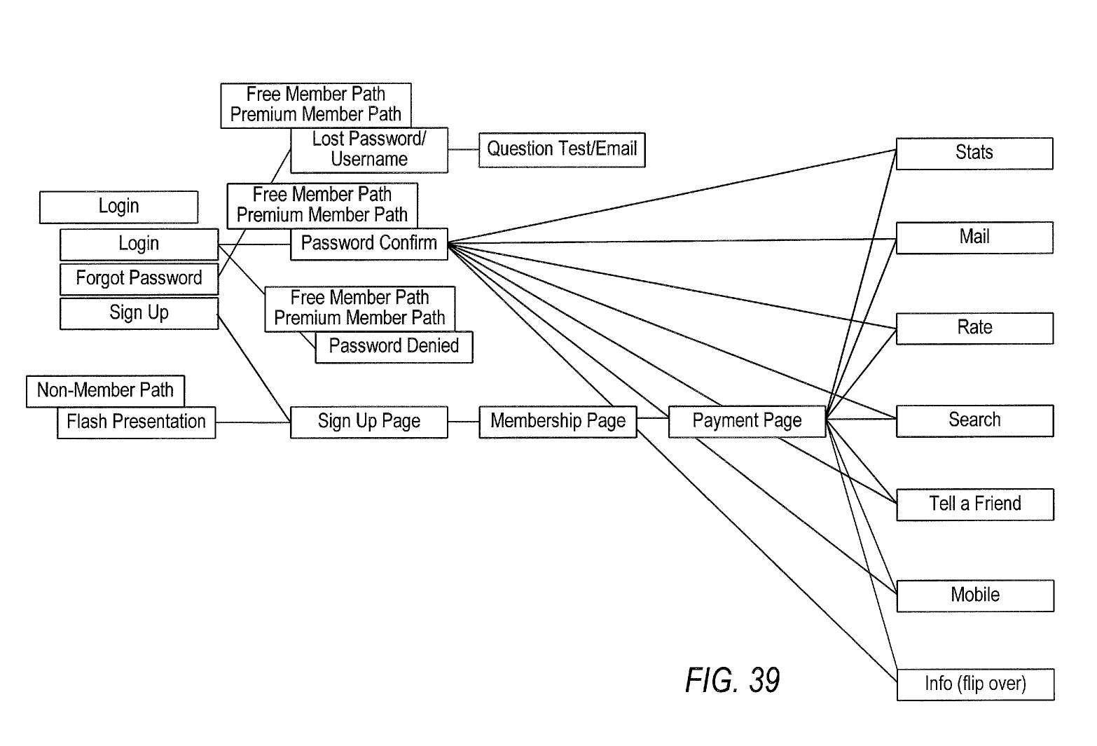

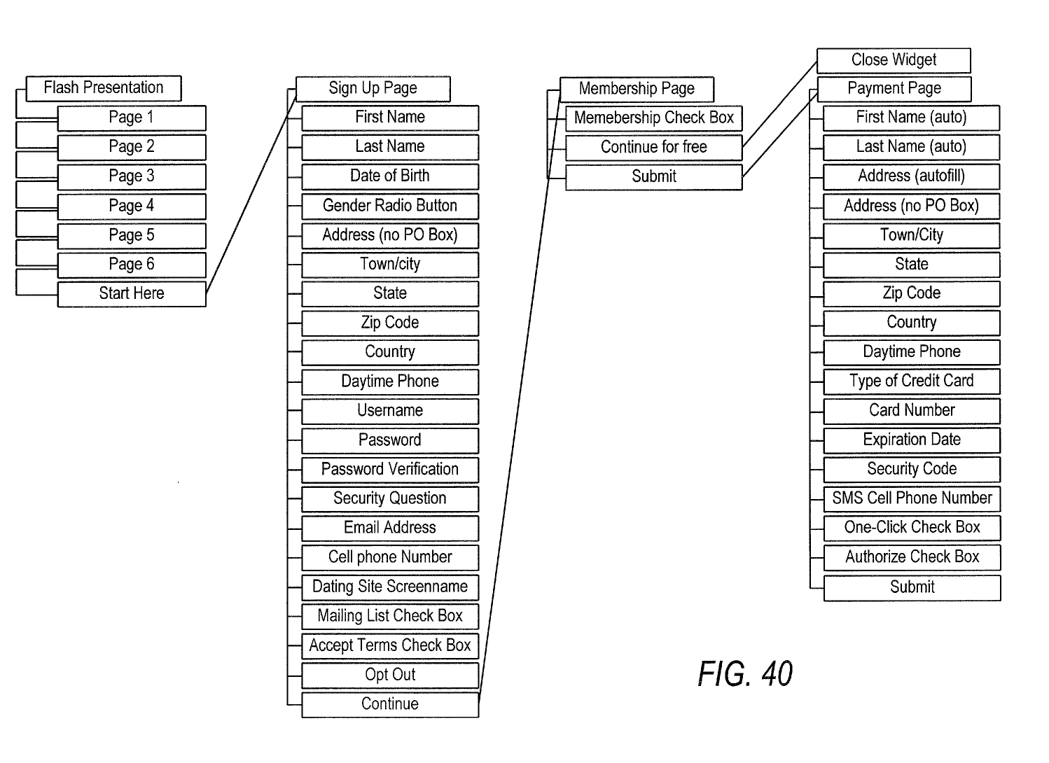

FIG. 39 illustrates a site map for the front-end of an embodiment of widget 3800. When a new user accesses the widget, the user is shown a flash presentation, a sign up page, and, if the user so chooses, a membership page and a payment page, as further illustrated in FIG. 40. In the course of the sign up procedure, the user may opt to become a free member, a premium member, or opt out. If a member accesses the widget, a log in procedure is followed, as shown in FIG. 39. Premium or free members may then select one of the icons or links—for example, statistics (“stats”), mailbox (“mail”), review/rate (“rate”), search, invite my friends (“tell a friend”) or mobile phone (“mobile”). The member may also select “Info (flip over)” to display additional information or choices.

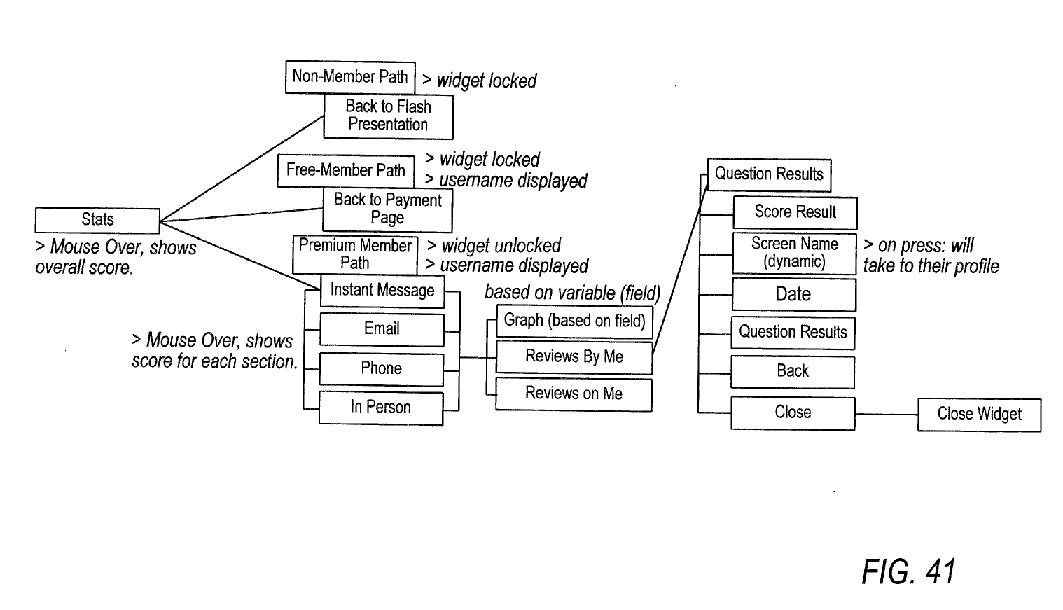

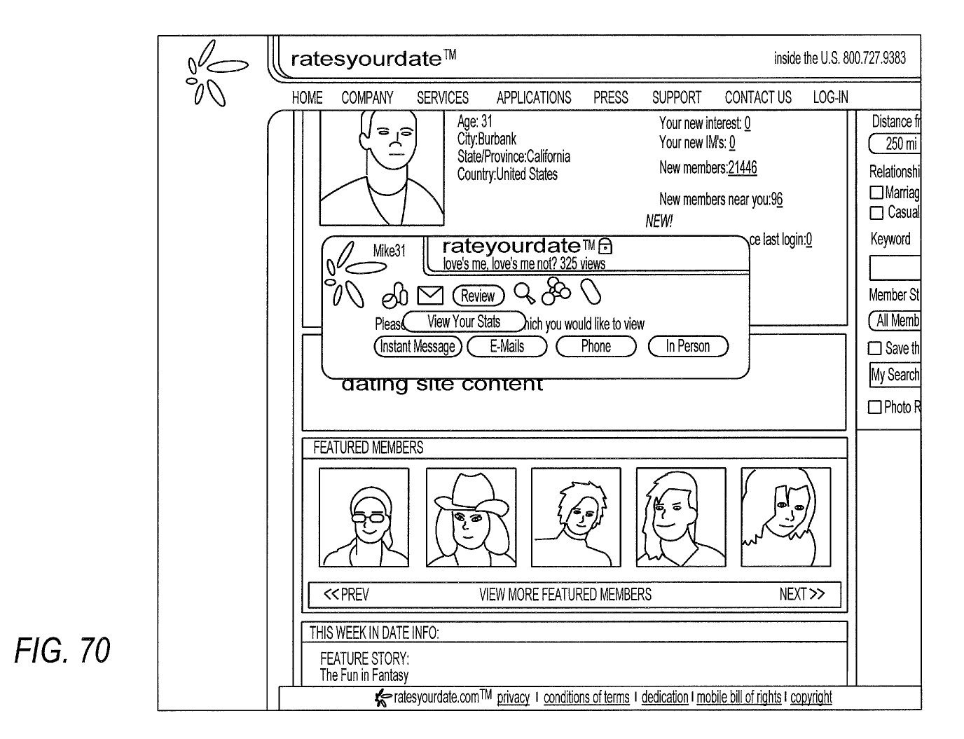

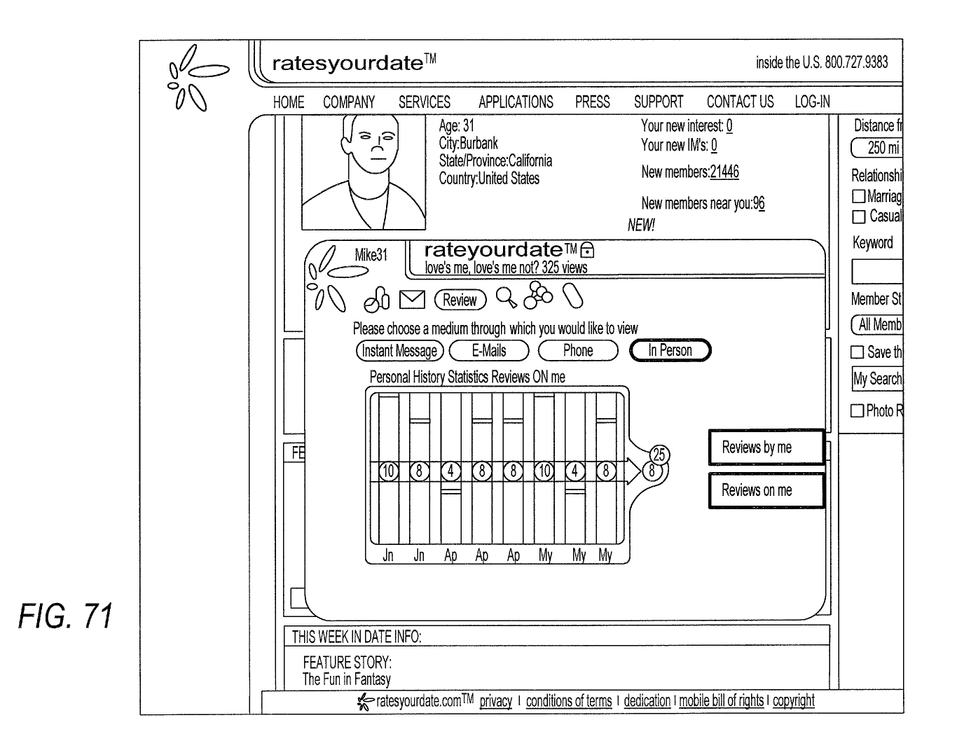

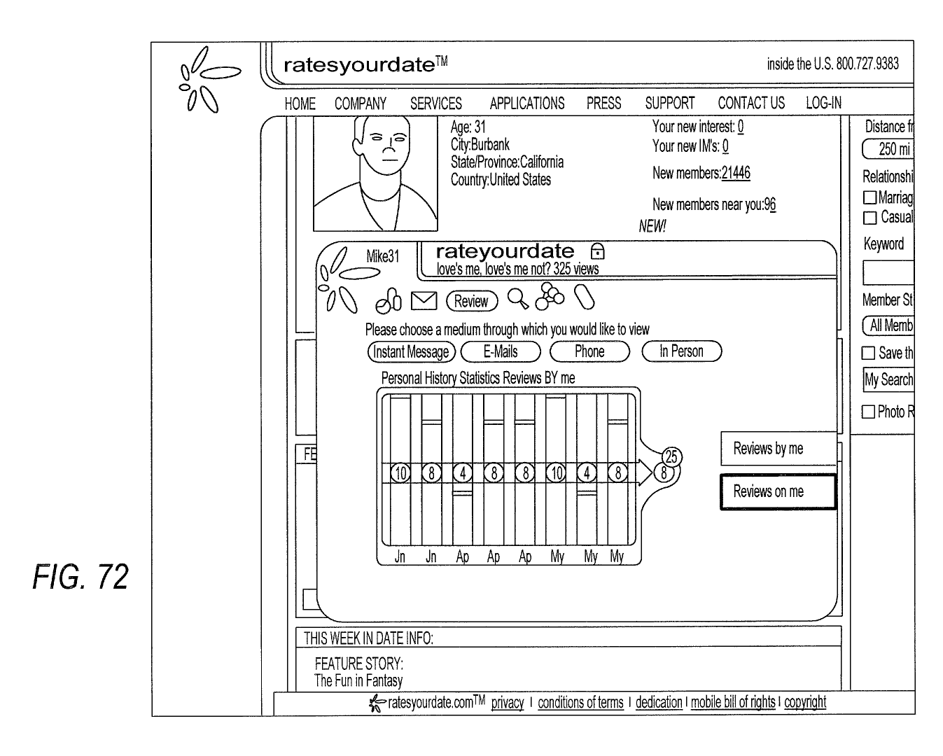

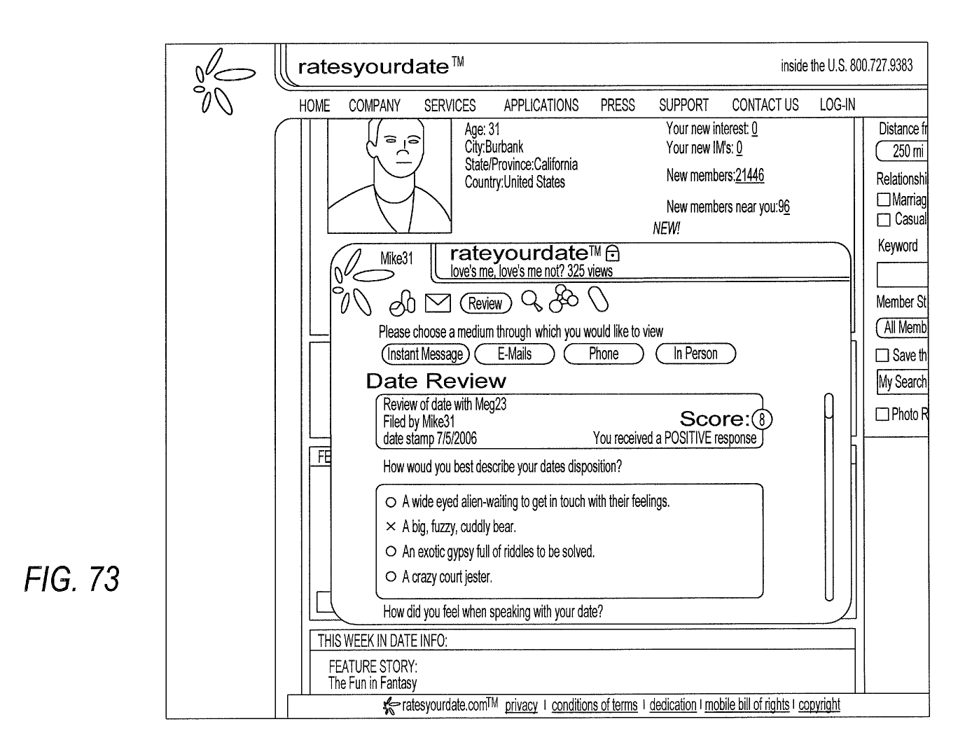

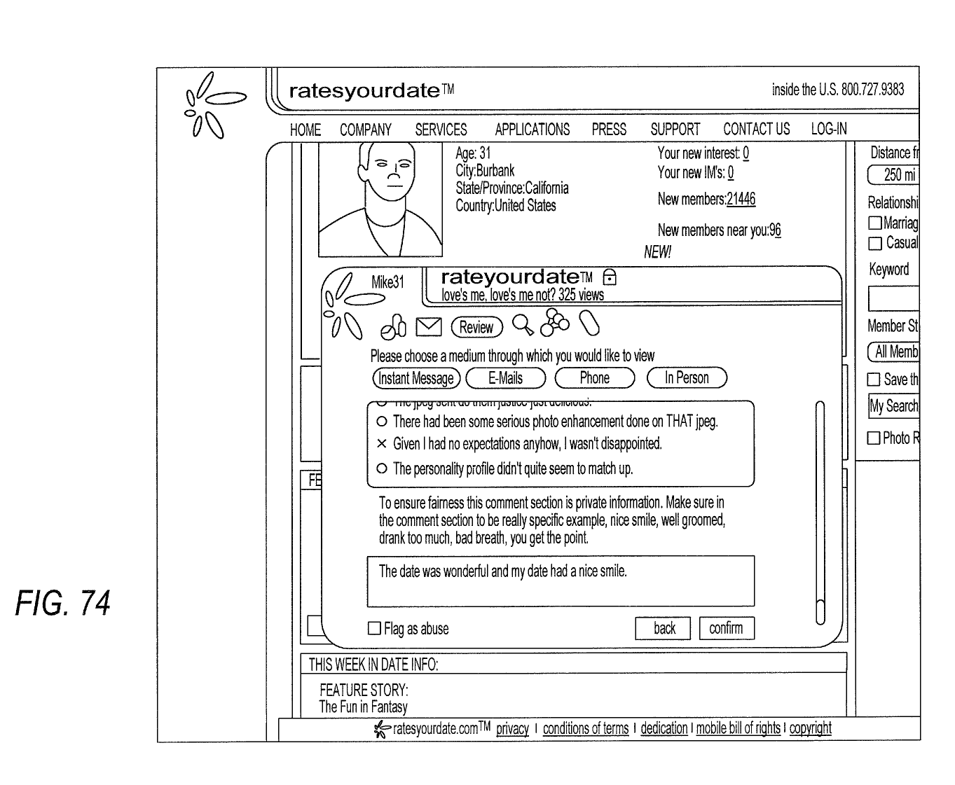

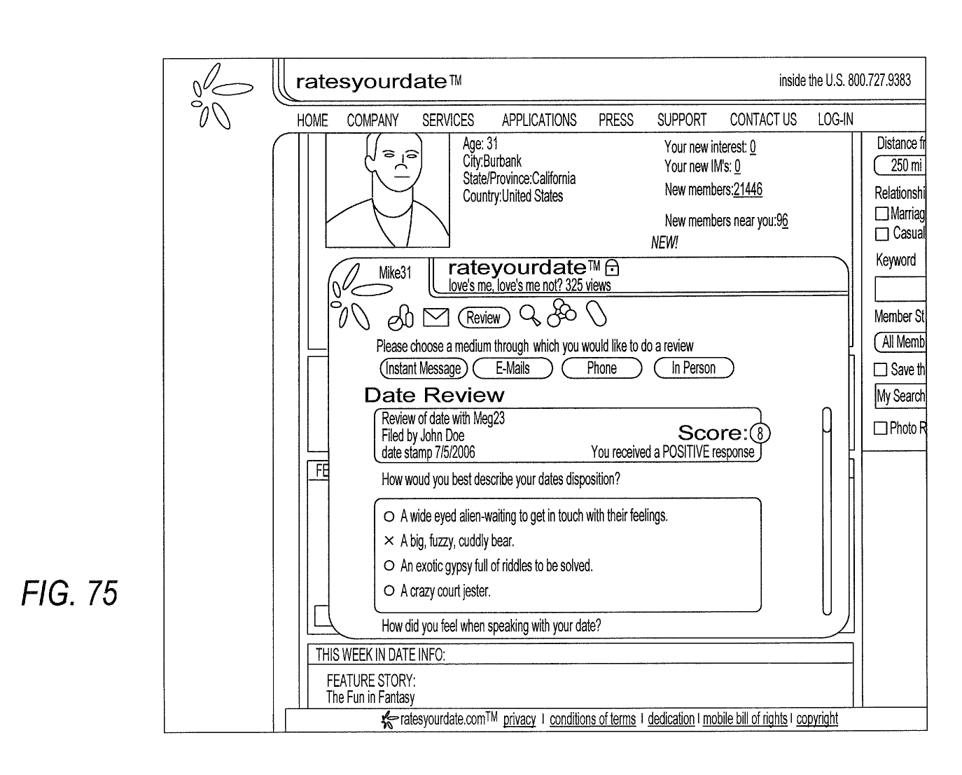

FIG. 41 provides an illustrative flowchart of the procedure followed if the My statistics icon 3806 is selected. As illustrated, in one embodiment, the provision of statistical information is a premium feature. Statistical information regarding both the member's reviews and reviews of the member are provided. Selection of the IM icon provides statistical information regarding IM conversations; selection of the e-mail icon provides statistical information regarding e-mail conversations; selection of the phone icon provides statistical information regarding phone conversations; and selection of the in-person icon provides statistical information regarding in-person date conversations. The statistical information may include, for example, the number of conversations of a particular type that the member has been rated or has rated others and the scores received or given. The information may be provided in the form of graphs such as bar graphs. Clicking on a portion of a graph, such as a bar in a bar graph, may provide additional information about the data underlying that portion of the graph. FIGS. 70-75 show various illustrative screen shots of this feature.

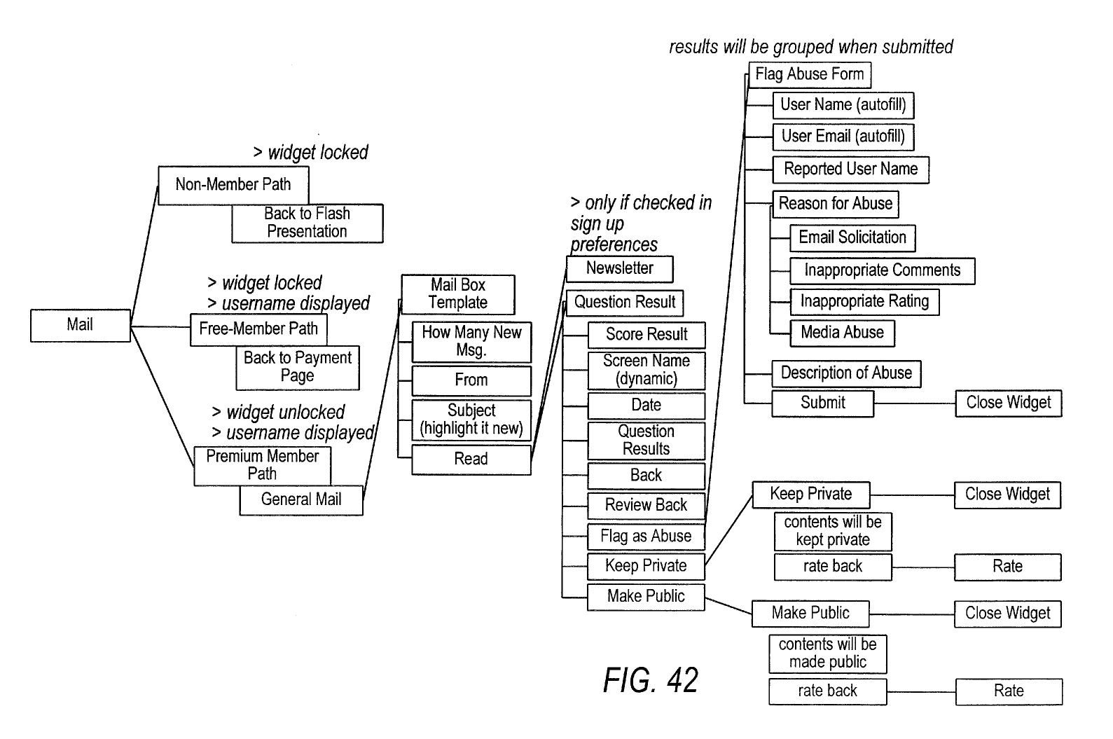

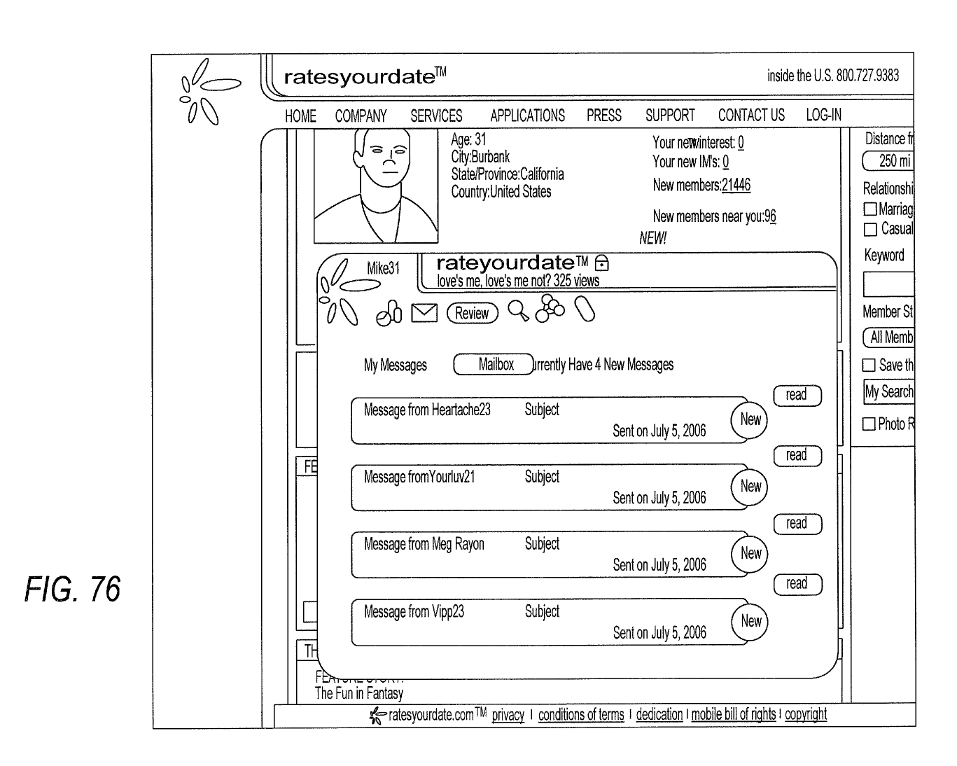

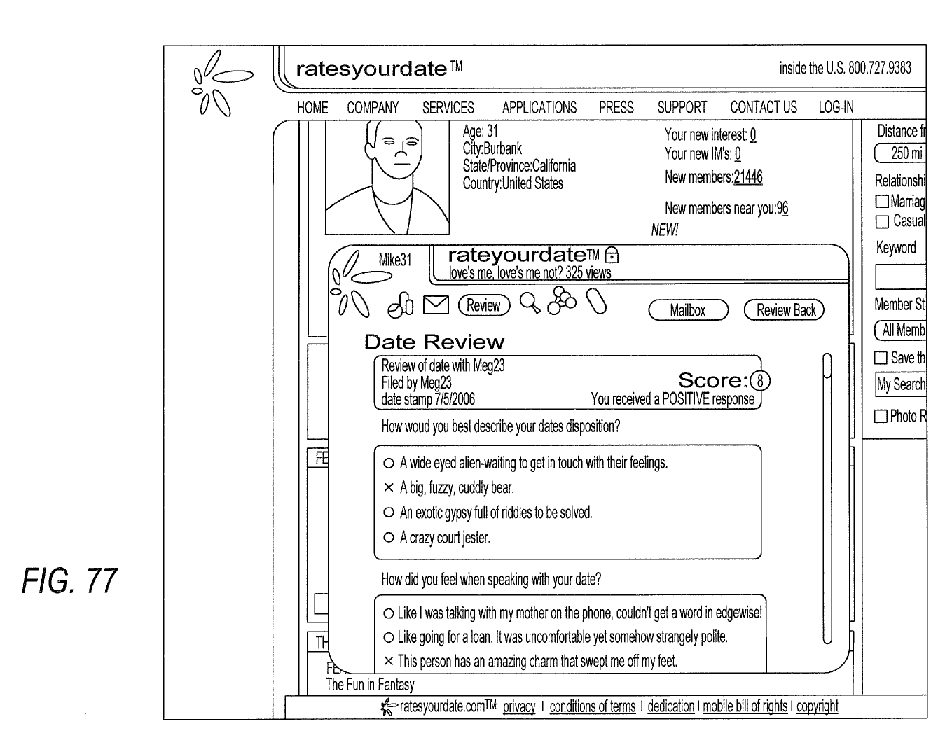

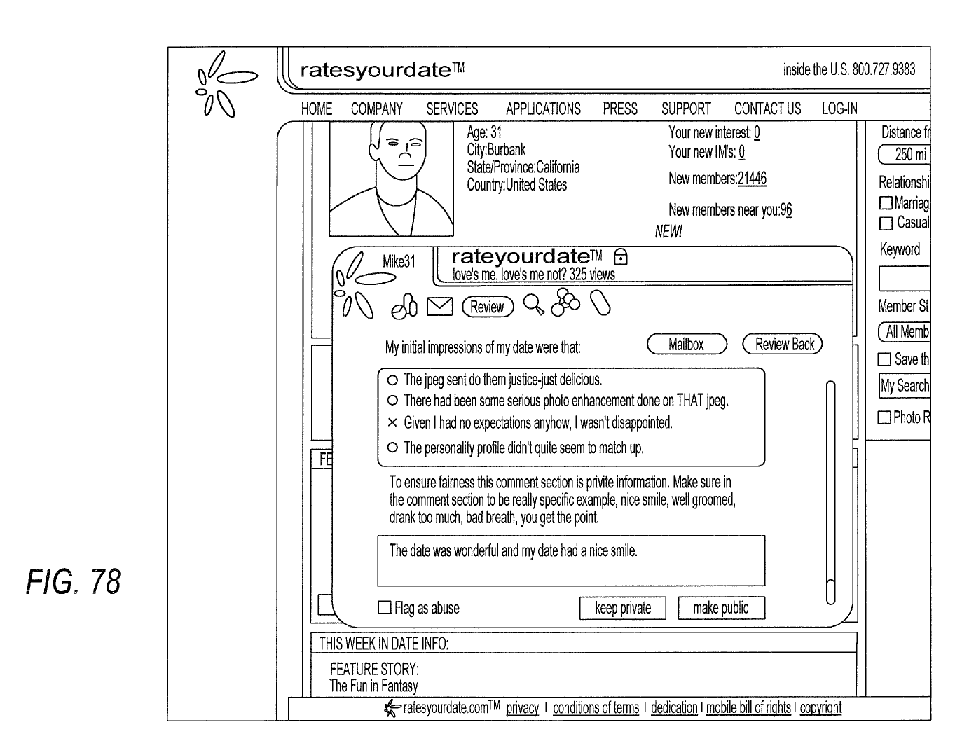

FIG. 42 provides an illustrative flowchart of the procedure followed if the My mailbox icon 3802 is selected. The member is then able to access his or her mailbox and read and respond to ratings done of the member. In one embodiment, members may receive ratings (i.e., questionnaire results) and newsletters in their mailboxes. Once a member has read a review, he or she may choose to make the comment box in the review public or private. If the member does not agree with a review, he or she may, in one embodiment, identify another person who can provide a recommendation for the member and verify that the review was inaccurate. FIGS. 76-78 show various illustrative screen shots of this feature.

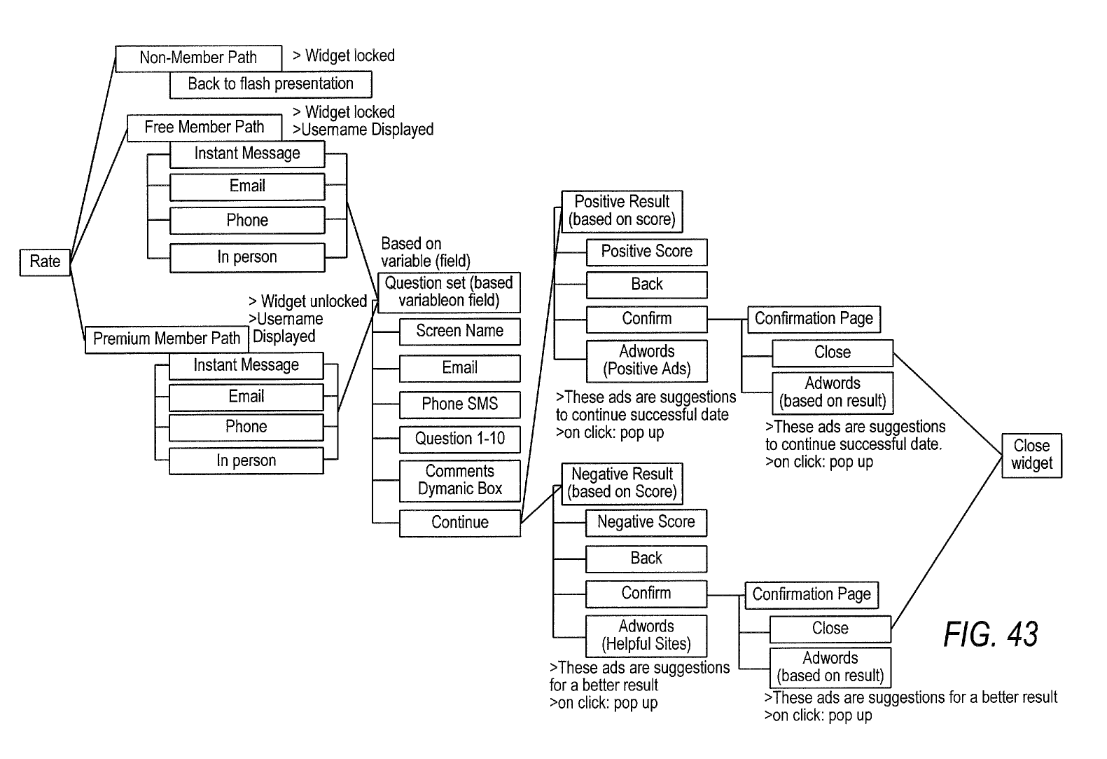

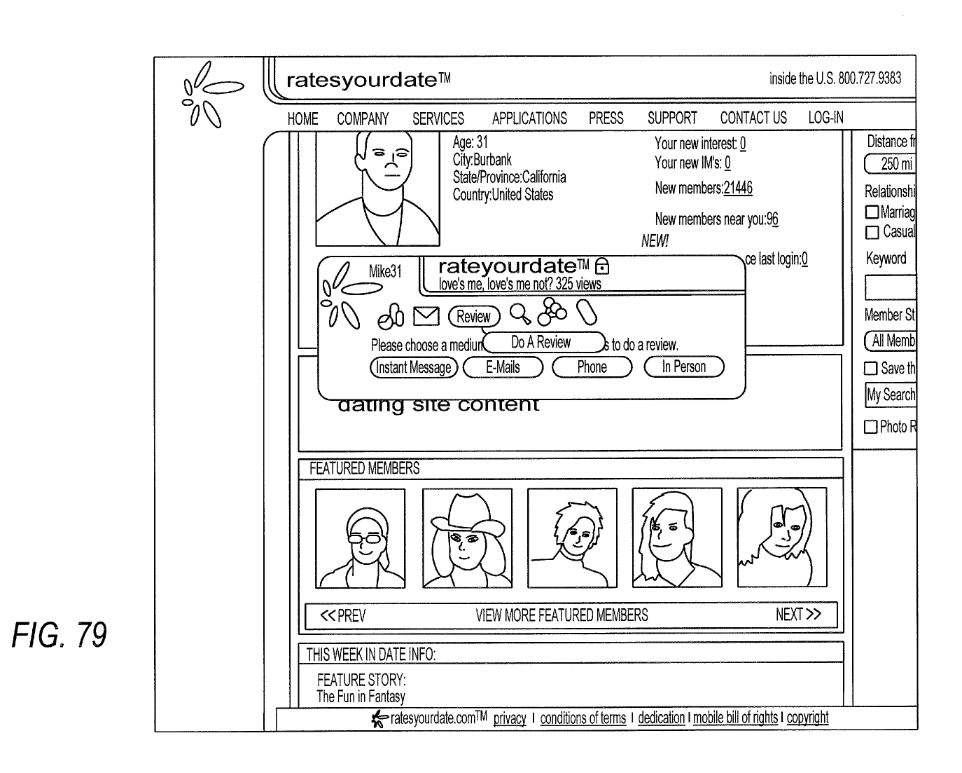

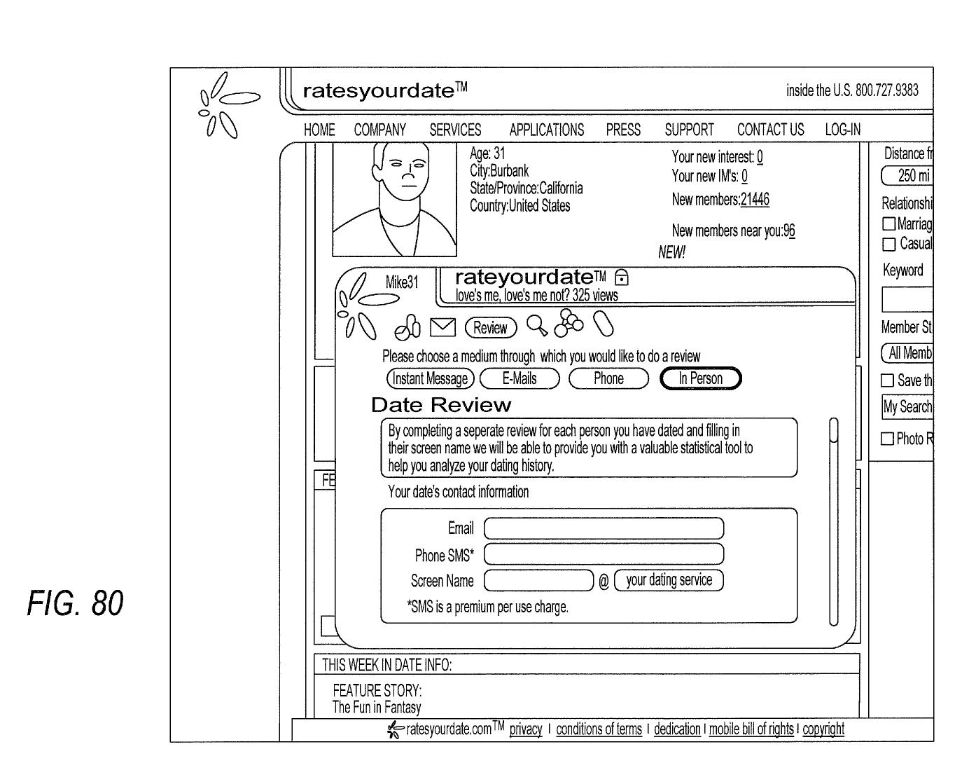

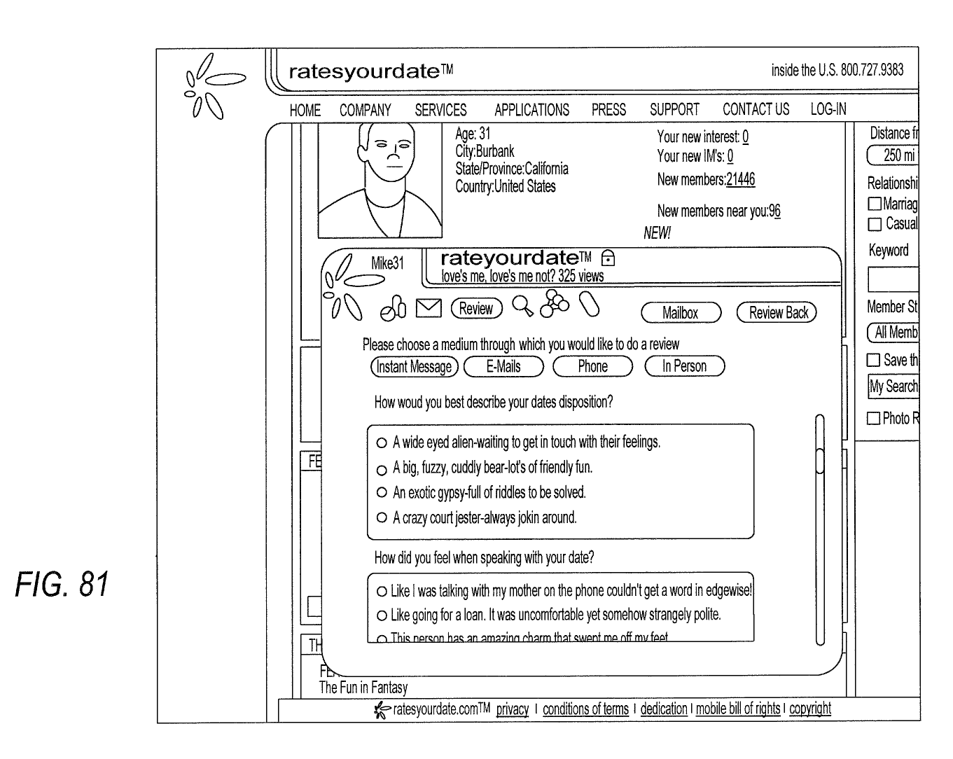

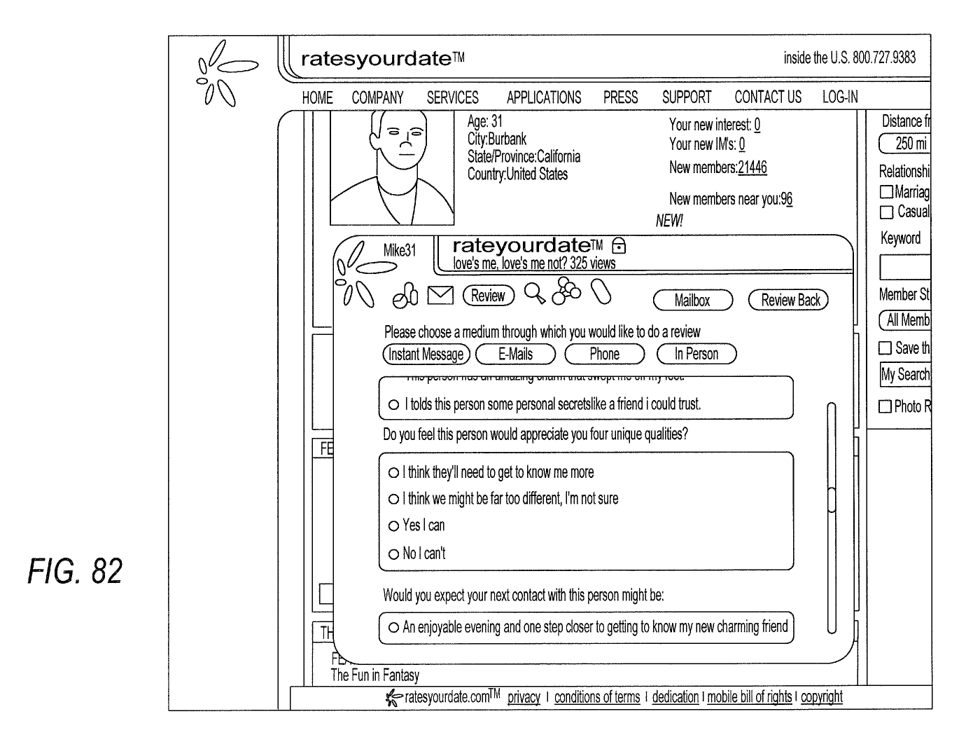

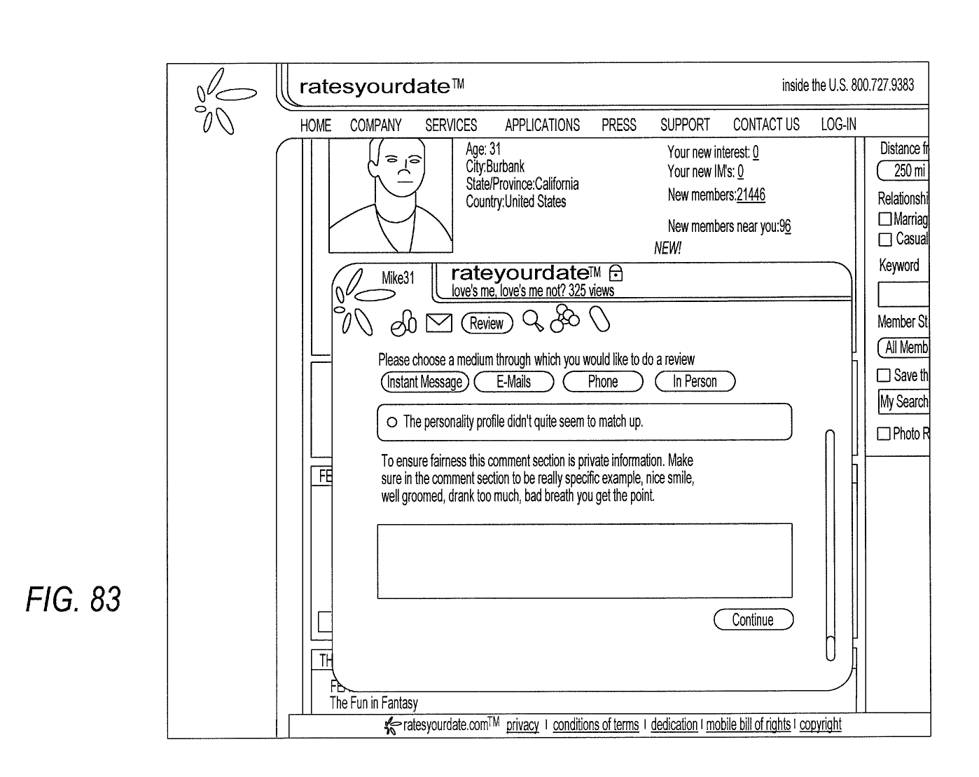

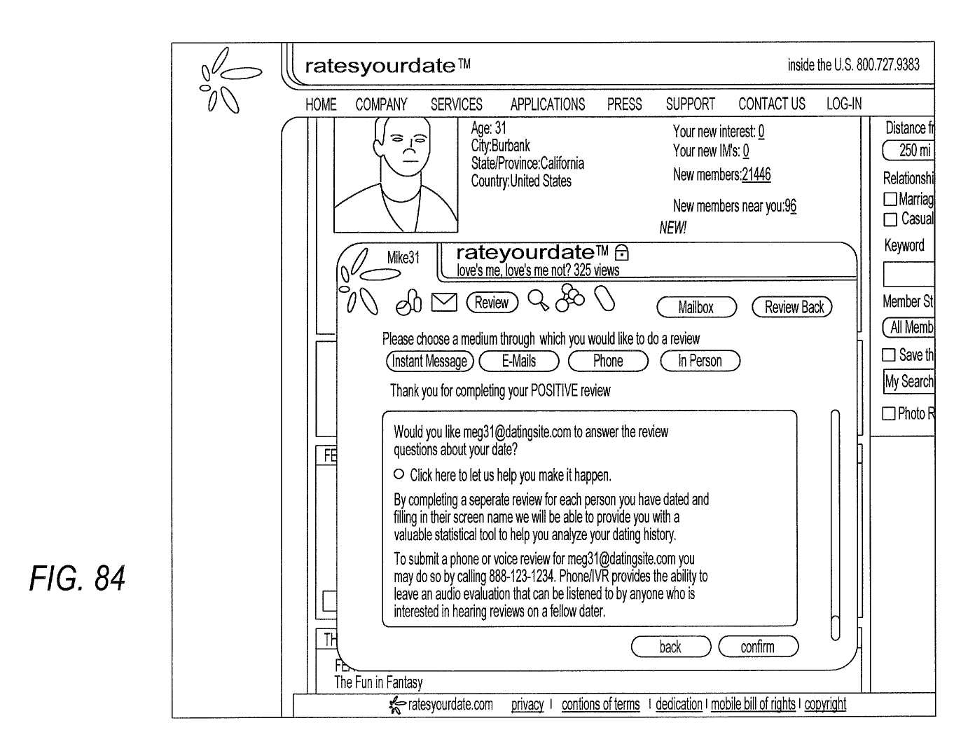

FIG. 43 provides an illustrative flowchart of the procedure followed if the Do a review/rate icon 3804 is selected. Once selected by a member, the IM icon 3816, e-mail icon 3818, phone icon 3820, and in-person icon 3822 are displayed. If the IM icon 3816 is selected, the member is prompted to review an IM conversation. If e-mail icon 3818 is selected, the member is prompted to review an e-mail conversation. If phone icon 3820 is selected, the member is prompted to review a phone conversation. If in-person icon 3820 is selected, the member is prompted to review an in-person date. FIGS. 79-84 show various illustrative screen shots of this feature.

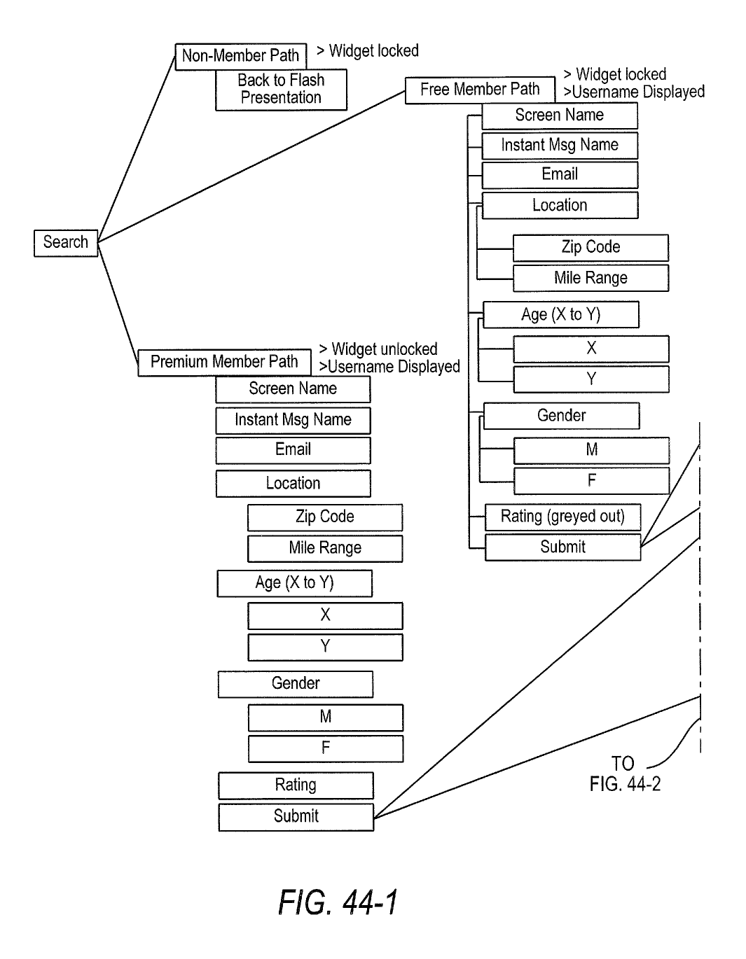

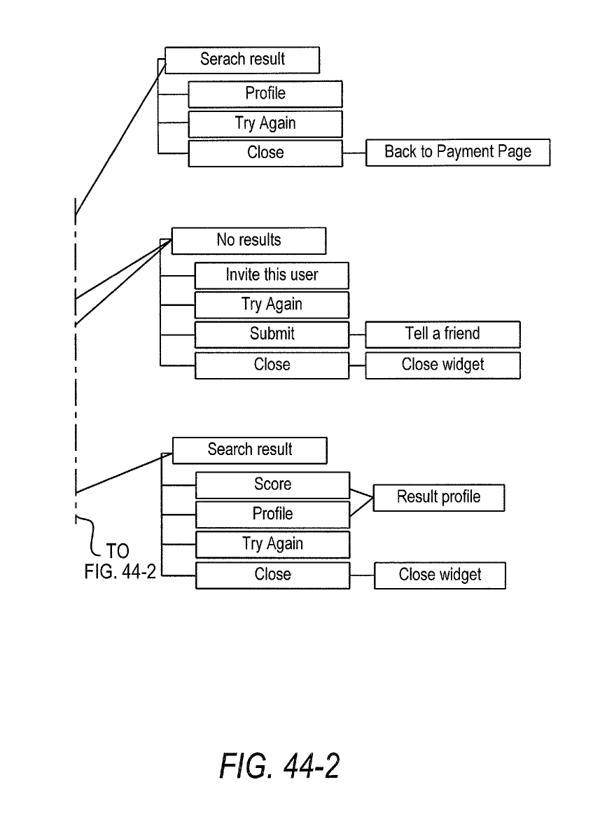

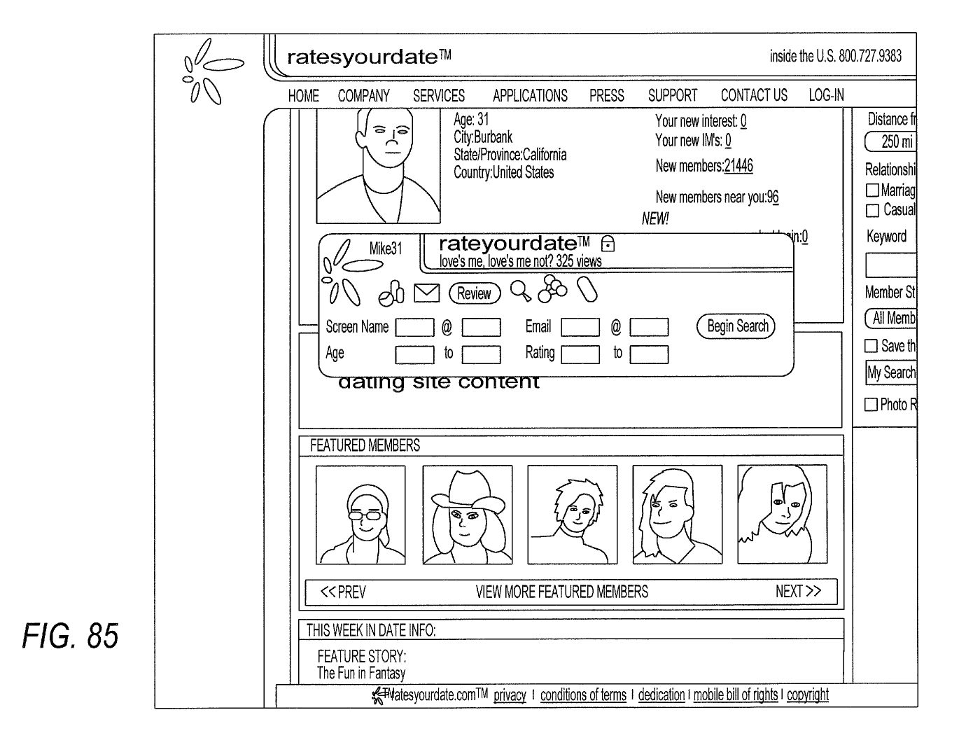

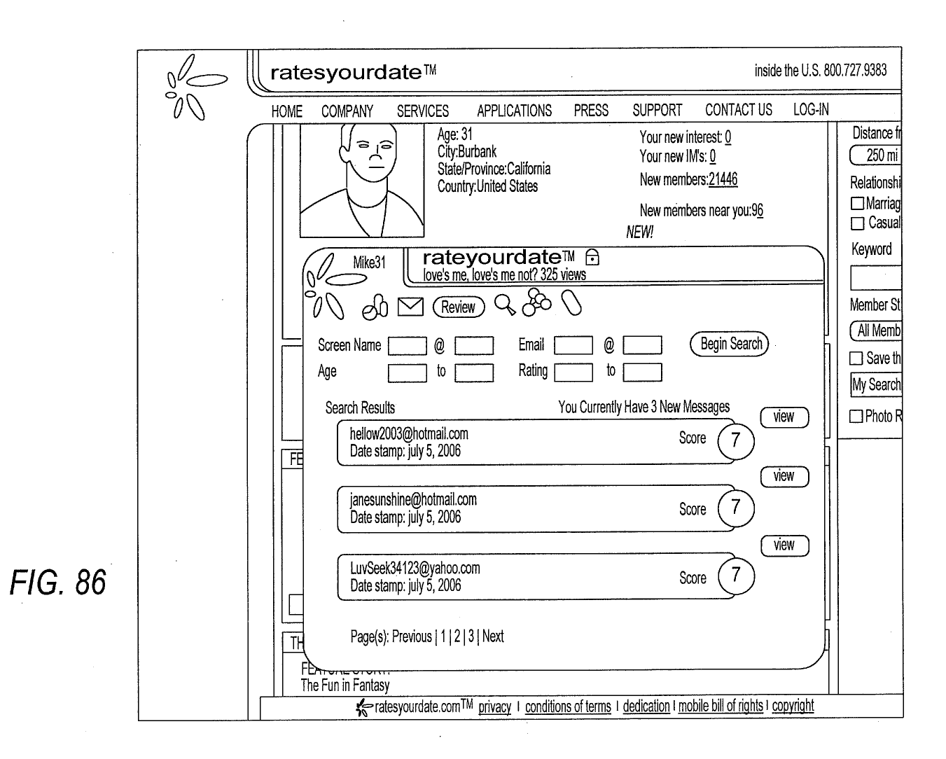

FIG. 44 provides an illustrative flowchart of the procedure followed if the Search icon 3808 is selected. Once selected, the member is prompted with search fields that enable the member to search for information about other members, such as ratings or other information, as depicted in FIG. 44. In one embodiment, different search capabilities may be provided to free and premium members. FIGS. 85-86 show various illustrative screen shots of this feature.

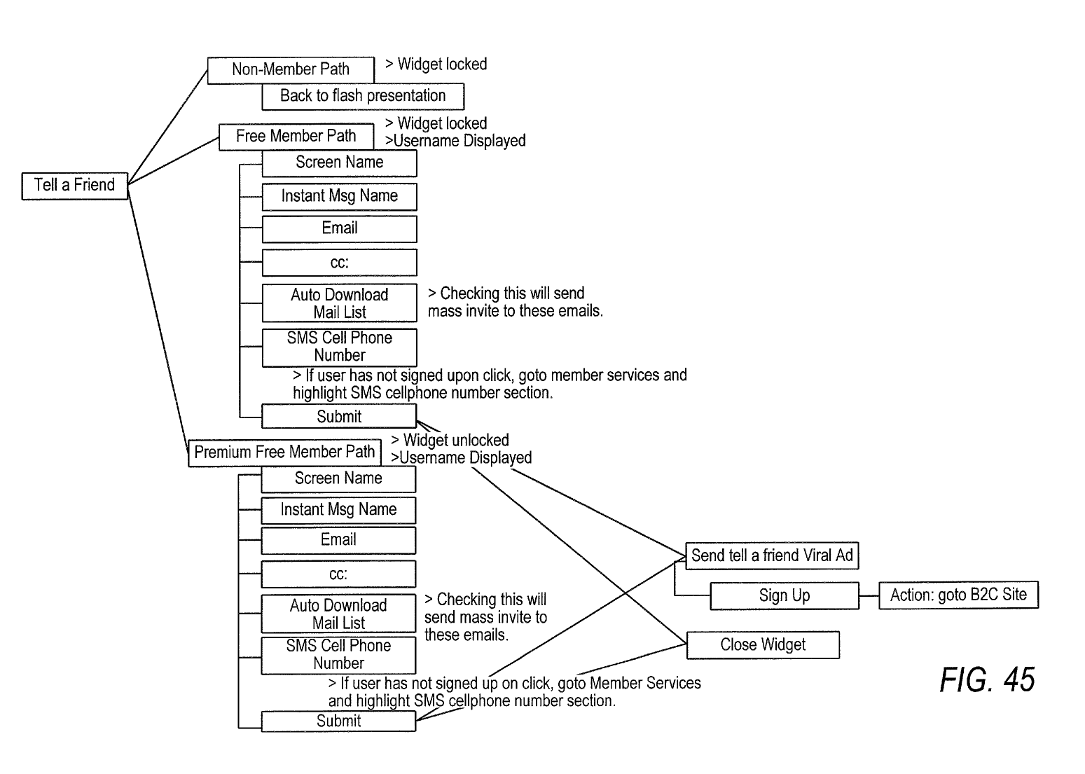

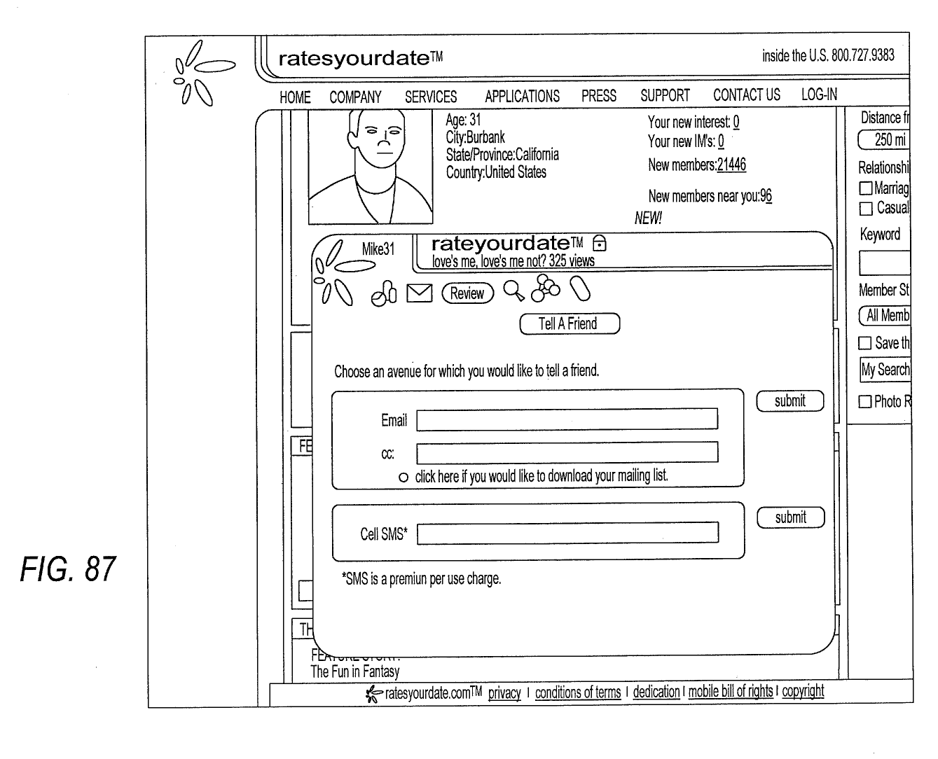

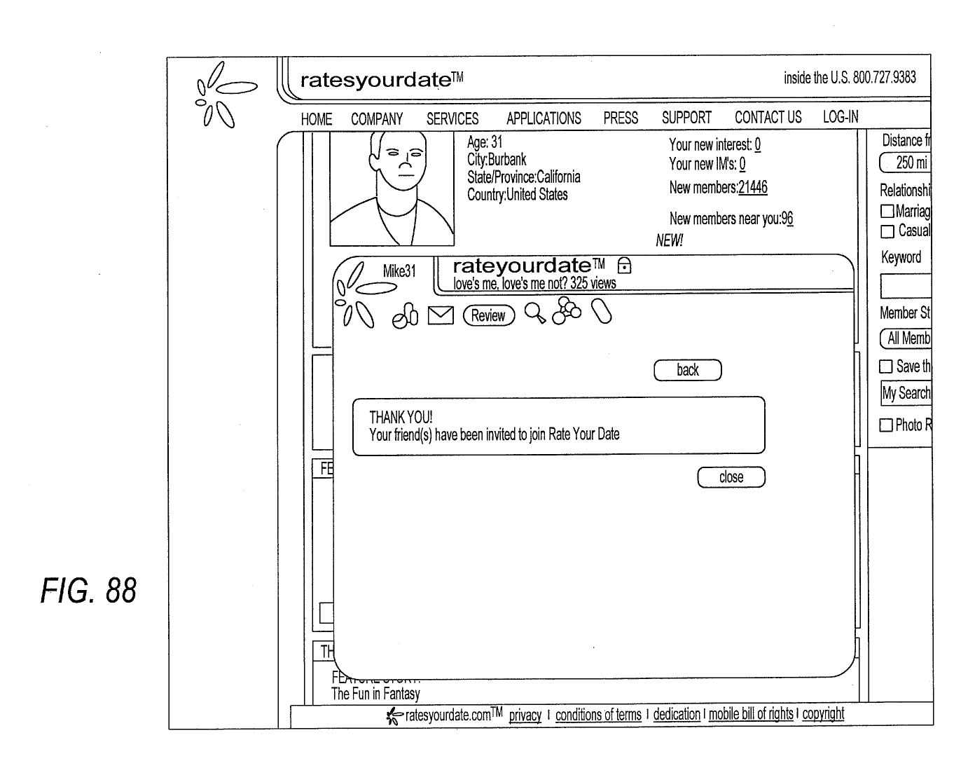

FIG. 45 provides an illustrative flowchart of the procedure followed if Invite my friends icon 3812 is selected. This feature enables members to tell friends, within or without the site, about the site in a viral fashion, in turn bringing new members to the site. FIGS. 87-88 show various illustrative screen shots of this feature.

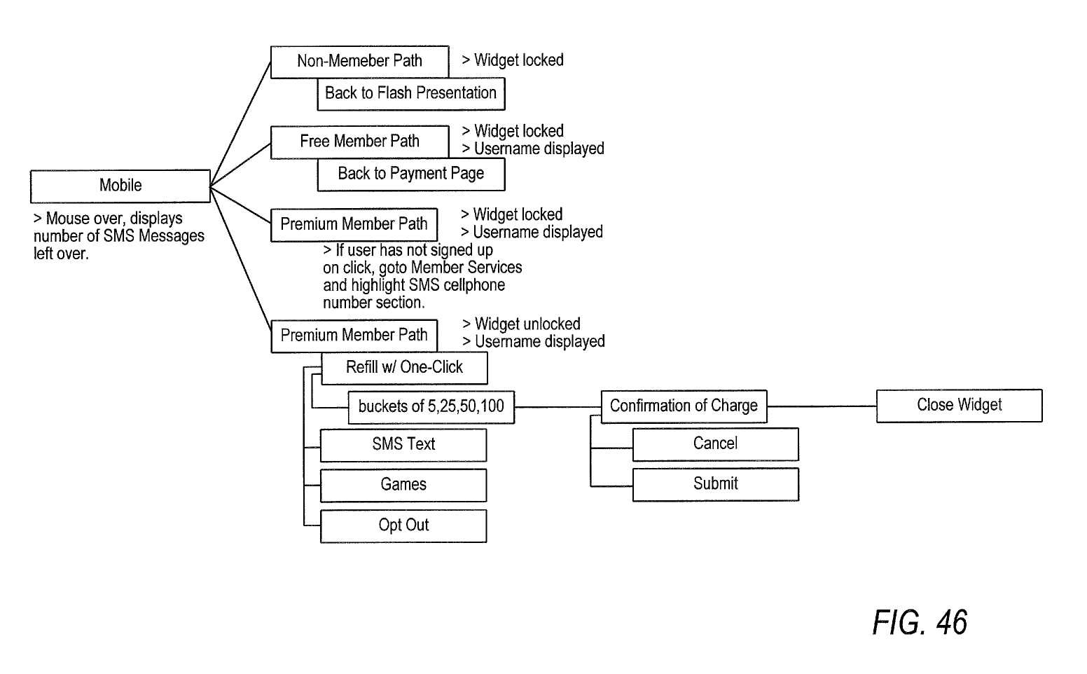

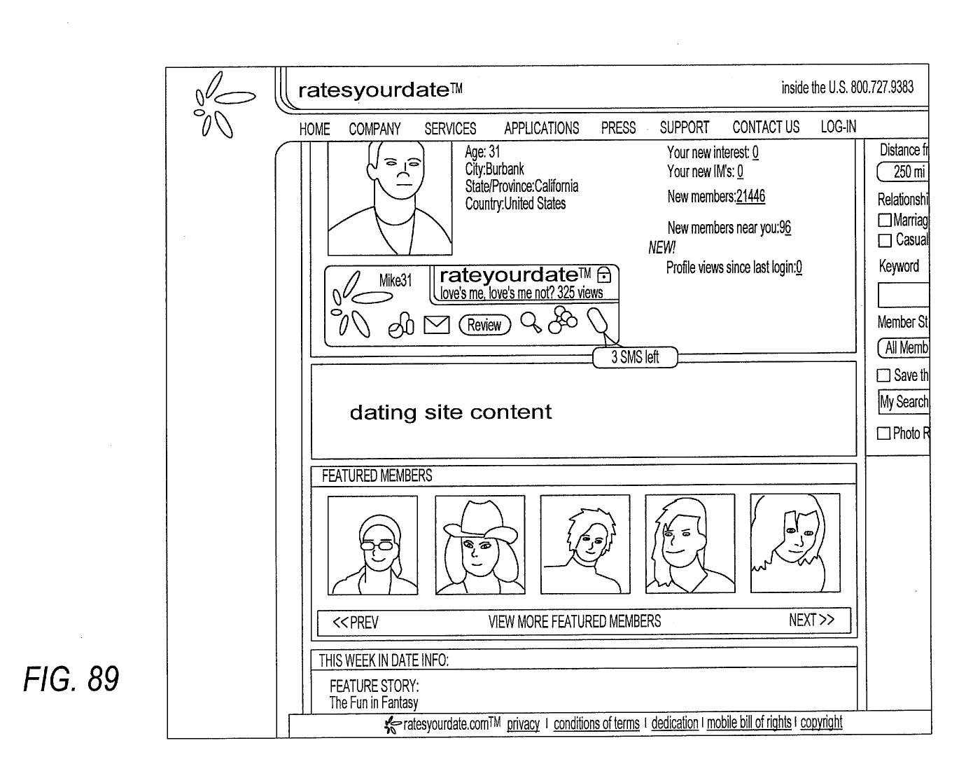

FIG. 46 provides an illustrative flowchart of the procedure followed if the mobile phone icon 3814 is selected. FIG. 89 shows a screen shot indicating the number of SMS messages left.

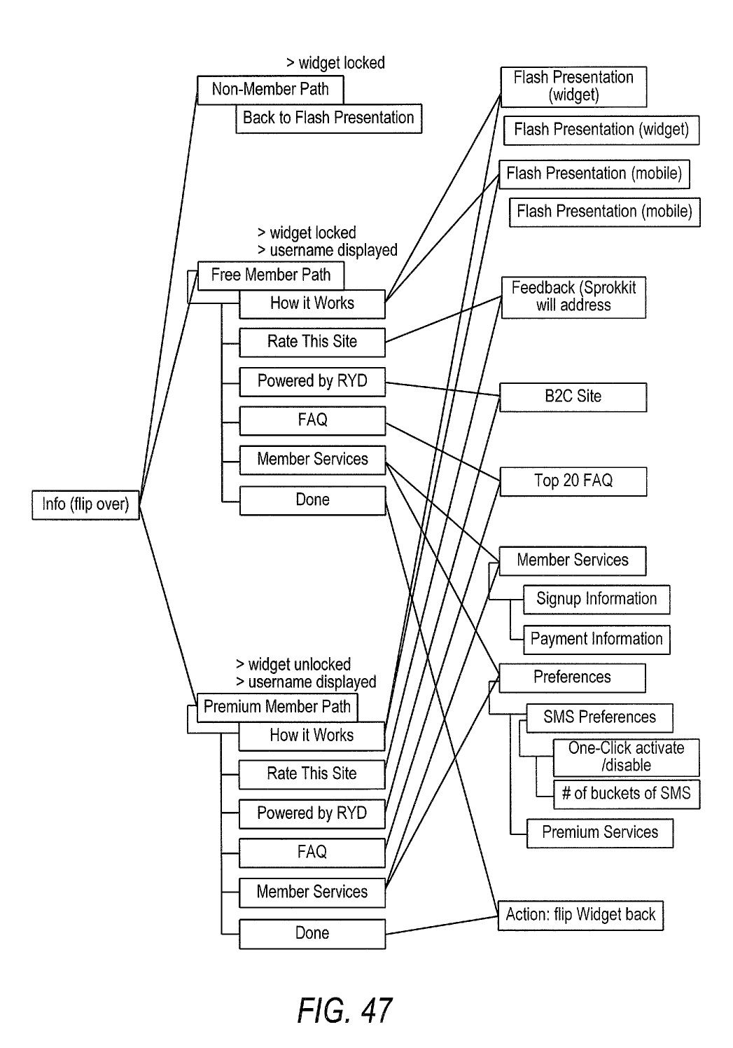

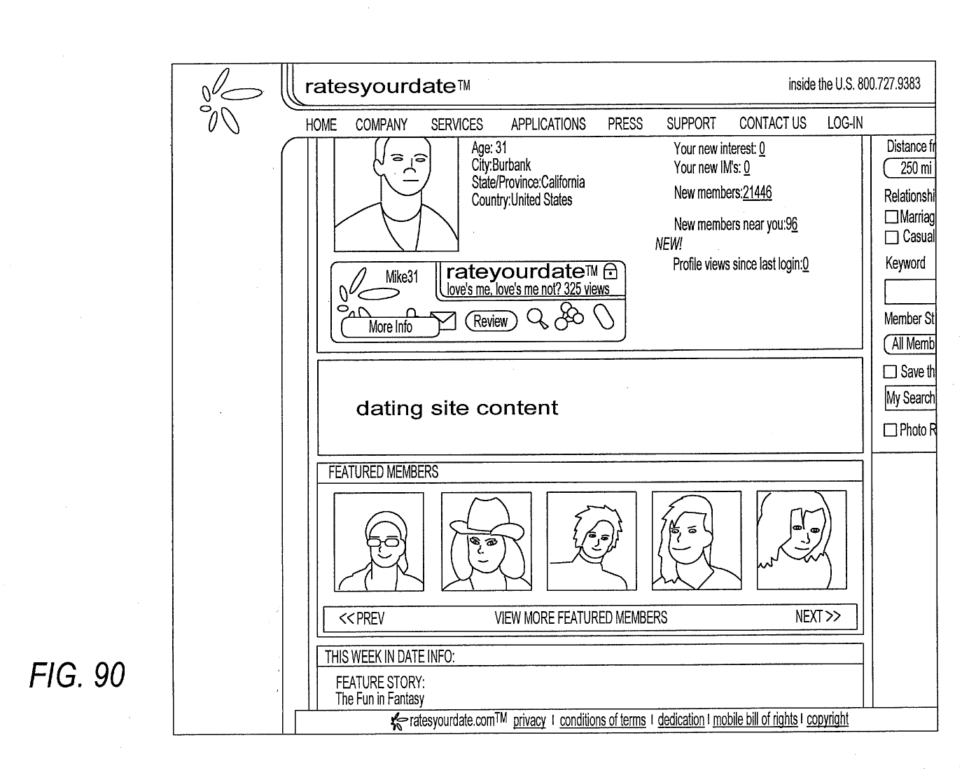

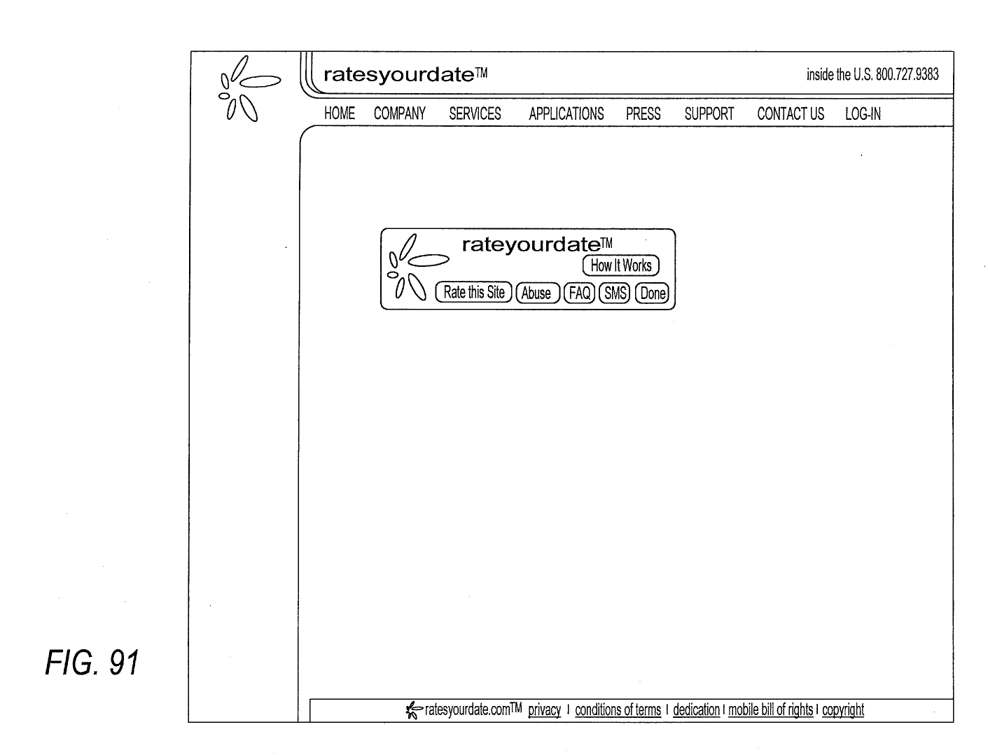

FIG. 47 provides an illustrative flowchart of the procedure followed if the Info (flip over) is selected. FIGS. 90-91 show various illustrative screen shots of this feature.

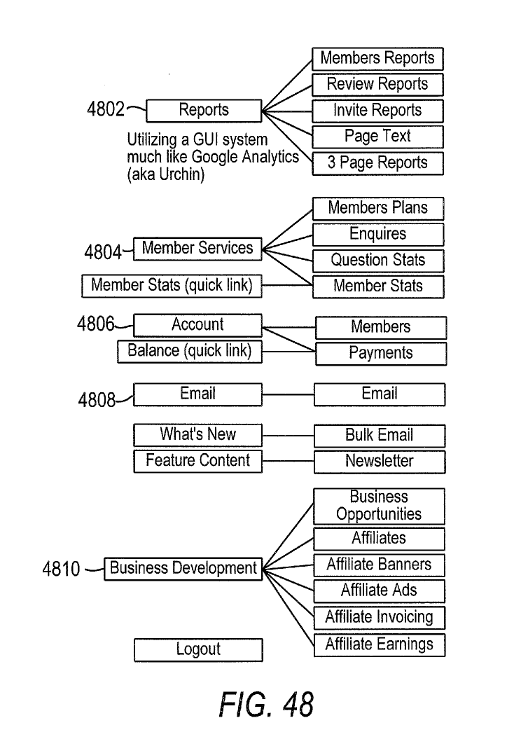

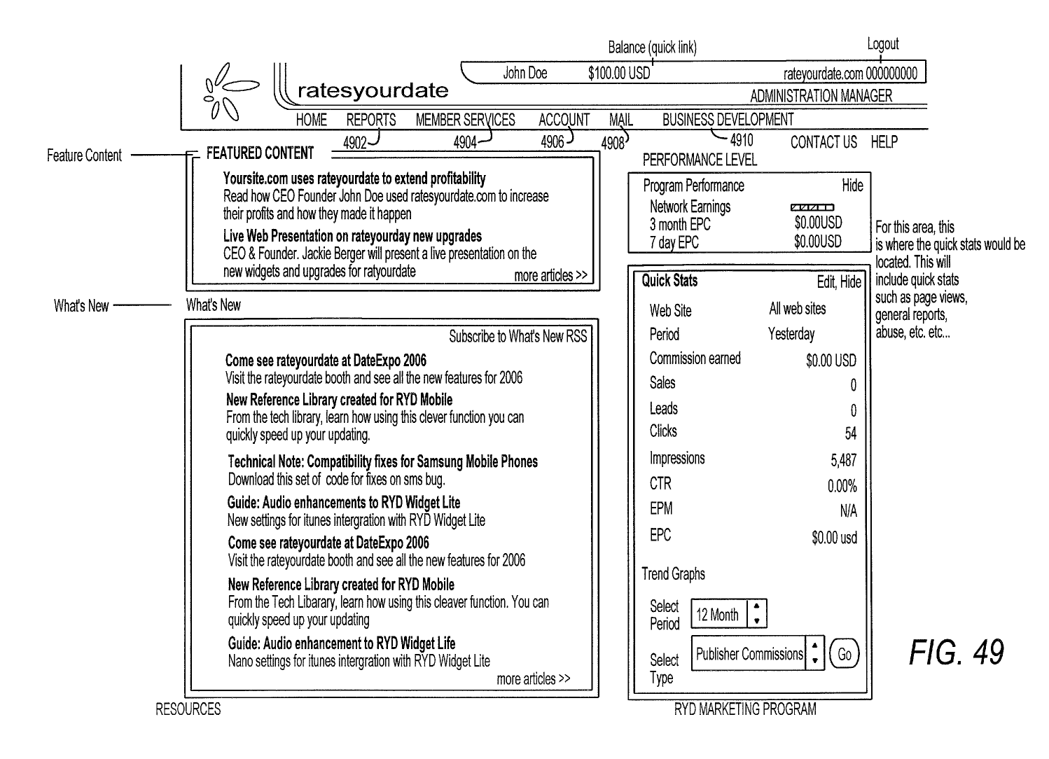

FIG. 48 illustrates a site map for providing back-end administrative features to a social networking or Internet dating system and/or the dating evaluation system, and FIG. 49 ilustrates a web page through which those feature may be provided. Those features may include Reports 4802 selected by Reports link 4902; Member Services 4804 selected by Member Service link 4904; Account information 4806 selected by Account link 4906, Email 4808 selected by Mail link 4908, and Business Development 4810 selected by Business Development link 4910.

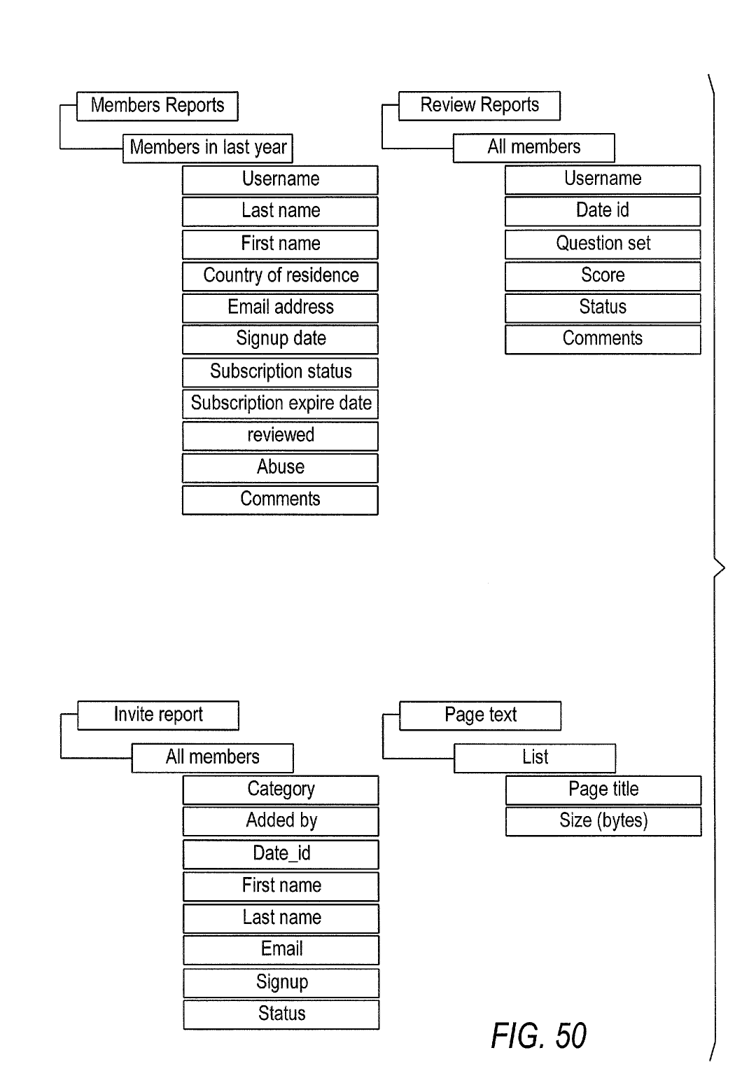

FIG. 50 provides an illustrative flowchart of the procedure followed if the Reports link 4902 is selected.

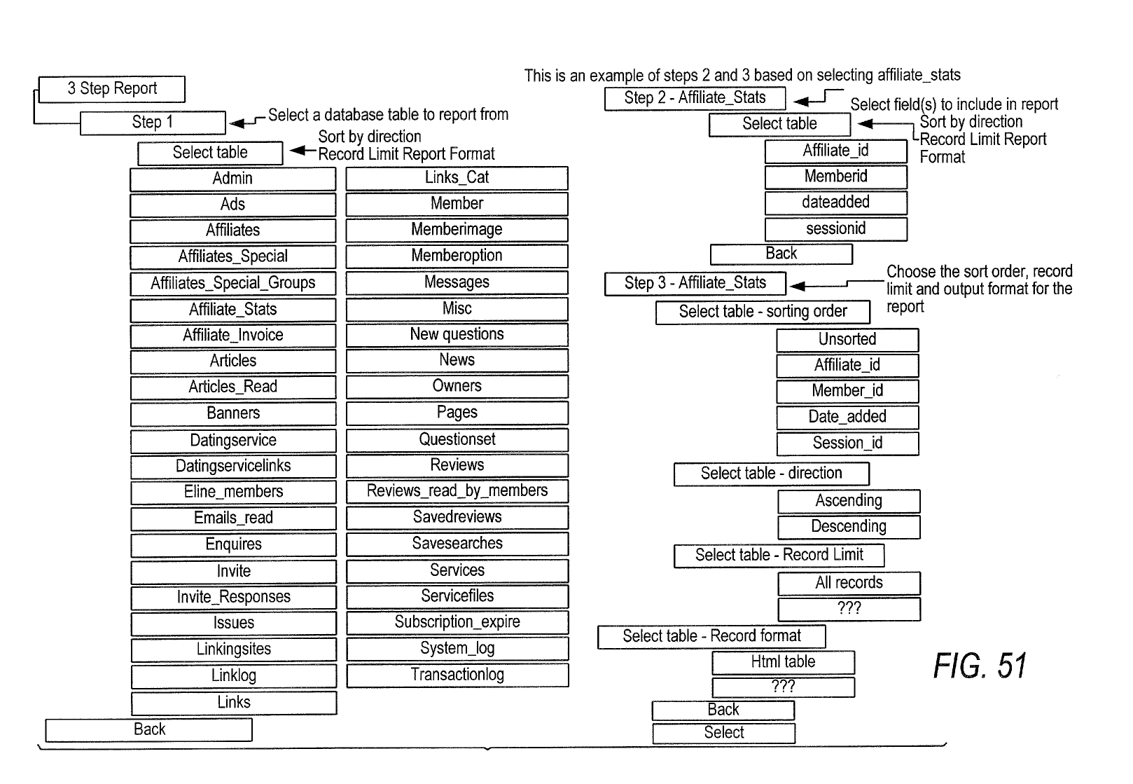

FIG. 51 provides an illustrative flowchart of the procedure followed if the “3 Step Reports” link in FIG. 50 is selected.

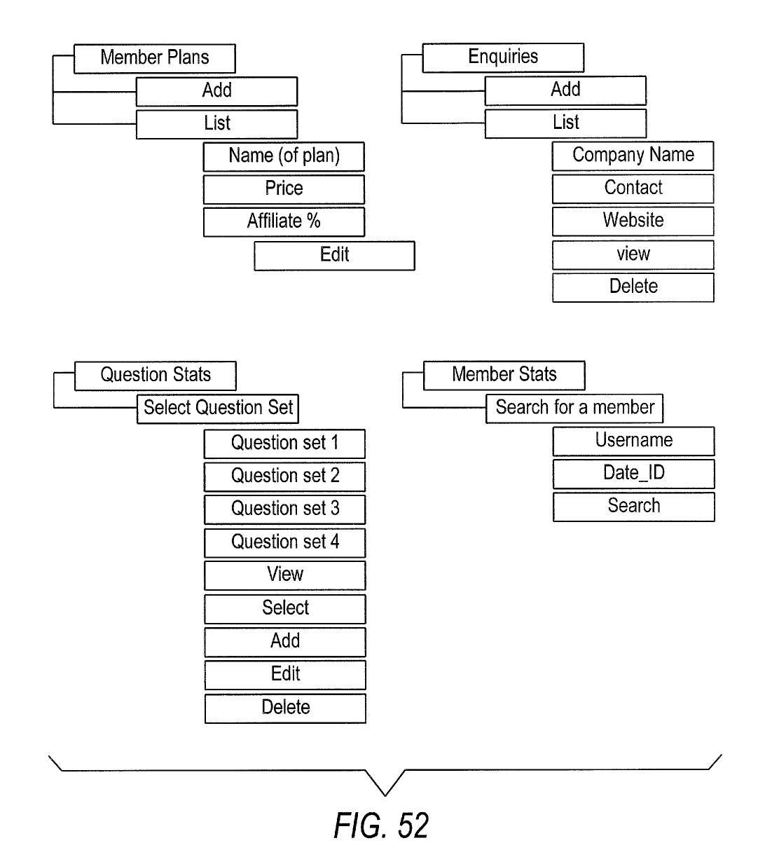

FIG. 52 provides an illustrative flowchart of the procedure followed if the Member Services link 4904 is selected. The Member Plans feature allows an administrator to select or modify the plan between the provider of the social networking or Internet dating system and the provider of the dating evaluation system. The Question Stats features allows an administrator to, for example, change the question set used in the member questionnaires. The Member Stats feature enables the administrator to view statistics of a member. The Enquiries feature enables the administrator to access information about company enquiries.

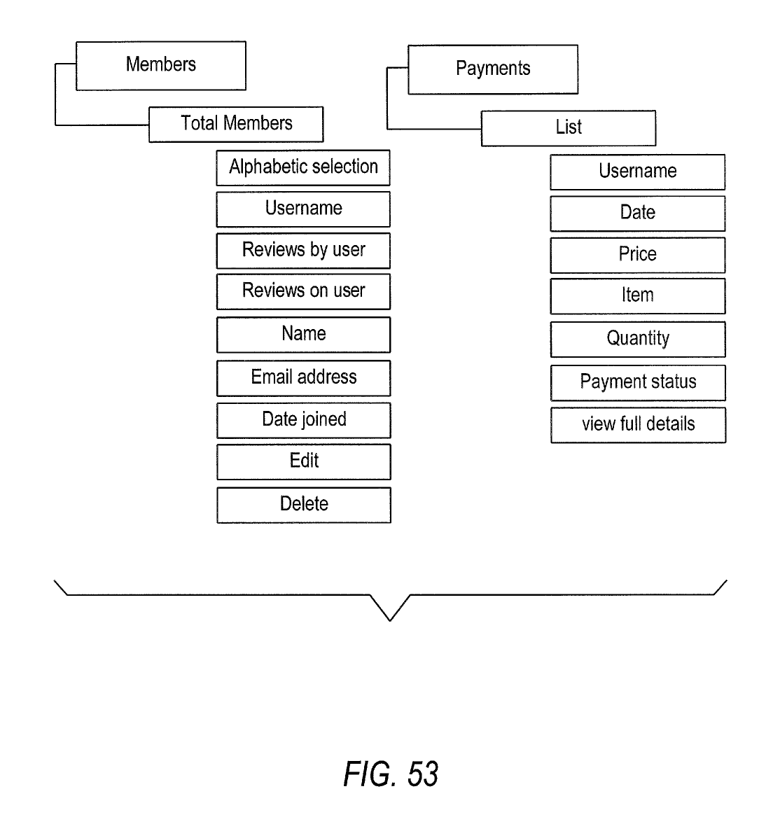

FIG. 53 provides an illustrative flowchart of the procedure followed if the Accounts link 4906 is selected.

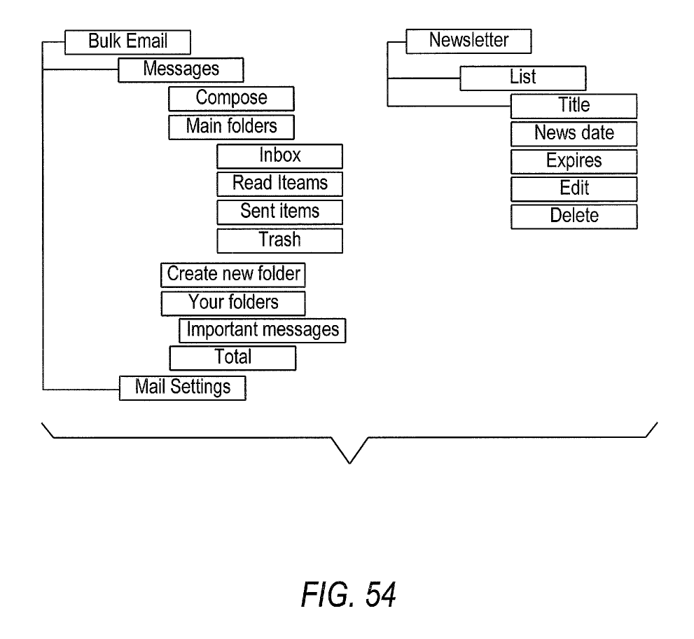

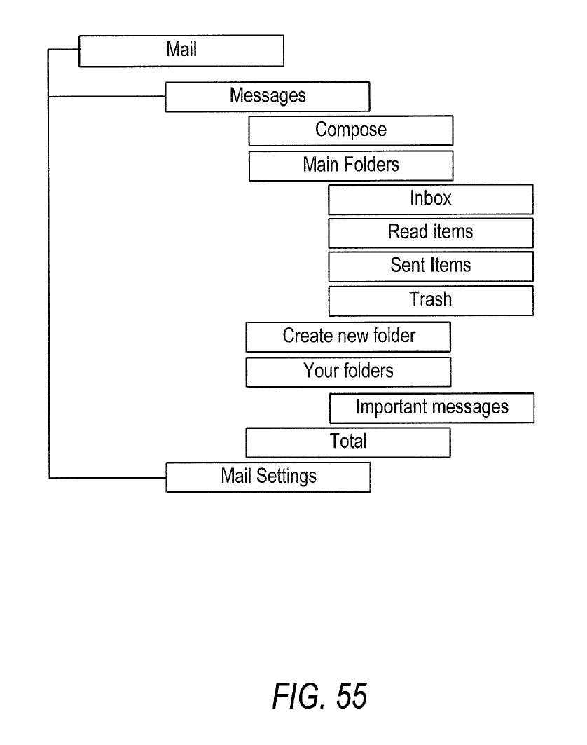

FIGS. 54 and 55 provide illustrative flowcharts of the procedure followed if the Mail link 4908 is selected, or if either sublist link “What's New” or “Feature Content”, shown in FIG. 48 is selected.

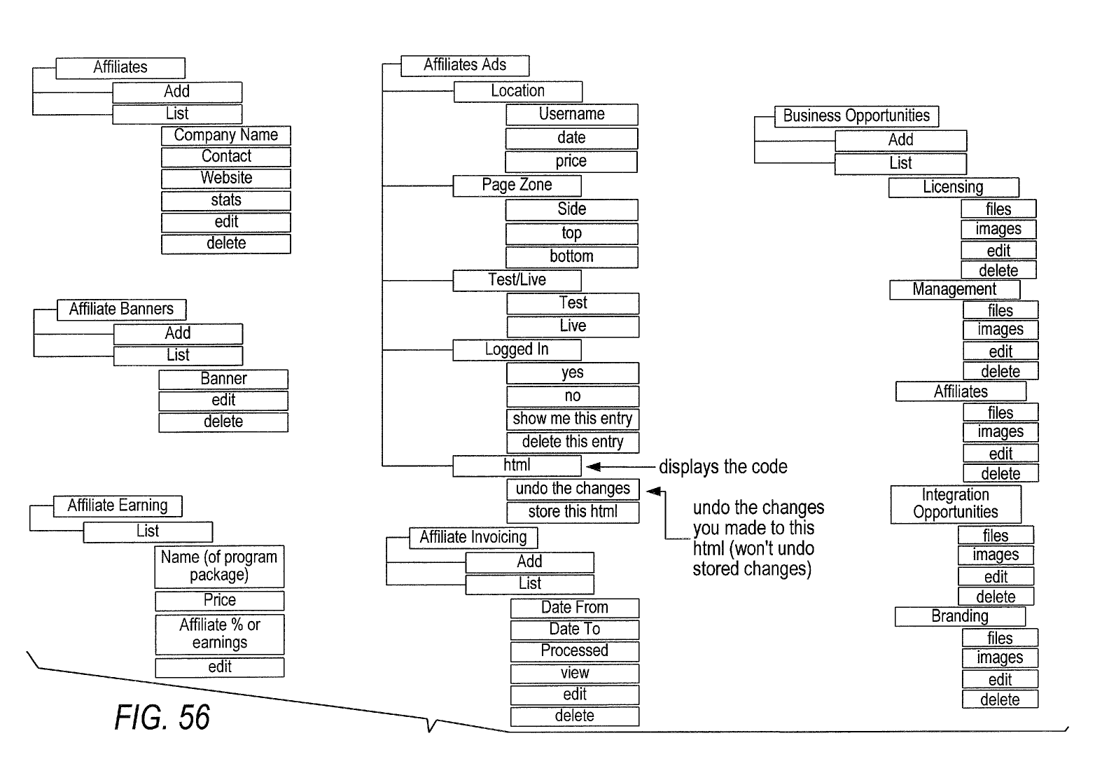

FIG. 56 provides an illustrative flowchart of the procedure followed if the Business Development link 4910 is selected.

In one aspect, the present invention also provides for the delivery of targeted advertising to members of a social networking or Internet dating systems. Such advertising can be delivered to members whether they access the system through a computer, a mobile phone or another device. The advertising can be targeted to members based on their dating behavior, such as their dating success or failure, or, for example, their personal preferences as reflected in their dating reviews, both reviews of them and by them, and their profile information. For example, a different type of advertisement may be sent to a member whose reviews indicate that he likes to take his dates to sporting events than to a member whose reviews indicate that he likes to take his dates to quiet restaurants. In addition, a member who has gotten a number of unfavorable reviews may be sent advertisements on date coaching, whereas a member who gets consistently good reviews would not.

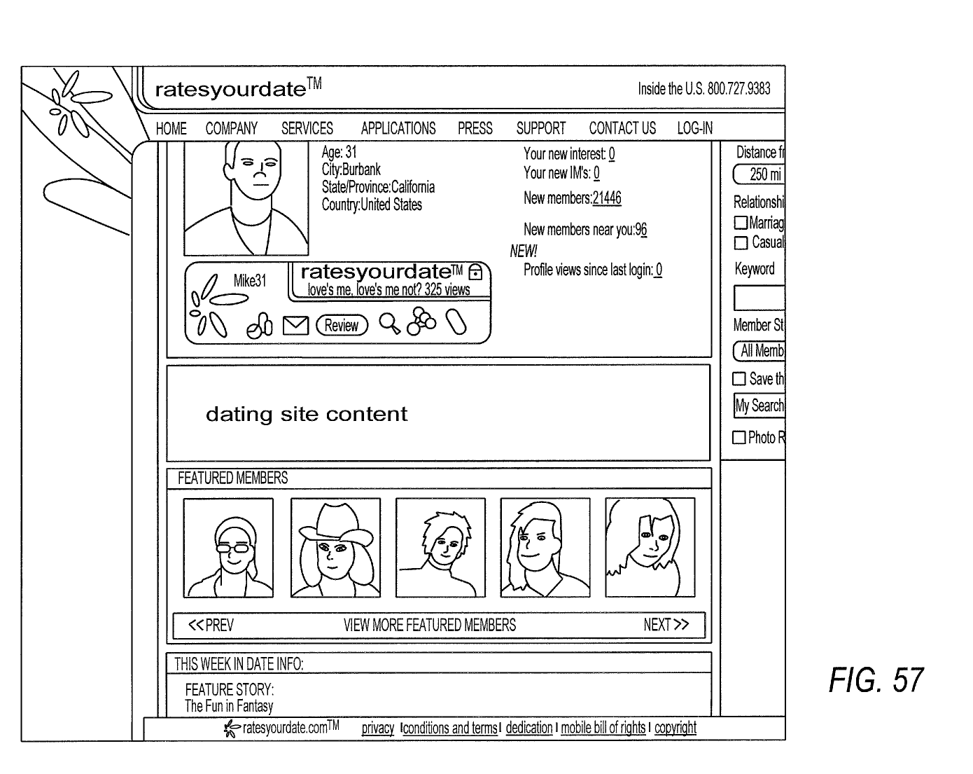

FIGS. 57-91 depict illustrative screen shots of a widget-based user interface in accordance with an embodiment of the present invention.

The illustrative descriptions of the application of the principles of the present invention are to enable any person skilled in the art to make or use the disclosed invention. These descriptions are susceptible to numerous modifications and alternative arrangements by those skilled in the art. Such modifications and alternative arrangements are not intended to be outside the scope of the present invention. The appended claims are intended to cover such modifications and arrangements. Thus, the present invention should not be limited to the described illustrative embodiments but, instead, is to be accorded the broadest scope consistent with the principles and novel features disclosed herein.

1. A social networking or dating system comprising:
one or more social networking or dating service; and
an evaluation system capable of communicating with the one or more social networking or dating service;
wherein the evaluation system stores evaluation information for one or more users of the one or more social networking or dating services; and
wherein the evaluation system comprises a widget interface that is displayed to users of the one or more social networking or dating services and that provides access to features of the evaluation system.

2. (canceled)

3. The system of claim 1 wherein the widget interface enables users to access a review feature of the evaluation system.

4. The system of claim 1 wherein the widget interface enables users to access a view statistics feature of the evaluation system.

5. The system of claim 1 wherein the widget interface enables users to access one or more of a mailbox feature, a search feature, a newsletter feature and an invite friends feature of the evaluation system.

6. A method of providing access to a social networking or dating evaluation system capable of communicating with one or more social networking or dating services, comprising:
causing a widget interface to be displayed to a user of the one or more social networking or dating services, wherein the widget provides access to features of the evaluation system; and
receiving an instruction that was entered by the user using the widget interface.

7-9. (canceled)

10. The method of claim 7 wherein the received instruction enables the user to access one or more of a mailbox feature, a search feature, a newsletter feature and an invite friends feature of the evaluation system.

11. A method of processing date information comprising the steps of:
providing an on-line questionnaire to a first date participant, wherein the questionnaire comprises questions regarding a date between the first date participant and a second date participant;
receiving responses from the first date participant to the questionnaire; and
automatically sending date information regarding the first date participant's responses to the questionnaire to the second date participant.

12. The method of claim 1 further comprising the step of:
determining a date rating based on the responses; and
wherein the step of sending information to the second date participant comprises sending the date rating.

13. The method of claim 11 further comprising the step of:
sending action prompts to the second date participant, wherein each action prompt is associated with corresponding actions that are automatically initiated if the action prompt is selected by the second date participant.

14. The method of claim 13 wherein the actions initiated by the action prompts are associated with one or more of sending a gift to the first date participant, sending a message to the first date participant, and receiving suggestions for another date.

15. The method of claim 11 wherein the step of sending date information comprises one or more of emailing the information to the second date participant and transmitting a message to the second date participant to be received by a mobile device.

16. The method of claim 11 further comprising the step of:
providing action prompts to the first date participant, wherein each action prompt is associated with corresponding actions that are automatically initiated if the action prompt is selected by the first date participant.

17. The method of claim 11 wherein
the step of providing an on-line questionnaire comprises sending the questionnaire to a mobile device, and the step of receiving responses comprises receiving the responses from the mobile device.

18. The method of claim 11 further comprising the step of:
providing the date information to interested third parties.

19. The method of claim 11 further comprising the step of
storing the responses to the questionnaire in a database entry associated with the second date participant.

20. The method of claim 19 further comprising the step of:
analyzing database entries associated with the second date participant, and providing improvement information to the second date participant that is useful in addressing the second date participant's dating deficiencies.

21. A dating system comprising:
means for providing an automated, on-line questionnaire to a first date participant,
wherein the questionnaire comprises questions regarding a date between the first date participant and a second date participant;
means for receiving responses from the first date participant to the questionnaire; and
means for automatically sending date information regarding the first date participant's responses to the questionnaire to the second date participant.

22. A dating system comprising:
one or more Internet dating sites; and
a dating evaluation system capable of communicating with the one or more Internet dating sites;
wherein the dating evaluation system stores date evaluation information for one or more users of the one or more Internet dating sites.

23. The system of claim 22 wherein the date evaluation information for a particular user that is a member of more than one Internet dating site is aggregated.

24. The system of claim 22 wherein the one or more Internet dating sites contain a user selectable link to the dating evaluation system.
